(19) United States
(12) Patent Application Publication
(10) Pub. No.: US 2026/0367626 A1
(43) Pub. Date: Nov. 19, 2026

(54) Robot Navigation Using Evolving Semantic Associations

(71) Applicant: Ron ZASS, Kiryat Tivon (IL)

(72) Inventor: Ron ZASS, Kiryat Tivon (IL)

(21) Appl. No.: 19/651,999

(22) Filed: Apr. 20, 2026

Related U.S. Application Data
(60) Provisional application No. 63/793,327, filed on Apr. 23, 2025.
(60) Provisional application No. 64/043,713, filed on Apr. 19, 2026.

(51) Int. Cl. G05D 1/2285; G05D 1/60; G05D 101/15; G05D 111/10; G05D 111/20; G06V 20/62

(52) U.S. Cl. CPC G05D 1/2285; G05D 1/60; G06V 20/63; G05D 2101/15; G05D 2111/10; G05D 2111/20

(57) ABSTRACT

Systems, methods and non-transitory computer readable media for navigating robots based on associations are provided. In a first timeframe, a natural language input is received and analyzed to determine a user need to navigate to a location associated with an entity. A data structure mapping entities to stored locations, independent of real-time positions, is accessed to identify a corresponding location, and control signals are generated to move the robot accordingly. Sensor data collected after navigation is analyzed to update the entity-location association within the data structure, independent of real-time tracking. In a subsequent timeframe, a new natural language input is processed to determine a similar navigation need. The updated data structure is accessed to identify a potentially different location associated with the same entity, and the robot is directed to the updated location, enabling adaptive, experience-based navigation.

### CROSS-REFERENCE TO RELATED APPLICATIONS

This application claims the benefit of priority of U.S. Provisional Patent Application No. 63/793,327, filed on Apr. 23, 2025, and U.S. Provisional Patent Application No. 64/043,713, filed on Apr. 19, 2026, the disclosures of which are incorporated herein by reference in their entirety.

### BACKGROUND OF THE INVENTION

### Technological Field

The disclosed embodiments generally relate to systems and methods for robot navigation. More particularly, the disclosed embodiments relate to systems and methods for robot navigation using evolving semantic associations.

### Background Information

The integration of artificial intelligence (AI) into robotic systems has significantly advanced the capabilities of machines to perceive, learn, and adapt to dynamic environments. Traditional robotic systems often rely on predefined rules and deterministic algorithms, limiting their effectiveness in unstructured or unpredictable settings. Recent developments in AI, particularly in machine learning and neural networks, have enabled robots to perform complex tasks such as object recognition, path planning, and human-robot interaction with greater autonomy and efficiency. However, challenges remain in optimizing these AI models for real-time decision-making, scalability across platforms, and seamless adaptation to new tasks or environments. There is a growing need for more intelligent, adaptable, and context-aware robotic systems that leverage advanced AI techniques to enhance performance and flexibility.

Autonomous robot navigation has traditionally relied on real-time localization techniques, such as simultaneous localization and mapping (SLAM), visual tracking, or direct coordinate-based commands, to guide movement within an environment. While these approaches can be effective, they often require continuous sensing of an entity's current position and may be computationally intensive or unreliable in dynamic or sensor-constrained environments. Moreover, conventional systems typically lack the ability to interpret natural language instructions in a manner that reflects human-like associations between entities and locations, such as referring to a person, object, or concept whose associated location may change over time. Existing solutions also tend to bind navigation decisions to instantaneous spatial data, limiting their flexibility in scenarios where location relevance is context-dependent or temporally evolving. Accordingly, there is a need for improved navigation techniques that enable robots to respond to natural language inputs by leveraging stored, updateable associations between entities and locations, independent of real-time positional tracking, while still adapting those associations over time based on observed data.

Autonomous and semi-autonomous robotic systems are increasingly deployed in complex, unstructured environments where maintaining stability during locomotion is critical to safe and effective operation. Conventional navigation approaches often prioritize obstacle avoidance and path efficiency but may insufficiently account for localized terrain instability, such as uneven surfaces, loose materials, or dynamically changing ground conditions. As a result, robots may experience reduced balance, inefficient gait patterns, or even failure when traversing challenging environments. Existing techniques for terrain assessment may rely on pre-mapped data or simplified heuristics, which can be inadequate in real-time scenarios where environmental conditions must be continuously interpreted. Accordingly, there is a need for improved methods that leverage sensor data to dynamically evaluate terrain stability and guide precise foot placement decisions, thereby enhancing robotic balance and reliability during navigation toward a desired destination.

Conventional robotic systems are typically designed to execute programmed tasks based on sensor inputs and predefined control logic, often without providing meaningful, real-time explanations of their actions in a form readily understandable to human users. While advances in sensing technologies and autonomous decision-making have improved a robot's ability to interpret its environment and perform complex actions, there remains a gap in effectively communicating those actions to nearby users or operators. Existing approaches to human-robot interaction generally rely on visual displays, status indicators, or post hoc reporting, which may be insufficient in dynamic or collaborative environments where immediate situational awareness is important. Furthermore, systems that generate natural language descriptions of robotic behavior are often decoupled from the underlying motion planning and control processes, leading to inconsistencies between what the robot does and what it communicates. Accordingly, there is a need for improved techniques that integrate perception, action planning, physical execution, and real-time natural language narration, enabling robots to both perform tasks and concurrently convey their intended actions in an intuitive and synchronized manner.

Conventional robotic control systems typically rely on preconfigured rules and sensor inputs to trigger specific actions, but such systems often lack flexibility when environmental conditions change or when exceptions to predefined triggers arise. More recent approaches attempt to improve usability by enabling users to teach robots new triggers through natural language inputs, demonstrations, or visual data. However, these systems generally require the creation or retraining of trigger definitions from scratch, rather than allowing efficient modification of existing triggers. As a result, even minor contextual adjustments, such as excluding specific instances of an otherwise valid trigger, can require disproportionate effort or reconfiguration. In particular, vision-based trigger detection may cause a robot to repeatedly perform the same action upon detecting similar visual cues, even when contextual nuances would warrant a different response. Existing approaches do not effectively integrate inputs with trigger-based control frameworks to dynamically define exceptions or refinements to previously learned behaviors. Accordingly, there is a need for improved techniques that enable incremental, context-aware adjustment of trigger conditions, without requiring complete relearning, by leveraging natural language and visual inputs in conjunction with sensor data to refine robotic responses in real time.

Robotic systems increasingly rely on visual data to learn tasks through observations, enabling more flexible and adaptive behavior in dynamic environments. Conventional approaches to vision-based learning often treat all observed demonstrations equally, without adequately considering the identity, reliability, or relevance of the entity performing the action. As a result, robots may learn suboptimal, unsafe, or unintended behaviors from unverified or unsuitable sources. Existing solutions lack mechanisms for selectively filtering which observed actions should be incorporated into a robot's learning process based on contextual or entity-specific criteria. Accordingly, there is a need for improved methods that enable robots to selectively learn from visual inputs by distinguishing between preferred and non-preferred sources, thereby enhancing learning efficiency, safety, and overall task performance.

Robotic systems capable of interacting physically with humans are increasingly used in fields such as rehabilitation, assistive care, and collaborative manufacturing. Conventional approaches to human-robot interaction often rely on pre-programmed motion paths or require users to manually position their limbs within constrained mechanical structures, limiting adaptability and natural engagement. Vision-based systems have been introduced to improve responsiveness, but many existing solutions focus primarily on detection or tracking without tightly integrating perception with coordinated multi-stage actuation. As a result, these systems may struggle to safely and effectively guide human limb movement, particularly in scenarios requiring continuous contact and sequential motion control. Accordingly, there remains a need for improved methods that utilize real-time image data to detect specific body parts, enable controlled physical engagement, and coordinate multiple actuator groups to guide an individual's limb through successive movements in a safe, adaptive, and precise manner.

Autonomous robotic systems are increasingly utilized in environments requiring the retrieval and use of multiple objects to perform complex tasks. Conventional systems, such as warehouse automation platforms, are primarily directed to logistical operations including identifying items, retrieving the items from distributed storage locations, and transporting the items to a designated station for aggregation or packaging. These systems generally treat retrieved objects as independent items and do not perform substantive operations using the objects beyond placement or delivery. Other robotic systems configured for complex tasks involving different objects, are typically limited to predefined tools and localized resources, and lack the capability to dynamically identify, retrieve, and coordinate multiple objects from remote locations in connection with a desired action. As a result, existing approaches do not provide an integrated framework in which a robot determines a desired action, identifies and obtains a plurality of associated objects from respective source locations, and subsequently performs the desired action using the obtained objects in a coordinated and adaptive manner. Accordingly, there remains a need for improved robotic methods that unify object acquisition and action execution, particularly in applications involving unrestrained environments like home or office, or in applications involving operations on individuals.

In many care environments, including homes, hospitals, and assisted living facilities, feeding of subjects, such as infants, elderly individuals, or patients with limited mobility, remains a labor-intensive and time-sensitive task that often requires continuous human supervision. Conventional approaches rely heavily on caregivers to identify feeding needs, prepare consumable liquids (e.g., mixing powdered formula with liquid), retrieve appropriate containers, and physically deliver nourishment to the subject. These processes can be prone to delays, inconsistency in preparation, and human error, particularly in settings with limited staffing or high demand. While certain automated or semi-automated feeding devices exist, they are typically limited in scope, lacking integrated capabilities for autonomous navigation, context-aware decision-making, and end-to-end task execution. Accordingly, there is a need for improved systems and methods that enable robotic platforms to autonomously determine feeding requirements, prepare consumable liquids from stored materials, and deliver such liquids directly to subjects in a safe, efficient, and reliable manner.

Preparation of consumable liquids from powdered substances, such as infant formula, nutritional supplements, or medical mixtures, typically involves a sequence of precise manual actions, including opening containers, measuring appropriate quantities of powder, transferring the powder into a receptacle, sealing the receptacle, and mixing the contents to achieve a uniform solution. In conventional settings, these tasks are performed by human operators and are susceptible to variability in measurement accuracy, contamination risks, and inconsistent mixing quality. Existing automated devices generally provide only partial solutions, such as dispensing pre-measured quantities or performing limited mixing functions, but lack the capability to execute a complete preparation workflow involving manipulation of multiple objects and coordinated actuation of distinct mechanical components. Furthermore, such systems often do not support flexible interaction with standard containers or dynamically controlled actuation sequences required for reliable preparation. Accordingly, there is a need for improved robotic methods capable of autonomously performing multi-step liquid preparation processes, including container access, powder measurement and transfer, sealing, and mixing, through coordinated control of multiple actuators to ensure accuracy, consistency, and hygiene.

Feeding infants requires careful handling, precise positioning, and continuous monitoring to ensure both safety and adequate intake. In conventional care settings, caregivers must manually support the infant's head and body, correctly position a feeding bottle, and observe the infant throughout the feeding process to detect cues such as completion, discomfort, or improper latch. These tasks demand sustained attention and skill, and may be difficult to perform consistently in environments with limited caregiver availability or high workloads. While some assistive feeding devices exist, they generally lack the capability to safely position an infant, coordinate bottle placement with the infant's posture, and dynamically monitor feeding using sensor-based feedback. Moreover, existing systems often do not provide mechanisms for determining when feeding is complete or for adjusting the infant's position accordingly. Accordingly, there is a need for improved robotic methods that can safely and autonomously support infant positioning, deliver nourishment using appropriate feeding interfaces, monitor the feeding process through sensor data, and respond adaptively to ensure safe and effective feeding.

### SUMMARY OF THE INVENTION

In some examples, systems, methods and non-transitory computer readable media for navigating robots based on associations are provided. In some examples, in a first timeframe, a first verbal input in a natural language may be received. The first verbal input may be analyzed to determine a first need. The first need may be a need to move to a stored location associated, at the first timeframe, with a particular entity. A data structure associating entities with stored locations may be accessed, based on the particular entity, to identify a first location associated with the particular entity at the first timeframe. The stored locations in the data structure may be independent of real-time detected positions of the entities. First digital signals configured to activate at least one actuator of a robot to cause the robot to move to the first location may be generated. After causing the robot to move to the first location, digital data captured using at least one sensor included in the robot may be received. The captured digital data may be analyzed to update an association of the particular entity in the data structure. The update may be independent of a real-time detected position of the particular entity. In a second timeframe, after updating the data structure, a second verbal input in the natural language may be received. The second verbal input may be analyzed to determine a second need. The second need may be a need to move to a stored location associated, at the second timeframe, with the particular entity. The updated data structure may be accessed, based on the particular entity, to identify a second location associated with the particular entity at the second timeframe. The second location may differ from the first location due to the update. Second digital signals configured to activate the at least one actuator of the robot to cause the robot to move to the second location may be generated.

In some examples, systems, methods and non-transitory computer readable media for stable navigation of robots are provided. In some examples, an indication of a desired destination of a robot may be received. Digital data captured from an environment of the robot using at least one sensor included in the robot may be received. The captured digital data may be analyzed to determine a first likelihood of unsteadiness associated with a first location. The captured digital data may be analyzed to determine a second likelihood of unsteadiness associated with a second location. Based on the indication of the desired destination, the first likelihood and the second likelihood, it may be determined to avoid stepping at the first location and to step at the second location. Digital signals configured to activate at least one actuator of the robot to cause the robot to move a leg of the robot to step at the second location may be generated.

In some examples, systems, methods and non-transitory computer readable media for narrating robotic activities are provided. In some examples, data captured using at least one sensor may be received. The captured data may be analyzed to determine a desired action for a robot. Based on the desired action, a series of desired movements for a body of the robot for performing the desired action may be determined. Based on the desired action, information in a natural language indicative of the desired action may be determined. Digital signals configured to activate at least one actuator of the robot to cause the body to undergo the determined desired movements may be generated. An audible output of the determined information in the natural language may be generated.

In some examples, systems, methods and non-transitory computer readable media for robotic trigger configuration are provided. In some examples, at least one rule associated with at least one trigger may be obtained. First image data captured using at least one image sensor included in a robot may be received. The first image data may be analyzed using the at least one rule to detect the at least one trigger in the first image data. In response to the detection of the at least one trigger in the first image data, first digital signals configured to activate a first group of actuators may be generated to cause the robot to perform a specific action. After the generation of the first digital signals, a natural language input may be received. The natural language input may be analyzed to determine an exception to the at least one trigger. The at least one trigger detected in the first image data may correspond to the determined exception. After determining the exception, second image data captured using the at least one image sensor may be received. The second image data may be analyzed using the at least one rule to detect the at least one trigger in the second image data. The detected at least one trigger in the second image data may correspond to the determined exception. Due to the determined exception, performing the specific action in response to the detection of the at least one trigger in the second image data may be avoided. After determining the exception, third image data captured using the at least one image sensor may be received. The third image data may be analyzed using the at least one rule to detect the at least one trigger in the third image data. The detected at least one trigger in the third image data may not correspond to the determined exception. In response to the detection of the at least one trigger in the third image data, second digital signals configured to activate a second group of actuators may be generated to cause the robot to perform the specific action.

In some examples, systems, methods and non-transitory computer readable media for selective learning in visual robotic configuration are provided. In some examples, first image data captured using at least one image sensor included in a robot may be received. The first image data may depict a first entity performing a first action. The first image data may be analyzed to determine an identity of the first entity. A data structure may be accessed based on the identity of the first entity to make a determination to learn from the first entity. In response to the determination to learn from the first entity, the first image data may be analyzed to learn to perform the first action. Second image data captured using the at least one image sensor included in the robot may be received. The second image data may depict a second entity performing a second action. The second image data may be analyzed to determine an identity of the second entity. The data structure may be accessed based on the identity of the second entity to make a determination not to learn from the second entity. In response to the determination not to learn from the second entity, learning to perform the second action from the second image data may be avoided.

In some examples, systems, methods and non-transitory computer readable media for robotic guidance are provided. In some examples, image data captured using at least one image sensor included in a robot may be received. The image data may depicts an individual. The image data may be analyzed to detect a limb of the individual. First digital signals configured to activate a first group of actuators to cause the robot to hold at least part of the limb of the individual may be generated. While holding the at least part of the limb of the individual, second digital signals configured to activate a second group of actuators to cause the robot to guide the limb of the individual in a first movement may be generated. Further, while holding the at least part of the limb of the individual and after the completion of the first movement, third digital signals configured to activate a third group of actuators to cause the robot to guide the limb of the individual in a second movement may be generated.

In some examples, systems, methods and non-transitory computer readable media for robotic preparation for task execution are provided. In some examples, a desired action for performance by a robot may be determined. Further, a specific location for performing the desired action may be determined. A plurality of objects associated with the desired action may be identified. For each object of the plurality of objects, a respective source location remote from the specific location that enables the robot to obtain the object may be identified, the robot may be navigated to the respective source location, and, at the respective source location, respective digital signals configured to activate a respective group of actuators may be generated to cause the robot to obtain the object. Further, the robot may be caused to bring the obtained objects to one or more locations accessible from the specific location. The robot may be navigated to the specific location. At the specific location, specific digital signals configured to activate a specific group of actuators may be generated to cause the robot to perform the desired action using the obtained objects.

In some examples, systems, methods and non-transitory computer readable media for robotic feeding of subjects are provided. In some examples, a need to feed a subject may be determined. A robot may be navigated to a particular location. The particular location may enable the robot to access a specific bottle. The robot may be caused to prepare liquid from powder using the specific bottle to thereby obtain a prepared liquid in the specific bottle. While the robot holds the specific bottle containing the prepared liquid, the robot may be navigated to a specific location, the specific location enables the robot to access the subject. At the specific location, the robot may be caused to use the specific bottle to feed the subject with the prepared liquid.

In some examples, systems, methods and non-transitory computer readable media for robotic preparation of liquids are provided. In some examples, a robot may be navigated to a particular location. The particular location may enable the robot to access a specific bottle. First digital signals configured to activate a first group of actuators may be generated to cause the robot to open a container. The container may contain powder. Second digital signals configured to activate a second group of actuators may be generated to cause the robot to hold a scoop. After the robot opens the container and while the robot holds the scoop, third digital signals configured to activate a third group of actuators may be generated to cause the robot to move the scoop through the powder to thereby fill the scoop with the powder from the open container. After the robot fills the scoop with the powder from the open container, fourth digital signals configured to activate a fourth group of actuators may be generated to cause the robot to unload the powder from the scoop into a body of the specific bottle. After the robot unloads the powder from the scoop into the specific bottle, fifth digital signals configured to activate a fifth group of actuators may be generated to cause the robot to screw a screw ring onto the body. After the robot screws the screw ring onto the body, sixth digital signals configured to activate a sixth group of actuators may be generated to cause the robot to shake the specific bottle.

In some examples, systems, methods and non-transitory computer readable media for robotic feeding of infants are provided. In some examples, a robot may be caused to obtain a specific bottle containing liquid. The specific bottle may include a teat. The robot may be navigated to a specific location. The specific location may enable the robot to access an infant. After the robot arrives at the specific location, first digital signals configured to activate a first group of actuators may be generated to cause the robot to position the infant in a first pose. In the first pose a head of the infant may be supported by at least part of a body of the robot. While the infant is in the first pose, second digital signals configured to activate a second group of actuators may be generated to cause an arm of the robot holding the specific bottle to position the specific bottle to thereby position a tip of the teat in a mouth of the infant. Information captured using at least one sensor after the robot positions the tip of the teat in the mouth may be received. The captured information may be analyzed to monitor a feeding process of the liquid to the infant. A completion of the feeding process may be determined. In response to the determined completion, third digital signals configured to activate a third group of actuators may be generated to cause the robot to position the infant in a second pose.

### BRIEF DESCRIPTION OF DRAWINGS

FIG. 1A is a block diagram illustrating a possible implementation of a robot, consistent with some embodiments of the present disclosure.

FIG. 1B is a schematic illustration of an example of a part of a robot, consistent with some embodiments of the present disclosure.

FIG. 1C is a block diagram illustrating a possible implementation of a communicating system, consistent with some embodiments of the present disclosure.

FIG. 2 is a flowchart of an exemplary process for operating a robot, consistent with some embodiments of the present disclosure.

FIG. 3 is a block diagram illustrating some possible flows of information, consistent with some embodiments of the present disclosure.

FIG. 4 is a flowchart of an exemplary process for navigating robots based on associations, consistent with some embodiments of the present disclosure.

FIG. 5A is a flowchart of an exemplary process for stable navigation of robots, consistent with some embodiments of the present disclosure.

FIG. 5B is a block diagram illustrating an environment, consistent with some embodiments of the present disclosure.

FIG. 6 is a flowchart of an exemplary process for narrating robotic activities, consistent with some embodiments of the present disclosure.

FIGS. 7A and 7B are a flowchart of an exemplary process for robotic trigger configuration, consistent with some embodiments of the present disclosure.

FIG. 8 is a flowchart of an exemplary process for selective learning in visual robotic configuration, consistent with some embodiments of the present disclosure.

FIG. 9 is a flowchart of an exemplary process for robotic guidance, consistent with some embodiments of the present disclosure.

FIG. 10A is a flowchart of an exemplary process for robotic preparation for task execution, consistent with some embodiments of the present disclosure.

FIG. 10B is a flowchart of an exemplary process for obtaining object using robots, consistent with some embodiments of the present disclosure.

FIG. 11 is a flowchart of an exemplary process for robotic feeding of subjects, consistent with some embodiments of the present disclosure.

FIG. 12 is a flowchart of an exemplary process for robotic preparation of liquids, consistent with some embodiments of the present disclosure.

FIG. 13A is a flowchart of an exemplary process for robotic feeding of infants, consistent with some embodiments of the present disclosure.

FIG. 13B is a flowchart of an exemplary process for robotic feeding of subjects, consistent with some embodiments of the present disclosure.

### DETAILED DESCRIPTION OF THE INVENTION

Unless specifically stated otherwise, as apparent from the following discussions, it is appreciated that throughout the specification discussions utilizing terms such as “processing”, “calculating”, “computing”, “determining”, “generating”, “setting”, “configuring”, “selecting”, “defining”, “applying”, “obtaining”, “monitoring”, “providing”, “identifying”, “segmenting”, “classifying”, “analyzing”, “associating”, “extracting”, “storing”, “receiving”, “transmitting”, “presenting”, “causing”, “using”, “basing”, “halting” or the like, include action and/or processes of a computer that manipulate and/or transform data into other data, said data represented as physical quantities, for example such as electronic quantities, and/or said data representing the physical objects. The terms “computer”, “processor”, “controller”, “processing unit”, “computing unit”, and “processing module” should be expansively construed to cover any kind of electronic device, component or unit with data processing capabilities, including, by way of non-limiting example, a personal computer, a wearable computer, a tablet, a smartphone, a server, a computing system, a cloud computing platform, a communication device, a processor (for example, digital signal processor (DSP), an image signal processor (ISR), a microcontroller, a field programmable gate array (FPGA), an application specific integrated circuit (ASIC), a central processing unit (CPA), a graphics processing unit (GPU), a visual processing unit (VPU), and so on), possibly with embedded memory, a single core processor, a multi core processor, a core within a processor, any other electronic computing device, or any combination of the above.

The operations in accordance with the teachings herein may be performed by a computer specially constructed or programmed to perform the described functions.

Examples describe non-limiting embodiments of the presently disclosed subject matter. As used herein, the phrase “for example,” “in one example”, “in some examples”, “such as”, “for instance”, “one case”, “some cases”, “other cases”, and variants thereof describe non-limiting embodiments of the presently disclosed subject matter, and may mean that a particular feature, structure or characteristic described in connection with the embodiment(s) may be included in at least one embodiment of the presently disclosed subject matter. Thus, the appearance of such phrases does not necessarily refer to the same embodiment(s). As used herein, the term “and/or” includes any and all combinations of one or more of the associated listed items. As used herein, the phrase “may not” means “might not”.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter, one or more stages illustrated in the figures may be executed in a different order and/or one or more groups of stages may be executed simultaneously. The figures illustrate a general schematic of the system architecture in accordance embodiments of the presently disclosed subject matter. Each module in the figures can be made up of any combination of software, hardware and/or firmware that performs the functions as defined and explained herein. The modules in the figures may be centralized in one location or dispersed over more than one location.

It should be noted that some examples of the presently disclosed subject matter are not limited in application to the details of construction and the arrangement of the components set forth in the following description or illustrated in the drawings. The invention can be capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing may have the same use and description as in the previous drawings.

The drawings in this document may not be to any scale. Different figures may use different scales and different scales can be used even within the same drawing, for example different scales for different views of the same object or different scales for the two adjacent objects.

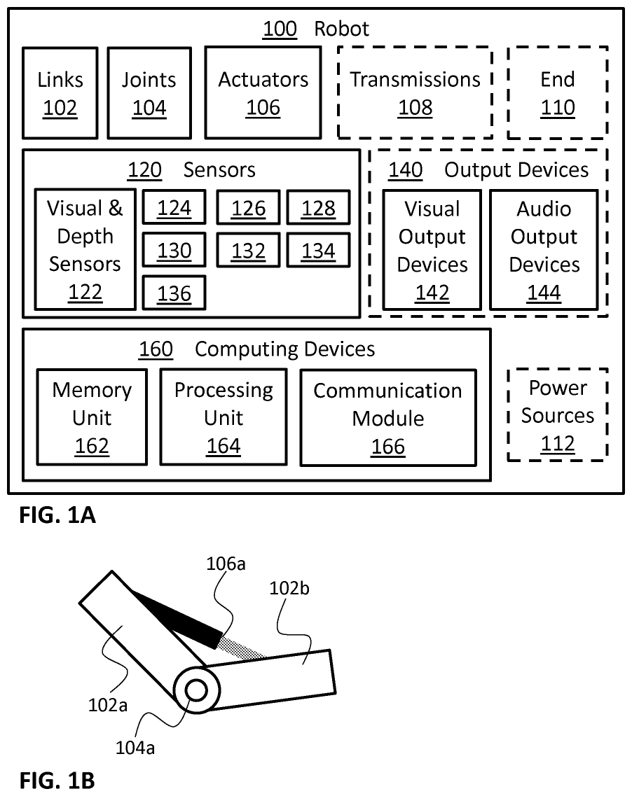

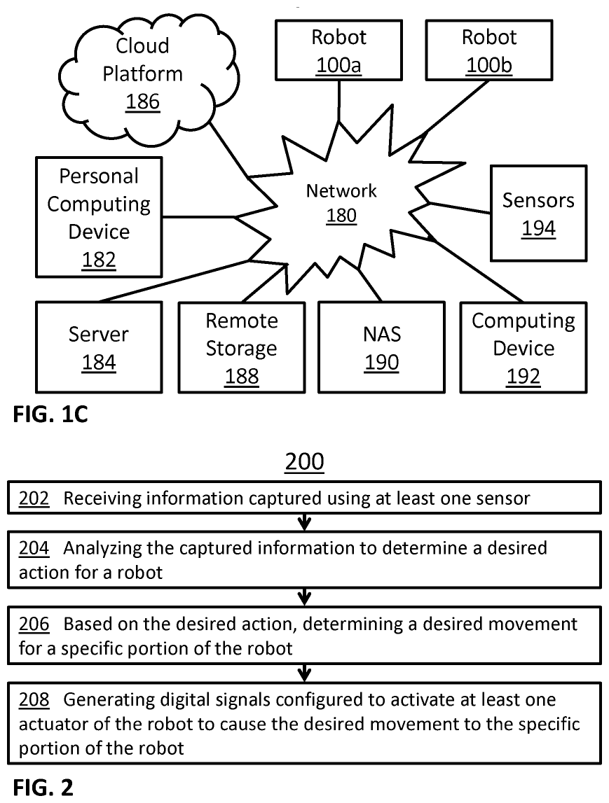

FIG. 1A is a block diagram illustrating a possible implementation of robot 100, consistent with some embodiments of the present disclosure. In some examples, a robot (such as robot 100) may be a machine that is able to move in the physical world, sense its environment, and use computing devices to control its movements. In one non-limiting example, a robot (such as robot 100) may be an automated robot, exhibiting at least some degree of autonomy or automation. In one non-limiting example, a robot (such as robot 100) may be an intelligent robot, exhibiting apparently intelligent behavior. In some examples, a robot (such as robot 100) may comprise one or more links (such as links 102), one or more joints (such as joints 104), one or more actuators (such as actuator 106), one or more sensors (such as sensors 120), and one or more computing devices (such as computing devices 160). In one example, communication between actuators and/or computing devices and/or sensors may be wired, may be wireless, and so forth. In some examples, a robot (such as robot 100) may further comprise one or more power sources (such as power sources 112). Such power source may be connected to and provide power to actuators and/or computing devices and/or sensors. In some examples, a link (such as link 102) may be a rigid part of a robot. In one example, a link (such as link 102) may be constructed to resist deformation while transmitting force. In another example, a link (such as link 102) may be flexible, or may include or be connected to a flexible part (such as an elastic cover, such as rubber). In one example, a link (such as link 102) may be at least one of a rod or a bar. In one example, a link (such as link 102) may be connected to one or more joints. For example, a link may connect two joints together, and each joint may be connected to an opposite side of the link. In another example, a link (such as a distal link) may connect to a single joint. In some non-limiting examples, a link (such as link 102) may be constructed of at least one of metal, wood, plastic, or composite material. In some examples, a joint (such as joint 104) may connect two or more links (such as links 102). In one example, a joint (such as joint 104) may enable and/or restrict the relative motion between two links (for example, the motion of one link connected to the joint relative to another link connected to the joint). For example, the motion may allow at least one of rotation or translation motion between the two links. One non-limiting example of a joint may be a hinge-based joint enabling rotation of one link about a specific axis relative to another link (that is, one rotational degree of freedom). Another non-limiting example of a joint may be a ball-and-socket joint, which may enable backward, forward, sideways and/or rotating movements (that is, three rotational degrees of freedom). Yet another non-limiting example of a joint may be a translational joint enabling one link to only translate along a vector in respect of another link (that is, one translational degree of freedom). Other non-limiting examples of joints may include a prismatic joint, cylindrical joint, screw joint, planar joint, slot joint, reduced slot joint, distance joint, or universal joint. In one example, a joint (such as joint 104) may have zero, one, two or three translational degree of freedom, and zero, one, two or three rotational degrees of freedom. A joint (such as joint 104) may be constructed using high-strength materials and/or high-precision manufacturing. In one non-limiting example, friction reduction along joints may be provided using at least one of lubrication, bearings, or bushings. In some examples, an actuator (such as actuator 106) may be a mechanism that generates force and/or torque, for example in response to a signal (such as an electrical signal, a digital signal, and so forth). An actuator (such as actuator 106) may be connected to a link (such as link 102), for example directly or via a transmission system (such as transmission 108), and may apply force and/or torque to the link, for example directly or via the transmission system. In one example, an actuator (such as actuator 106) may be or include at least one of a motor, an electric motor (such as a stepper motor, brushed DC motor, brushless DC motor, AC motor, etc.), a servo, a pneumatic actuator, a hydraulic actuator, a combustion actuator, or a piezoelectric actuator. In one example, an actuator (such as actuator 106) may be rotary (for example, revolving around an axis). In another example, an actuator (such as actuator 106) may be linear (for example, translating about an axis). In some examples, a robot (such as robot 100) may further comprise one or more transmission systems (such as transmissions 108). Some non-limiting examples of such transmission systems may include gears (such as gearboxes, leadscrews, harmonic drives, etc.), cables, wheels and/or tracks, pneumatic lines (for example, connecting pump/valve system to a pneumatic cylinder), hydraulic lines (for example, connecting pump/valve system to a hydraulic cylinder), bars, four-bar linkages, flywheels, thrusters, and so forth. In one non-limiting example, a transmission (such as transmission 108) may be configured to transmit rotary motion and/or linear motion. In one non-limiting example, a transmission (such as transmission 108) may be configured to convert rotary to linear motion and/or vice versa. In one non-limiting example, a transmission (such as transmission 108) may transform changes in angular momentum to changes in orientation. In some examples, a transmission (such as transmission 108) may be located directly at the joint, may connect an actuator to a far-off link, and so forth. In some examples, a transmission (such as transmission 108) may pull, may push, may output linear motion, may output rotary motion, and so forth. In some examples, a robot (such as robot 100) may further comprise one or more end effectors (such as end effectors 110). In one example, the end effectors may be configured to interact with the physical environment of the robot, and with physical objects in the physical environment. Some non-limiting example of end effector may include grippers, tools, manipulators, human-like hands, and so forth. An end effector may be coupled to a distal link (such as a terminal link of links 102) and may be configured to perform one or more tasks, such as grasping, manipulating, cutting, welding, fastening, or sensing. In some implementations, an end effector may include at least one of a gripper (such as, a parallel-jaw gripper, multi-fingered gripper, or vacuum gripper), a tool (such as, a drill, welder, or screwdriver), or a specialized interface adapted to a particular application. In some examples, an end effector may comprise one or more sensors (such as force, torque, tactile, proximity, or vision sensors) and/or one or more actuators to enable active control of interaction with the environment. In some implementations, the end effector may be interchangeable, and the robot may be configured to automatically couple to or decouple from different end effectors. In some examples, a robot (such as robot 100) may further comprise one or more output devices (such as output devices 140). Some non-limiting examples of such output device may include a visual output device (such as visual output devices 142, display screens, projectors, LED indicators, etc.), an audio output device (such as audio output devices 144, loudspeakers, headphones, earphones, earbuds, etc.), and so forth. In some examples, a computing device (such as computing device 160) may comprise one or more memory units 162, one or more processing units 164, and one or more communication modules 166. In some implementations, the computing device may comprise additional components, while some components listed above may be excluded. For example, the computing device may further comprise sensors 120 and/or power sources 112. In another example, the computing device may further comprise output devices 140 and/or input devices (such as a keyboard, a pointing device, a computer mouse, a touchscreen, a touchpad, a microphone, a camera, and so forth). In one example, the computing device may be part of a robot (such as robot 100, as illustrated in FIG. 1A) or external to a robot (such as a Personal Computer, a tablet, a smartphone, a smartwatch, a wearable computing device, a remote server, a part of a cloud platform, and so forth). In some examples, the computing device may be configured to implement control algorithms, such as feedback control, feedforward control, or model-based control, to regulate motion of the robot. In some examples, the computing device may implement AI models (such as machine learning models, artificial neural networks, etc.) to process sensor data and generate control commands. In some embodiments, one or more power sources 112 may be configured to power at least one of a robot (such as robot 100), a computing device (such as computing device 160), an actuator (such as actuator 106), a sensor (such as sensors 120), or an output device (such as output devices 140). Possible implementation examples of such power source may include at least one of an electric battery, a capacitor, a connection to external power source, or a power convertor. In some examples, a robot (such as robot 100) may be a humanoid robot, semi-humanoid robot, an upper-body robot, a non-humanoid robot, a unipedal robot, a bipedal robot, a tripedal robot, a quadruped robot, a pentapedal robot, a hexapod robot, a robot with more than six legs, a robot with a single arm, a robot with two arms, a robot with more than two arms, a robot with one or more wheels, a robot with a torso, and so forth.

In some embodiments, a processing unit (such as processing unit 164) may be configured to execute software programs. For example, processing unit 164 may be configured to execute software programs stored on the memory units 162. In some cases, the executed software programs may store information in memory unit 162. In some cases, the executed software programs may retrieve information from memory unit 162. Possible implementation examples of such processing unit may include at least one of a single core processor, a multicore processor, a controller, an application processor, a system on a chip processor, a central processing unit, a graphical processing unit, or a neural processing units. In one example, the processing unit may include at least one of logical gates, flip-flops, multiplexers, demultiplexers, registers, or circuits. In one example, the processing unit may comprise at least one of an Arithmetic Logic Unit (ALU), a decoder, an encoder, a clock, a Control Unit (CU), a cache memory, a bus, or a Memory Management Unit (MMU). In some examples, processing units 164 may control sensors 120. For example, processing units 164 may control at least one of capturing information using a sensor, storing the captured information, or transmitting the captured information. In some cases, the captured information may be processed using processing units 164. For example, the captured information may be compressed by processing units 164; possibly followed: by storing the compressed captured information in memory units 162, by transmitted the compressed captured information using communication modules 164, and so forth.

In some embodiments, a communication module (such as communication module 166) may be configured to receive and/or transmit information. For example, control signals may be transmitted and/or received through communication modules 166. In another example, information received though communication modules 166 may be stored in memory unit 162. In an additional example, information retrieved from memory unit 162 may be transmitted using communication modules 166. In another example, input data may be transmitted and/or received using communication modules 166. Examples of such input data may include input data inputted by a user using user input devices, information captured using one or more sensors (such as sensors 120), and so forth. Such communication module may be digital, may be analog, may be configured for external communication (for example, for communication with an external computing device, for communication with a communication network such as the Internet, etc.), may be configured for internal communication (for example, for communication with other parts of a robot or a computing device), may be wired (such as a point-to-point communication device, a wired connection to a communication network, etc.), may be wireless (such as Bluetooth, Wireless LAN, WiFi, cellular data communication, etc.), and so forth. In one example, communication module 166 may enable communication with external systems, including remote servers or cloud-based platforms, for data processing, model updates, or coordination with other robots.

In some examples, a sensor (such as sensor 120) may measure one or more physical quantities, and may encode the measurements in electrical form (for example, in digital form) to obtain captured information (for example, captured digital information). In one example, a sensor (such as sensor 120) may be connected or mounted to a link of the robot, for example at a specific position and/or at a specific orientation. In another example, a sensor (such as sensor 120) may be included in the robot. In yet another example, a sensor (such as sensor 120) may be external to the robot. Some non-limiting examples of such sensor may include visual and/or depth sensor 122, audio sensor 124, position and/or motion and/or acceleration sensor 126 (such as GPS, outdoor position sensor, indoor position sensor, gyroscope, accelerometer, inertial sensor, etc.), tactile sensor 128 (such as contact switch, force/torque sensor, scale, pressure sensor, tactile array, touchpad, touchscreen, proximity sensor, etc.), proprioceptive sensor 130 (such as relative joint encoder, absolute joint encoder, joint limit contact switch, or any other sensor that measures a position of a link, for example relative to another link, relative to an external object, or relative to a coordinate system), temperature sensor 132, gas sensor 134, battery voltage sensor 136, and so forth. In one example, the captured information may be stored in memory units 162. In another example, the captured information may be transmitted using communication modules 166, for example to external computerized devices. In an additional example, the captured information may be processed using processing unit 164, for example using at least one of an algorithm, a convolution, a classification algorithm, a data-regression algorithm, a pattern recognition algorithm, a trained machine learning model, or an artificial neural network. In one example, sensors 120 may be configured to generate sensor data representing the robot's environment or internal state. In one example, sensor data may be used in a feedback loop to adjust actuator outputs in real time.

In some examples, visual and/or depth sensor 122 may be configured to capture visual and/or depth information, such as images, sequences of images, videos, 3D images, sequence of 3D images, 3D videos, range images, range videos, and so forth. For example, visual and/or depth sensor 122 may capture image data 302. In one example, the captured visual and/or depth information may be processed using processing unit 164 to detect a layout of an environment, to detect and/or decode visual codes, to detect objects, to detect events, to detect actions, to detect faces, to detect peoples, and/or to recognize people. In another example, the captured visual and/or depth information may be processed using at least one of object detection algorithm, face detection algorithm, face recognition algorithm, or semantic segmentation algorithm. In some examples, visual and/or depth sensor 122 may include at least one of an image sensor, a monocular camera, a stereo camera, an active stereo camera, a laser rangefinder, a range camera, or sonar. In one example, an image sensor may be configured to capture information by converting light to digital information.

In some examples, audio sensor 124 may be configured to capture audio by converting sounds to electrical signals and/or digital information. For example, audio sensor 124 may capture audio data 304. Some examples of audio sensors 124 may include microphones, unidirectional microphones, bidirectional microphones, cardioid microphones, omnidirectional microphones, onboard microphones, wired microphones, wireless microphones, any combination of the above, and so forth. In some cases, the captured audio may be processed by processing units 164. In another example, the captured audio may be processed using at least one of speech recognition algorithm, speaker recognition algorithm, or speaker diarization algorithm.

In some examples, position and/or motion and/or acceleration sensor 126 may be configured to capture and/or determine at least one of a position of at least part of a robot, a motion of at least part of a robot, or an acceleration of at least part of a robot. For example, sensor 126 may capture position data 306. For example, sensor 126 may be configured to detect and/or measure at least one of position, change in position, orientation, changes in orientation, velocity, speed, direction of motion, acceleration, or direction of acceleration, for example relative to another object and/or in a selected coordinates system. Some possible implementations of sensor 126 may include at least one of an accelerometer, gyroscope, image sensor (for example, with an ego-positioning and/or ego-motion algorithm), Lidar, Radar, Global Positioning System (GPS), GLObal NAvigation Satellite System (GLONASS), Galileo global navigation system, BeiDou navigation system, other Global Navigation Satellite Systems (GNSS), Indian Regional Navigation Satellite System (IRNSS), Local Positioning Systems (LPS), Real-Time Location Systems (RTLS), Indoor Positioning System (IPS), Wi-Fi based positioning systems, or cellular triangulation.

In some examples, tactile sensor 128 may be configured to detect physical interaction between the robot and its physical environment. For example, tactile sensor 128 may capture tactile data 308. The tactile sensor 128 may generate data indicative of contact, force, pressure, or texture at one or more surfaces of the robot. In one example, the tactile sensor 128 comprises an array of sensing elements distributed across a contact surface to provide spatially resolved feedback. Some possible implementations of tactile sensor 128 may include at least one of contact switch, force/torque sensor, scale, pressure sensor, tactile array, touchpad, touchscreen, or proximity sensor.

In some examples, proprioceptive sensor 130 may be configured to detect internal state information of the robot. For example, proprioceptive sensor 130 may capture proprioceptive data 310. The proprioceptive sensor 130 may generate data indicative of one or more of joint position, velocity, acceleration, orientation, or applied torque within robot 100. In one example, proprioceptive sensor 130 may include one or more encoders, inertial measurement units, or force/torque sensors associated with articulated components of the robot. In one example, proprioceptive sensor 130 may include at least one of relative joint encoder, absolute joint encoder, joint limit contact switch, or any other sensor that measures a position of a link, for example relative to another link, relative to an external object, or relative to a coordinate system.

FIG. 1B is a schematic illustration of an example of a part of a robot, consistent with some embodiments of the present disclosure. In this example, a part of a robot (for example, of robot 100, of a different robot, etc.) may comprise links 102a and 102b connected by joint 104a, and actuator 106a configured to apply force and/or torque to link 102a and/or link 102b, for example in response to a digital control signal.

FIG. 1C is a block diagram illustrating a possible implementation of a communicating system, consistent with some embodiments of the present disclosure. In this example, apparatuses may communicate using communication network 180 or directly with each other. Some non-limiting examples of such apparatuses may include at least one of one or more robots (such as robot 100, robot 100a, robot 100b, a different robot, etc.), personal computing device 182 (such as a mobile phone, smartphone, tablet, Personal Computer, smartwatch, wearable computer, etc.), server 184, cloud platform 186, remote storage 188, Network Attached Storage (NAS) 190, other computing devices 192, or sensors 194. Some non-limiting examples of communication network 180 may include digital communication networks, analog communication networks, the Internet, phone networks, cellular networks, satellite communication networks, private communication networks, Virtual Private Networks (VPN), and so forth. FIG. 1C illustrates a possible implementations of a communication system. In some embodiments, other communication systems that enable communication among apparatuses may be used. In one example, sensors 194 may include the same sensor as sensors 120 or different sensors. Sensor 194 may be external to robot 100 (for example, included in a different robot, not included in any robot, and so forth). Some non-limiting examples of sensors 194 may include at least one of a sensor integrated in a computing device, image sensor, audio sensor, motion sensor, positioning sensor, touch sensor, proximity sensor, chemical sensor, temperature sensor, and so forth.

In some embodiments, machine learning algorithms (also referred to as machine learning models in the present disclosure) may be trained using training examples, for example in the cases described below. Some non-limiting examples of such machine learning algorithms may include inference algorithms, prediction algorithms, classification algorithms, data regressions algorithms, image segmentation algorithms, visual detection algorithms (such as object detectors, face detectors, person detectors, motion detectors, edge detectors, etc.), visual recognition algorithms (such as face recognition, person recognition, object recognition, etc.), speech recognition algorithms, mathematical embedding algorithms, natural language processing algorithms, support vector machines, random forests, nearest neighbors algorithms, deep learning algorithms, artificial neural network algorithms, transformer neural network algorithms, generative neural network algorithms, convolutional neural network algorithms, recurrent neural network algorithms, linear machine learning models, non-linear machine learning models, ensemble algorithms, and so forth. For example, a trained machine learning algorithm may comprise an inference model, such as a predictive model, a classification model, a data regression model, a clustering model, a segmentation model, an artificial neural network (such as a deep neural network, a transformer neural network, a generative neural network, a convolutional neural network, a recurrent neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters may be set manually by a person or automatically by a process external to the machine learning algorithm (such as a hyper parameter search algorithm), and the parameters of the machine learning algorithm may be set by the machine learning algorithm based on the training examples. In some implementations, the hyper-parameters may be set based on the training examples and the validation examples, and the parameters may be set based on the training examples and the selected hyper-parameters. For example, given the hyper-parameters, the parameters may be conditionally independent of the validation examples.

In some embodiments, trained machine learning algorithms (also referred to as machine learning models or trained machine learning models in the present disclosure) may be used to analyze inputs and generate outputs, for example in the cases described below. In some examples, a trained machine learning algorithm may be used as an inference model that when provided with an input generates an inferred output. For example, a trained machine learning algorithm may include a classification algorithm, the input may include a sample, and the inferred output may include a classification of the sample (such as an inferred label, an inferred tag, and so forth). In another example, a trained machine learning algorithm may include a regression model, the input may include a sample, and the inferred output may include an inferred value corresponding to the sample. In yet another example, a trained machine learning algorithm may include a clustering model, the input may include a sample, and the inferred output may include an assignment of the sample to at least one cluster. In an additional example, a trained machine learning algorithm may include a classification algorithm, the input may include an image, and the inferred output may include a classification of an item depicted in the image. In yet another example, a trained machine learning algorithm may include a regression model, the input may include an image, and the inferred output may include an inferred value corresponding to an item depicted in the image (such as an estimated property of the item, such as size, volume, age of a person depicted in the image, cost of a product depicted in the image, and so forth). In an additional example, a trained machine learning algorithm may include an image segmentation model, the input may include an image, and the inferred output may include a segmentation of the image. In yet another example, a trained machine learning algorithm may include an object detector, the input may include an image, and the inferred output may include one or more detected objects in the image and/or one or more locations of objects within the image. In an additional example, the input may include textual and/or visual and/or audible input data, and the inferred output may include textual and/or visual and/or audible output data. In some examples, the trained machine learning algorithm may include one or more formulas and/or one or more functions and/or one or more rules and/or one or more procedures, the input may be used as input to the formulas and/or functions and/or rules and/or procedures, and the inferred output may be based on the outputs of the formulas and/or functions and/or rules and/or procedures (for example, selecting one of the outputs of the formulas and/or functions and/or rules and/or procedures, using a statistical measure of the outputs of the formulas and/or functions and/or rules and/or procedures, and so forth).

In some embodiments, artificial neural networks may be configured to analyze inputs and generate corresponding outputs, for example in the cases described below. Some non-limiting examples of such artificial neural networks may comprise shallow artificial neural networks, deep artificial neural networks, feedback artificial neural networks, feed forward artificial neural networks, autoencoder artificial neural networks, probabilistic artificial neural networks, time delay artificial neural networks, convolutional artificial neural networks, recurrent artificial neural networks, long short term memory artificial neural networks, transformer artificial neural networks, generative artificial neural networks, and so forth. In some examples, an artificial neural network (or aspects thereof, such as hyper-parameters) may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

In some embodiments, generative models may be configured to generate new content, such as textual content, visual content, auditory content, graphical content, and so forth. In some examples, generative models may generate new content without input. In other examples, generative models may generate new content based on an input. In one example, the new content may be fully determined from the input, where every usage of the generative model with the same input produces the same new content. In another example, the new content may be associated with the input but not fully determined from the input, where every usage of the generative model with the same input may product a different new content that is associated with the input. In some examples, a generative model may be a result of training a machine learning generative algorithm with training examples. An example of such training example may include a sample input, together with a sample content associated with the sample input. Some non-limiting examples of such generative models may include Deep Generative Model (DGM), Generative Adversarial Network model (GAN), auto-regressive model, Variational AutoEncoder (VAE), transformers based generative model, artificial neural networks based generative model, hard-coded generative model, and so forth.

Herein, Large Language Models (LLMs), foundation models, and other large AI models are collectively referred to as Large Model (LM). LM are generative language models with a large number of parameters (usually billions or more) trained on large corpus of unlabeled data (usually trillions of words or more) in a self-supervised learning scheme and/or a semi-supervised learning scheme. While models trained using a supervised learning scheme with label data are fitted to the specific tasks they were trained for, LM can handle wide range of tasks that the model was never specifically trained for, including ill-defined tasks. It is common to provide LM with instructions in natural language, sometimes referred to as prompts. For example, to cause a LM to count the number of people that objected to a proposed plan in a meeting, one might use the following prompt, ‘Please read the meeting minutes. Of all the speakers in the meeting, please identify those who objected to the plan proposed by Mr. Smith at the beginning of the meeting. Please list their names, and count them.’ Further, after receiving a response from the LM, it is common to refine the task or to provide subsequent tasks in natural language. For example, ‘Also count for each of these speakers the number of words said’, ‘Of these speakers, could you please identify who is the leader?’ or ‘Please summarize the main objections’. In one example, LM may generate textual outputs in natural language, or in a desired structured format, such as a table or a formal language (such as a programming language, a digital file format, and so forth). In another example, LM may generate audible and/or visual outputs. In many cases, a LM may be a multimodal model, allowing the model to analyze both textual inputs as well as other kind of inputs (such as images, videos, audio, sensor data, telemetries, and so forth) and/or to generate both textual outputs as well as other kinds of outputs (such as images, videos, audio, telemetries, and so forth).

In some examples, AI models may be used for operating and/or controlling a robot (such as robot 100). Such AI models may include, for example, one or more machine learning models, such as neural networks, deep neural networks, reinforcement learning models, supervised learning models, unsupervised learning models, LM, or hybrid models. In some implementations, an AI model may be configured to process sensor data (such as data from sensors 120) and generate outputs indicative of control commands, motion plans, trajectories, classifications, predictions, or decisions. In some examples, an AI model may be used to perform one or more tasks, such as perception (for example, object detection, localization, or scene understanding), planning (for example, path planning or task planning), and control (for example, generating actuator commands for actuators 106). In some implementations, an AI model may be trained using data collected from the robot, from other robots, from simulated environments, and/or from external data sources, and may be updated during operation or offline. In some examples, an AI model may be executed locally on the robot (for example, by computing device 160) and/or remotely (for example, by a remote server or cloud-based system), and outputs of the AI model may be used, directly or indirectly, to control motion and/or interaction of the robot with its environment.

Some non-limiting examples of audio data (such as audio data 304) may include audio recordings, audio stream, audio data that includes speech, audio data that includes music, audio data that includes ambient noise, digital audio data, analog audio data, digital audio signals, analog audio signals, mono audio data, stereo audio data, surround audio data, audio data captured using at least one audio sensor (such as audio sensor 124), audio data generated artificially, and so forth. In one example, audio data may be generated artificially from textual content, for example using text-to-speech algorithms. In another example, audio data may be generated using a generative model (for example, using a generative machine learning model). In some embodiments, analyzing audio data (for example, by the methods, steps, processes and modules described herein) may comprise analyzing the audio data to obtain a preprocessed audio data, and subsequently analyzing the audio data and/or the preprocessed audio data to obtain a desired outcome. One of ordinary skill in the art will recognize that the followings are examples, and that the audio data may be preprocessed using other kinds of preprocessing methods. In some examples, the audio data may be preprocessed by transforming the audio data using a transformation function to obtain transformed audio data, and the preprocessed audio data may comprise the transformed audio data. For example, the transformation function may comprise a multiplication of a vectored time series representation of the audio data with a transformation matrix. For example, the transformation function may comprise convolutions, audio filters (such as low-pass filters, high-pass filters, band-pass filters, all-pass filters, etc.), linear functions, nonlinear functions, and so forth. In some examples, the audio data may be preprocessed by smoothing the audio data, for example using Gaussian convolution, using a median filter, and so forth. In some examples, the audio data may be preprocessed to obtain a different representation of the audio data. For example, the preprocessed audio data may comprise: a representation of at least part of the audio data in a frequency domain; a Discrete Fourier Transform of at least part of the audio data; a Discrete Wavelet Transform of at least part of the audio data; a time/frequency representation of at least part of the audio data; a spectrogram of at least part of the audio data; a log spectrogram of at least part of the audio data; a Mel-Frequency Spectrum of at least part of the audio data; a sonogram of at least part of the audio data; a periodogram of at least part of the audio data; a representation of at least part of the audio data in a lower dimension; a lossy representation of at least part of the audio data; a lossless representation of at least part of the audio data; a time order series of any of the above; any combination of the above; and so forth. In some examples, the audio data may be preprocessed to extract audio features from the audio data. Some non-limiting examples of such audio features may include: auto-correlation; number of zero crossings of the audio signal; number of zero crossings of the audio signal centroid; MP3 based features; rhythm patterns; rhythm histograms; spectral features, such as spectral centroid, spectral spread, spectral skewness, spectral kurtosis, spectral slope, spectral decrease, spectral roll-off, spectral variation, etc. ; harmonic features, such as fundamental frequency, noisiness, inharmonicity, harmonic spectral deviation, harmonic spectral variation, tristimulus, etc. ; statistical spectrum descriptors; wavelet features; higher level features; perceptual features, such as total loudness, specific loudness, relative specific loudness, sharpness, spread, etc. ; energy features, such as total energy, harmonic part energy, noise part energy, etc. ; temporal features; and so forth. In some examples, analyzing the audio data may include calculating at least one convolution of at least a portion of the audio data, and using the calculated at least one convolution to calculate at least one resulting value and/or to make determinations, identifications, recognitions, classifications, and so forth. In some embodiments, analyzing audio data (for example, by the methods, steps, processes and modules described herein) may comprise analyzing the audio data and/or the preprocessed audio data using one or more rules, functions, procedures, artificial neural networks, speech recognition algorithms, speaker recognition algorithms, speaker diarization algorithms, audio segmentation algorithms, noise cancelling algorithms, source separation algorithms, inference models, and so forth. Some non-limiting examples of such inference models may include: an inference model preprogrammed manually; a classification model; a data regression model; a result of training algorithms, such as machine learning algorithms and/or deep learning algorithms, on training examples, where the training examples may include examples of data instances, and in some cases, a data instance may be labeled with a corresponding desired label and/or result; and so forth.

Some non-limiting examples of image data (such as image data 302) may include one or more images, grayscale images, color images, series of images, 2D images, 3D images, videos, 2D videos, 3D videos, frames, footages, image data captured using at least one image sensor (such as visual and depth sensors 122), image data generated artificially, or data derived from other image data. In some embodiments, analyzing image data (for example by the methods, steps, processes and modules described herein) may comprise analyzing the image data to obtain a preprocessed image data, and subsequently analyzing the image data and/or the preprocessed image data to obtain the desired outcome. One of ordinary skill in the art will recognize that the followings are examples, and that the image data may be preprocessed using other kinds of preprocessing methods. In some examples, the image data may be preprocessed by transforming the image data using a transformation function to obtain a transformed image data, and the preprocessed image data may comprise the transformed image data. For example, the transformed image data may comprise one or more convolutions of the image data. For example, the transformation function may comprise one or more image filters, such as low-pass filters, high-pass filters, band-pass filters, all-pass filters, and so forth. In some examples, the transformation function may comprise a linear function, may comprise a nonlinear function, and so forth. In some examples, the image data may be preprocessed by smoothing at least parts of the image data, for example using Gaussian convolution, using a median filter, and so forth. In some examples, the image data may be preprocessed to obtain a different representation of the image data. For example, the preprocessed image data may comprise: a representation of at least part of the image data in a frequency domain; a Discrete Fourier Transform of at least part of the image data; a Discrete Wavelet Transform of at least part of the image data; a time/frequency representation of at least part of the image data; a representation of at least part of the image data in a lower dimension; a lossy representation of at least part of the image data; a lossless representation of at least part of the image data; a time ordered series of any of the above; any combination of the above; and so forth. In some examples, the image data may be preprocessed to extract edges, and the preprocessed image data may comprise information based on and/or related to the extracted edges. In some examples, the image data may be preprocessed to extract image features from the image data. Some non-limiting examples of such image features may comprise information based on and/or related to: edges; corners; blobs; ridges; Scale Invariant Feature Transform (SIFT) features; spatial features; temporal features; and so forth. In some examples, analyzing the image data may include calculating at least one convolution of at least a portion of the image data, and using the calculated at least one convolution to calculate at least one resulting value and/or to make determinations, identifications, recognitions, classifications, and so forth. In some embodiments, analyzing image data (for example by the methods, steps, processes and modules described herein) may comprise analyzing the image data and/or the preprocessed image data using one or more rules, functions, procedures, artificial neural networks, object detection algorithms, face detection algorithms, visual event detection algorithms, action detection algorithms, motion detection algorithms, background subtraction algorithms, inference models, and so forth. Some non-limiting examples of such inference models may include: an inference model preprogrammed manually; a classification model; a regression model; a result of training algorithms, such as machine learning algorithms and/or deep learning algorithms, on training examples, where the training examples may include examples of data instances, and in some cases, a data instance may be labeled with a corresponding desired label and/or result; and so forth. In some embodiments, analyzing image data (for example by the methods, steps, processes and modules described herein) may comprise analyzing pixels, voxels, point cloud, range data, etc. included in the image data.

A convolution may include a convolution of any dimension. A one-dimensional convolution is a function that transforms an original sequence of numbers to a transformed sequence of numbers. The one-dimensional convolution may be defined by a sequence of scalars. Each particular value in the transformed sequence of numbers may be determined by calculating a linear combination of values in a subsequence of the original sequence of numbers corresponding to the particular value. A result value of a calculated convolution may include any value in the transformed sequence of numbers. Likewise, an n-dimensional convolution is a function that transforms an original n-dimensional array to a transformed array. The n-dimensional convolution may be defined by an n-dimensional array of scalars (known as the kernel of the n-dimensional convolution). Each particular value in the transformed array may be determined by calculating a linear combination of values in an n-dimensional region of the original array corresponding to the particular value. A result value of a calculated convolution may include any value in the transformed array. In some examples, an image may comprise one or more components (such as color components, depth component, etc.), and each component may include a two dimensional array of pixel values. In one example, calculating a convolution of an image may include calculating a two dimensional convolution on one or more components of the image. In another example, calculating a convolution of an image may include stacking arrays from different components to create a three dimensional array, and calculating a three dimensional convolution on the resulting three dimensional array. In some examples, a video may comprise one or more components (such as color components, depth component, etc.), and each component may include a three dimensional array of pixel values (with two spatial axes and one temporal axis). In one example, calculating a convolution of a video may include calculating a three dimensional convolution on one or more components of the video. In another example, calculating a convolution of a video may include stacking arrays from different components to create a four dimensional array, and calculating a four dimensional convolution on the resulting four dimensional array. In some examples, audio data may comprise one or more channels, and each channel may include a stream or a one-dimensional array of values. In one example, calculating a convolution of audio data may include calculating a one dimensional convolution on one or more channels of the audio data. In another example, calculating a convolution of audio data may include stacking arrays from different channels to create a two dimensional array, and calculating a two dimensional convolution on the resulting two dimensional array.

Some non-limiting examples of a mathematical object in a mathematical space may include a mathematical point in the mathematical space, a group of mathematical points in the mathematical space (such as a region, a manifold, a mathematical subspace, etc.), a mathematical shape in the mathematical space, a numerical value, a vector, a matrix, a tensor, a function, and so forth. Another non-limiting example of a mathematical object is a vector, wherein the dimension of the vector may be at least two (for example, exactly two, exactly three, more than three, and so forth). Some non-limiting examples of a phrase may include a phrase of at least two words, a phrase of at least three words, a phrase of at least five words, a phrase of more than ten words, and so forth.

FIG. 2 is a flowchart of exemplary process 200 for operating a robot, consistent with some embodiments of the present disclosure. In this example, process 200 may comprise: receiving information captured using at least one sensor (step 202); analyzing the captured information to determine a desired action for a robot (step 204); based on the desired action, determining a desired movement for a specific portion of the robot (step 206); and generating signals (such as electrical signals, digital signals, analog signals, magnetic signals, mechanical signal, etc.) configured to activate at least one actuator of the robot to cause the desired movement to the specific portion of the robot (step 208). In other examples, process 200 may include additional steps or fewer steps. In other examples, one or more steps of process 200 may be executed in a different order and/or one or more groups of steps may be executed simultaneously. In some examples, a system for operating a robot may include at least one processing unit configured to perform process 200. In one examples, the system may further comprise the robot of process 200. For example, the robot may include the at least one processing unit. In another example, the at least one processing unit may be external to the robot of process 200. A non-limiting example of such robot may be robot 100. In some examples, a method for operating a robot may include performing process 200. In some examples, a non-transitory computer readable medium may store computer implementable instructions that when executed by at least one processor may cause the at least one processor to perform operations for operating a robot, and the operations may include the steps of process 200.

In some examples, step 202 may comprise receiving information captured using at least one sensor. For example, step 202 may receive information capture using internal sensor included in a robot (such as robot 100, the robot of step 206 and/or step 208, a different robot, etc.), such as sensors 120. In another example, step 202 may receive information capture using external sensor (i.e., not included in such robot), such as sensors 194. In one example, the information received by step 202 may be information captured from a physical environment, for example from a physical environment of such robot. In one example, step 202 may trigger the capturing of the information, for example by generating a digital signal to trigger the capturing. In another example, step 202 may receive information captured without triggering the capturing. In one example, step 202 may read the captured information from memory, may receive the captured information from an external computing device (for example, using a digital communication device), may capture the information using the at least one sensor, and so forth. In one example, step 202 may use step 410 and/or step 504 and/or step 602 to obtain the captured information. In one example, the captured information may be or include at least part of inputs 300.

In some examples, step 204 may comprise analyzing information (such as information captured using a sensor, the captured information received by step 202, etc.) to determine a desired action for a robot (for example, to determine desired action 362). Some non-limiting examples of such desired action may include moving the robot or a part of the robot (for example, towards a desired destination, to a desired destination, away from a selected location or area, to a desired pose, etc.), making physical contact with a selected object, manipulating a selected object, performing a gesture, creating a facial expression, and so forth. For example, to determine the desired action, step 204 may analyze the information using one or more rules, functions, procedures, artificial neural networks, machine learning models, or other AI models. In one example, step 204 may use a machine learning model to analyze the captured information and determine the desired action. The machine learning model may be a machine learning model trained using training examples to select actions based on information. An example of such training example may include sample information (for example, sample captured information), together with an indication of a sample action corresponding to the sample information. In another example, step 204 may use a foundation model to analyze the captured information (for example, with a suitable prompt, such as ‘suggest a likely action in response to the events in this captured image/audio/data’) to determine the desired action. In yet another example, step 204 may analyze the captured information to detect elements, for example using visual event detection algorithms to analyze captured image data to detect events, using voice recognition algorithms to analyze captured audio data to detect words and phrases, using motion detection algorithms to detect movements in the environment, and so forth. Further, step 204 determine the desired action based on the detected elements. For example, step 204 may access a data structure associating elements with desired actions based on the detected elements to determine the desired action. In some examples, step 204 may further based the determination of the desired action for the robot on additional information, such as a goal, a task, an instruction, a guideline, and so forth. In some examples, step 204 may comprise receiving an indication of a preferred action, and determining the desired action based on the received indication. For example, step 204 may read the indication from memory (for example, from a digital memory, from memory unit 162, etc.), may receive the indication from an external computing device (for example, using a digital communication device, such as communication module 166), may receive the indication from an individual (for example, via a user interface, using a keyboard, using a pointing device, using a touch surface, using a microphone, using an audio sensor, via gesture, via voice command, via natural language input, etc.), and so forth. In one example, step 204 may determine the desired action to be exactly the indicated preferred action. In another example, step 204 may adjust or alter the indicated preferred action, for example based on contextual information. For example, the preferred action may include storing a specific item in a specific container, the specific container may be full, and step 204 may adjust the preferred action to store the specific item in an alternative container. In another example, the preferred action may include using a specific tool to perform a specific action, the specific tool may be absent, broken or malfunctioning, and step 204 may adjust the preferred action to perform the specific action using an alternative tool. In yet another example, the preferred action may include using a specific tool to perform a specific action, the specific tool may be suboptimal or unsuitable for performing the specific action, and step 204 may adjust the preferred action to perform the specific action using an alternative tool.

In some examples, step 206 may comprise, determining a desired movement for a specific portion of the robot (for example, to determine desired movement 364), for example based on a desired action (such as the desired action determined by step 204). For example, a data structure and/or a rule may associate desired actions with portions of the robot and/or with desired movements of portions of the robot. Further, step 206 may access the data structure and/or may use the rule based on the desired action to determine the specific portion of the robot and/or the desired movement for the specific portion of the robot. In another example, step 206 may use a trained machine learning model to determine the specific portion of the robot and/or the desired movement for the specific portion of the robot based on the desired action. The machine learning model may be a machine learning model trained using training examples to determine portions of robots and/or desired movements based on desired actions. An example of such training example may include a sample desired action for a sample robot, together with a label indicative of a sample portion of the sample robot and/or a sample movement of the sample portion of the sample robot. In yet another example, step 206 may use an artificial neural network to determine the specific portion of the robot and/or the desired movement for the specific portion of the robot based on the desired action. In an additional example, step 206 may use a foundation model to determine the specific portion of the robot and/or the desired movement for the specific portion of the robot based on the desired action (for example, with a suitable prompt, such as ‘what movement of what part of a body may be used to make the {desired action}’). In one example, step 206 may use step 606 to determine the desired movement for the specific portion of the robot based on the desired action.

In some examples, step 208 may comprise generating digital signals configured to activate at least one actuator of the robot (such as control signals 366) to cause the desired movement to the specific portion of the robot. The digital signals may be derived from control logic based on previously received sensor data, user commands, or pre-programmed instructions. The actuator may be configured to produce motion in response to the received digital signals. The digital signals may be formatted in accordance with a communication protocol compatible with the robot's control architecture, ensuring reliable delivery and precise timing. In certain implementations, the activation of the actuator results in translational or rotational motion, for example of a limb, joint, or tool-end effector, depending on the operational context. The generated movement may also be monitored via feedback sensors to enable closed-loop control, thereby enhancing accuracy and responsiveness of the robotic system. When the robot is a humanoid robot, step 208 may further involve generating coordinated digital signals to activate multiple actuators corresponding to anthropomorphic joints such as shoulders, elbows, hips, knees, or fingers. These signals may be configured to mimic natural human movement patterns, taking into account biomechanical constraints and balance considerations. For example, when initiating a walking sequence, the control system may compute a trajectory that ensures dynamic stability, adjusting joint angles and step timing in real time based on inertial measurement unit (IMU) feedback and force sensors embedded in the feet. The actuators may be arranged to replicate musculoskeletal function, and the control signals may be modulated to vary torque, speed, and compliance, enabling fluid, human-like motion. In some implementations, the digital signals may be further adapted to maintain posture or to perform complex tasks such as grasping objects, climbing stairs, or interacting with humans in shared environments, with an emphasis on safety, adaptability, and expressive movement. In one example, step 208 may use step 408 and/or step 420 and/or step 512 and/or step 610 and/or step 708 and/or step 724 and/or step 808 and/or step 906 and/or step 908 and/or step 910 to generate the digital signals.

In some examples, navigating a robot to a location may be performed by utilizing sensor-derived information to guide movement decisions in real time, for example using process 200. For instance, the robot may receive information from one or more sensors, such as cameras, LiDAR, or inertial measurement units, representing characteristics of an environment including obstacles, terrain, and target location indicators (step 202). The captured information may then be analyzed to determine a desired action, such as advancing toward the location, adjusting direction to avoid an obstacle, or slowing movement in response to environmental conditions (step 204). Based on the desired action, a corresponding desired movement may be determined for one or more portions of the robot, such as wheel rotation, joint articulation, or orientation adjustment (step 206). Signals may then be generated to activate appropriate actuators to execute the movement, thereby incrementally navigating the robot toward the target location (step 208). This process may be repeated iteratively, enabling continuous adjustment of the robot's trajectory until the destination is reached.

In some examples, manipulating an object with a robot (such as grabbing the object, moving an object, screwing or attaching two objects together, etc.) may be performed using process 200 by coordinating sensing, decision-making, and actuation to achieve a controlled manipulation of the object. For instance, the robot may receive information from one or more sensors, such as visual sensors, depth sensors, force sensors, or tactile sensors, representing characteristics of one or more objects and/or the surrounding environment, including position, orientation, geometry, and interaction constraints (step 202). The captured information may then be analyzed to determine a desired action, such as approaching an object, aligning one or more robot components with a target feature, applying a force or torque, or modifying a relative position between objects (step 204). Based on the desired action, a corresponding desired movement may be determined for one or more portions of the robot, such as positioning an end effector, actuating joints, or adjusting grip or contact parameters (step 206). Signals may then be generated to activate one or more actuators to execute the movement, thereby enabling the robot to perform the manipulation task (step 208). This process may be repeated iteratively to refine the manipulation based on continuous or updated sensor feedback, thereby improving accuracy, stability, and task completion.

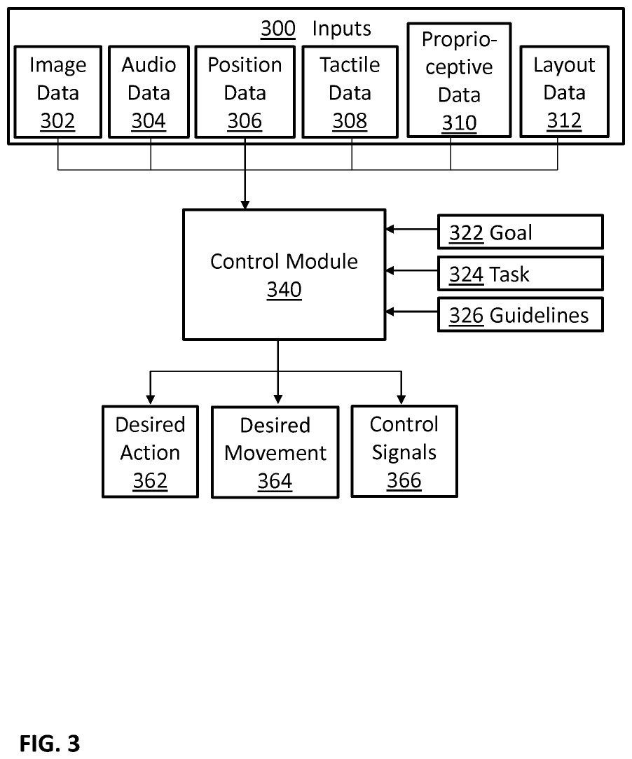

FIG. 3 is a block diagram illustrating some possible flows of information, consistent with some embodiments of the present disclosure. In this example, inputs 300 may comprise at least one of image dada 302, audio data 304, position data 306, tactile data 308, proprioceptive data 310, or layout data 312. In other examples, the inputs 300 may include any other type of information. In one example, inputs 300 may comprise information encoded in a digital format and/or in a digital signal. In one example, inputs 300 may include information captured using sensors 120. In one example, inputs 300 may be received using step 202. In the example of FIG. 3, any input of inputs 300, alone or in combination with other inputs and/or information, may be used to as inputs to control model 320. Control model 320 may include hardware and/or software. For example, control module 320 may include a computing device, such as computing device 160, configured to execute computer implementable instructions. In one example, control module 320 may use different software modules, artificial intelligence models, and so forth. Some non-limiting examples of such artificial intelligence model may include a generative model, a foundation model, a multi-modal artificial intelligence model, an artificial intelligence conversational model, a LM, a deep learning model, an artificial neural network, a trained machine learning model, a physical artificial intelligence model, a world foundation model, and so forth. In one example, such artificial intelligence model may include at least one of parameters, weights, structure or architecture, execution instructions, sub-models, mathematical functions, thresholds, rules, or artificial neurons. Control module 320 may analyze at least part of inputs 300 and/or goal 322 and/or task 324 and/or guidelines 326 to determine and/or generate at least one of desired action 362, desired movement 364, or control signals 366, for example using any one of the processes and techniques described herein. For example, control module 320 may use step 204 to determine desired action 362. In another example, control module 320 may use step 206 to determine desired movement 364. In yet another example, control module 320 may use step 208 to generate control signals 366.

In some examples, layout data 312 may include information indicative of a layout of a physical environment. For example, layout data 312 may include three-dimensional model of the physical environment, may include depth data associated with the physical environment, and so forth. In one example, layout data 312 may be retrieved based on a location and/or spatial orientation (such as position data 306) of robot 100, for example from a data structure, from an external computing device, from a mapping service, and so forth. In one example, layout data 312 may be captured and/or determined and/or generated, for example by analyzing (for example, with a Simultaneous Localization and Mapping (SLAM) algorithm, with a structure from motion algorithm, with other spatial reconstruction algorithms, etc.) image data captured from the physical environment (such as image data 302), by capturing depth and/or three dimensional data from the environment (for example, with a dedicated sensor), and so forth. In one example, layout data 312 may include a structured representation of the physical environment, such as spatial geometry of physical bodies and/or physical surfaces (for example, planes, meshes, point clouds, etc.), topological relationships (such as adjacency, containment, connectivity, etc.), semantic labels (such as wall, floor, table, digital screen, doorway, window, etc.), and so forth. In one example, layout data 312 may be updated over time, for example, when new sensor data is received. In one example, layout data 312 may be generated and/or determined from data captured using a single robot, from data captured using a plurality of robots, from data captured during a single session, from data captured across multiple sessions, from data received from a single source, from data merged from a plurality of different sources, and so forth. In one example, layout data 312 may be represented in a selected coordinate frame, such as robot centric, environment centric, global, static, relative to a moving physical object, and so forth.

In some examples, input in a natural language may be received. For example, verbal input in the natural language may be received. In another example, textual input in the natural language may be received. In yet another example, audible input including speech in the natural language may be received. For example, the input in the natural language may be read from a digital memory unit, may be received from an external computing device (for example, using a digital communication device), may be captured using a microphone or an audio sensor, may be generated (for example, using a generative model, using a LLM in response to a prompt, using a template, etc.), and so forth.

In some examples, digital data may be received. For example, the digital data may be read from a digital memory unit, may be received from an external computing device (for example, using a digital communication device), may be captured using one or more sensors, may be generated (for example, using a generative model, using a foundation model in response to a prompt, using a template, etc.), and so forth.

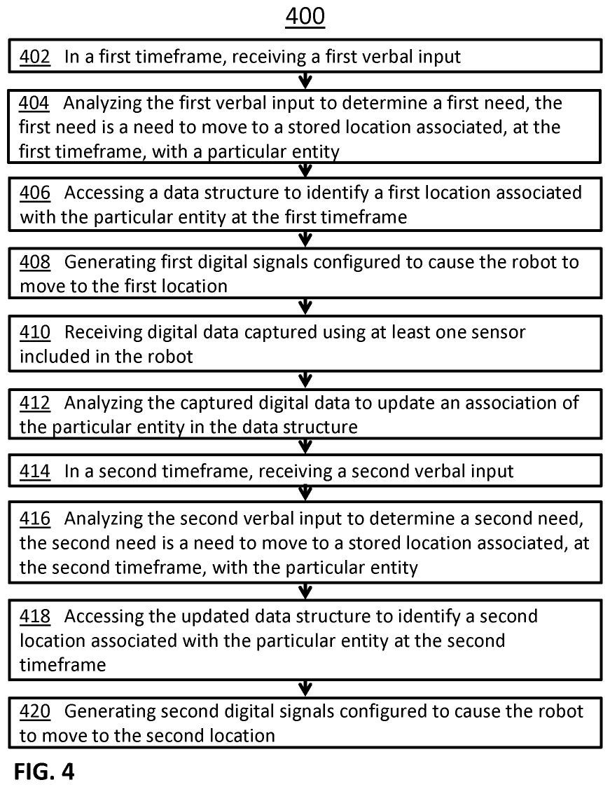

FIG. 4 is a flowchart of an exemplary process 400 for navigating robots based on associations, consistent with some embodiments of the present disclosure. In this example, process 400 may comprise: in a first timeframe, receiving a first verbal input in a natural language (step 402); analyzing the first verbal input to determine a first need, the first need is a need to move to a stored location associated, at the first timeframe, with a particular entity (step 404); accessing, based on the particular entity, a data structure associating entities with stored locations to identify a first location associated with the particular entity at the first timeframe (step 406), wherein the stored locations in the data structure are independent of real-time detected positions of the entities; generating first digital signals configured to activate at least one actuator of a robot to cause the robot to move to the first location (step 408); after causing the robot to move to the first location, receiving digital data captured using at least one sensor included in the robot (step 410); analyzing the captured digital data to update an association of the particular entity in the data structure (step 412), wherein the update is independent of a real-time detected position of the particular entity; in a second timeframe, after updating the data structure, receiving a second verbal input in the natural language (step 414); analyzing the second verbal input to determine a second need, the second need is a need to move to a stored location associated, at the second timeframe, with the particular entity (step 416); accessing, based on the particular entity, the updated data structure to identify a second location associated with the particular entity at the second timeframe (step 418), the second location differs from the first location due to the update; and generating second digital signals configured to activate the at least one actuator of the robot to cause the robot to move to the second location (step 420). In other examples, process 400 may include additional steps or fewer steps. In other examples, one or more steps of process 400 may be executed in a different order and/or one or more groups of steps may be executed simultaneously. In some examples, a system for navigating robots based on associations may include at least one processing unit configured to perform process 400. In one examples, the system may further comprise the robot of process 400. For example, the robot may include the at least one processing unit. In another example, the at least one processing unit may be external to the robot of process 400. A non-limiting example of such robot may be robot 100. In some examples, a method for navigating robots based on associations may include performing process 400. In some examples, a non-transitory computer readable medium may store computer implementable instructions that when executed by at least one processor may cause the at least one processor to perform operations for navigating robots based on associations, and the operations may include the steps of process 400. In one example, the particular entity may be a different robot. In another example, the particular entity may be a natural person. In one example, the particular individual may not be at the first location and/or near the first location and/or at a place associated with the first location during the first timeframe. In one example, the particular individual may not be at the second location and/or near the second location and/or at a place associated with the second location during the second timeframe. In one example, the data structure may be included in a digital memory, in a database, in a memory of an artificial neural network, and so forth.

In some examples, verbal input in a natural language (such as audible speech input in the natural language) may be received. For example, step 402 may comprise receiving a first verbal input in a natural language, for example in a first timeframe. In another example, step 414 may comprise receiving a second verbal input in a natural language (such as the natural language of step 402, a different natural language, etc.), for example in a second timeframe, after updating the data structure. In one example, the verbal input in the natural language may be read from memory (for example, from a digital memory, from memory unit 162, etc.), may be received from an external computing device (for example, using a digital communication device, such as communication module 166), may be captured (for example, using a microphone, using an audio sensor, etc.), may be received from an individual (for example, using a microphone, using an audio sensor, etc.), may be decoded (for example, from a digital signal, digital data, or another machine readable form), and so forth. In some examples, the verbal input in the natural language may be received at a single time or over a plurality of times. For example, the verbal input in the natural language may be received as a single input instance, as a sequence of input instances, or as a continuous input stream. In some examples, the verbal input in the natural language may include multiple verbal inputs in the natural language.

In some examples, a verbal input in a natural language may be analyzed to determine a need to move to a stored location associated, for example at a specific timeframe, with a particular entity. For example, step 404 may comprise analyzing the first verbal input received by step 402 to determine a first need, the first need may be a need to move to a stored location associated, at the first timeframe of step 402, with a particular entity. In another example, step 416 may comprise analyzing the second verbal input received by step 414 to determine a second need, the second need may be a need to move to a stored location associated, at the second timeframe of step 414, with a particular entity (such as the particular entity of step 404, a different particular entity, and so forth). In one example, the verbal input may be transcribed (for example, using speech to text algorithm) to obtain textual input in the natural language, and the textual input may be analyzed to determine the need to move to the stored location associated with the particular entity. For example, the verbal input may be analyzed using a Natural Language Processing (NLP) algorithm to determine the need to move to the stored location associated with the particular entity. In another example, the verbal input may be analyzed using an artificial neural network to determine the need to move to the stored location associated with the particular entity. In yet another example, the verbal input may be analyzed using a machine learning model to determine the need to move to the stored location associated with the particular entity. The machine learning model may be a machine learning model trained using training examples to determine needs based on verbal inputs in natural languages. An example of such training example may include sample input in a natural language, together with a label indicative of a need corresponding to the sample input.

In some examples, a data structure associating entities with stored locations may be accessed, based on a particular entity, to identify a location associated with the particular entity, for example at the selected timeframe. The stored locations in the data structure may be independent of real-time detected positions of the entities. For example, step 406 may comprise accessing, based on the particular entity of step 404, the data structure to identify a first location associated with the particular entity at the first timeframe of step 402 and/or step 404. In another example, step 418 may comprise accessing, based on the particular entity of step 404 and/or step 406 and/or step 416, the data structure updated by step 412 to identify a second location associated with the particular entity at the second timeframe of step 414 and/or step 416. The second location of step 418 may differ from the first location of step 406 due to the update of step 412. For example, the data structure may be accessed in a memory (for example, in a digital memory, in memory unit 162, etc.), may be accessed via an external computing device (for example, using a digital communication device, such as communication module 166), in a database, and so forth.

In some examples, digital signals configured to activate at least one actuator of a robot to cause the robot to move to a selected location may be generated. For example, step 408 may comprise generating first digital signals configured to activate at least one actuator of a robot to cause the robot to move to the first location identified by step 406. In another example, step 420 may comprise generating second digital signals configured to activate the at least one actuator of a robot (such as the at least one actuator of step 408, different at least one actuator of the robot of step 408, at least one actuator of a different robot, etc.) to cause the robot to move to the second location identified by step 420. For example, the digital signals may be configured to activate the at least one actuator of the robot to cause the robot to move legs to walk or run to the selected location. In another example, the digital signals may be configured to activate the at least one actuator of the robot to cause wheels of the robots to drive the robot to the selected location. In one example, the digital signals may be generated as described in relation to step 208 and/or using step 208.

In some examples, step 410 may comprise, for example after step 408 causes the robot to move to the first location, receiving digital data captured using at least one sensor (such as at least one sensor included in the robot of step 408 and/or step 420, at least one sensor included in a different robot, at least one sensor not included in any robot, and so forth). For example, the digital data may be read from memory (for example, from a digital memory, from memory unit 162, etc.), may be received from an external computing device (for example, using a digital communication device, such as communication module 166), may be captured using the at least one sensor, and so forth. In one example, step 410 may use step 202 and/or step 504 and/or step 602 to obtain the digital data. In one example, the captured digital data may be or include at least part of inputs 300.

In some examples, step 412 may comprise analyzing digital data (such as the captured digital data received by step 410, different digital data, etc.) to update an association of a particular entity (such as the particular entity of step 404 and/or step 406 and/or step 416 and/or step 418, a different particular entity, and so forth) in a data structure (such as the data structure of step 406 and/or step 418, a different data structure, and so forth). The update may be independent of a real-time detected position of the particular entity. For example, step 412 may use a multimodal foundation model with a specific prompt (such as ‘based on this image, what is the location of {entity}'s office’) to analyze the captured digital data to update the association of the particular entity in the data structure. In another example, step 412 may use an artificial neural network to analyze the captured digital data to update the association of the particular entity in the data structure. In yet another example, step 412 may use a machine learning model to analyze the captured digital data to update the association of the particular entity in the data structure. The machine learning model may be a machine learning model trained using training examples to identify locations associated with entities based on captured data. An example of such training example may include sample data, together with a label indicative of a location associated with a sample entity based on the sample data.

In some examples, the captured digital data received by step 410 may be captured image data including a visual indication of an association of the particular entity with the second location. For example, the captured image data may depict an item associated with the particular entity in a place associated with the second location. In one example, the item associated with the particular entity may be at least one of a nameplate or a label including a textual indication of the particular entity. For example, the textual indication may include a name of the particular entity, a title indicating with the particular entity (such as ‘CEO’), a unique textual identifier indicating with the particular entity (such as a social security number, a member number, a telephone number, etc.), and so forth. In one example, the at least one of a nameplate or a label may be positioned on a desk, and the desk may be the second location. In another example, the at least one of a nameplate or a label may be positioned on a door of a room or on a wall next to the door, and the room may be the second location. In yet another example, the at least one of a nameplate or a label may be positioned on an external face of a container (such as a drawer, a locker, etc.), and the container may be the second location. In an additional example, the at least one of a nameplate or a label may be positioned on a bed or next to the bed, and the bed may be the second location. In one example, the item associated with the particular entity may be an item moved from a place associated with the first location to the place associated with the second location. Some non-limiting examples of such item may include a laptop, a bag, a nameplate, a flowerpot, a coffee cap, a coat, dressing items, and so forth. In one example, the place associated with the second location may be external to the second location. In another example, the place associated with the second location may be the second location. In yet another example, the place associated with the second location in the second location. In one example, step 412 may analyze the pixels of the image data update the association of the particular entity in the data structure. For example, step 412 may use an object detection algorithm to analyze the image data to identify an item associated with the particular entity in the place associated with the second location. In another example, step 412 may use an Optical Character Recognition (OCR) algorithm to analyze the image data to determine a textual indication of the particular entity.

In some examples, the captured digital data received by step 410 may be captured audio data including a verbal indication of an association of the particular entity with the second location. For example, the captured audio data may include ‘have you heard that John got the corner office’, or ‘can you believe that John got Tom’s old office'. In one example, step 412 may use a speech recognition algorithm to analyze the audio data to determine the verbal indication. In another example, step 412 may use a speaker recognition algorithm to assign confidence to the verbal indication based on the speaker identity.

In some examples, the first location identified by step 406 may be a first room associated with the particular entity of step 404 and/or step 406 and/or step 412 and/or step 416 and/or step 418, the captured digital data received by step 410 may indicate that the particular entity is now associated with a second room and/or is no longer associated with the first room, the update of step 412 may include associating the particular entity with the second room in the data structure, and the second location identified by step 418 may be the second room. In one example, the first room may be a first office, and the second room may be a second office. In another example, the first room may be a first bedroom, and the second room may be a second bedroom. In yet another example, the first room may be a first patient room, and the second room may be a second patient room. In an additional example, the first room may be a first hotel room, and the second room may be a second hotel room. In some examples, the first location identified by step 406 may be a first desk associated with the particular entity of step 404 and/or step 406 and/or step 412 and/or step 416 and/or step 418, the captured digital data received by step 410 may indicate that the particular entity is now associated with a second desk and/or is no longer associated with the first desk, the update of step 412 may include associating the particular entity with the second desk in the data structure, and the second location identified by step 418 may be the second desk. For example, the desks may be desks in an office environment, in a classroom environment, and so forth. In some examples, the first location identified by step 406 may be a first bed associated with the particular entity of step 404 and/or step 406 and/or step 412 and/or step 416 and/or step 418, the captured digital data received by step 410 may indicate that the particular entity is now associated with a second bed and/or is no longer associated with the first bed, the update of step 412 may include associating the particular entity with the second bed in the data structure, and the second location identified by step 418 may be the second bed. For example, the beds may be hospital beds in a hospital or a clinic. In another example, the beds may be beds in a home environment, in a hostile environment, in a camping environment, in a hotel environment, and so forth. In some examples, the first location identified by step 406 may be a first storage unit associated with the particular entity of step 404 and/or step 406 and/or step 412 and/or step 416 and/or step 418, the captured digital data received by step 410 may indicate that belongings of the particular entity moved from the first storage unit to a second storage unit, the update of step 412 may include associating the particular entity with the second storage unit in the data structure, and the second location identified by step 418 may be the second storage unit. For example, the storage unit may be at least one of a locker, a container, a shelf area, or a drawer.

In some examples, process 400 may further comprise, for example during a third timeframe preceding the first timeframe of step 402 and/or step 404: receiving a third verbal input in a natural language (such as the natural language of step 402 and/or step 414, a different natural language, etc.), for example as described above; analyzing the third verbal input to determine a third need, the third need is a need to move to a stored location associated, at the third timeframe, with a particular entity (such as the particular entity of step 404 and/or step 406 and/or step 412 and/or step 416 and/or step 418, a different particular entity, and so forth), for example as described above; accessing, based on the particular entity, a data structure (such as a preliminary version of the data structure of step 406 and/or step 418, a different data structure, etc.) to identify a lack of information associated with the particular entity in the data structure; requesting an indication of the first location associated with the particular entity of step 406 and/or step 408 (for example, from the particular entity, from an individual, via a user interface, via natural language, via audile speech output, via an output device, via a text message, from a different process, from an external computing device, via a digital communication device, etc.); receiving the indication of the first location (for example, from the particular entity, from an individual, via a user interface, via natural language, via audile speech input, via an input device, via a text message, from a different process, from an external computing device, via a digital communication device, etc.); and analyzing the received indication of the first location to associate the particular entity with the first location in a data structure (such as the data structure of step 406 and/or step 418, a different data structure, and so forth).

In some examples, process 400 may further comprise, for example during a third timeframe preceding the first timeframe of step 402 and/or step 404: receiving second digital data captured using the at least one sensor of step 410, for example as described above in relation to step 410 and/or step 202; and analyzing the second digital data to associate a particular entity (such as the particular entity of step 404 and/or step 406 and/or step 412 and/or step 416 and/or step 418, a different particular entity, and so forth) with a location (such as the first location of step 406 and/or step 408, a different location, etc.) in a data structure (such as the data structure of step 406 and/or step 418, a different data structure, and so forth). For example, the analysis of the second digital data to associate the particular with the location may include analysis as described above in relation to step 412 and/or using step 412.

In some examples, process 400 may further comprise: in a third timeframe after step 408 causes the robot to move to the first location and before step 410 receives the digital data captured using the at least one sensor included in the robot, receiving a third verbal input in a natural language (such as the natural language of step 402 and/or step 414, a different natural language, etc.), for example as described above; analyzing the third verbal input to determine a third need, the third need is a need to move to a stored location associated, at the third timeframe, with the particular entity, for example as described above; in response to the third verbal input, generating third digital signals configured to activate the at least one actuator of the robot to cause the robot to start moving again towards the first location of step 406 and/or step 408 (for example, the third digital signals may be generated as described in relation to step 208 and/or step 408 and/or step 420); capturing the digital data received by step 410 using the at least one sensor included in the robot (of step 410) while moving again towards the first location; and in response to the analysis of the captured digital data and before the robot reaches the first location again: stopping the motion of the robot towards the first location (for example, by generating appropriate digital signals, by stopping generating digital signals corresponding to the motion towards the first location, etc.), and generating fourth digital signals configured to activate the at least one actuator of the robot to cause the robot to move to the second location (for example, the fourth digital signals may be generated as described in relation to step 208 and/or step 408 and/or step 420).

In some examples, process 400 may further comprise: in a third timeframe after step 408 causes the robot to move to the first location and before step 410 receives the digital data captured using the at least one sensor included in the robot, capturing second digital data using the at least one sensor (such as the at least one sensor of step 410, different at least one sensor included in the robot of step 408 and/or step 410 and/or step 420, at least one sensor included in a different robot, at least one sensor not included in any robot, etc.); analyzing the captured second digital data to determine a third need, the third need is a need to update the association of the particular entity in the data structure; and in response to the determined third need, causing capturing of the digital data of step 410 and/or step 412 using the at least one sensor of step 410. In one example, the captured second digital data may be captured image data depicting an absent of an item (such as a label, a nameplate, an item belonging to the particular entity, etc.) associated with the particular entity from a place associated with the first location and/or an item (such as a label, a nameplate, an item belonging to the different entity, etc.) associated with an entity different from the particular entity at the place associated with the first location. For example, the first location may be a desk, and the place associated with the first location may be on the desk. In another example, the first location may be a room, and the place associated with the first location may be on a surface of a door of the room or of a wall next to the door. In yet another example, the first location may be a container (such as a drawer, a locker, etc.), and the place associated with the first location may be on an external surface of the container. In an additional example, the first location may be a bed, and the place associated with the first location may be on an external surface of the bed and/or next to the bed. In one example, the captured second digital data may be captured at the first location. In another example, the captured second digital data may be captured on a way to the first location. In yet another example, the captured second digital data may be captured from a location different from the first location.

In some examples, the first verbal input received by step 402 may include an indication of a task and no direct indication of the particular entity, and step 404 may determine the first need to move to the stored location associated, at the first timeframe, with the particular entity based on the task. For example, the task may include putting a greeting card on the desks of all employees, and the particular entity may be an employee. In another example, the task may include retrieving an item, a record may indicate that the particular entity was the last to use the item, and the need to move to the stored location is a need to search for the item at the stored location.

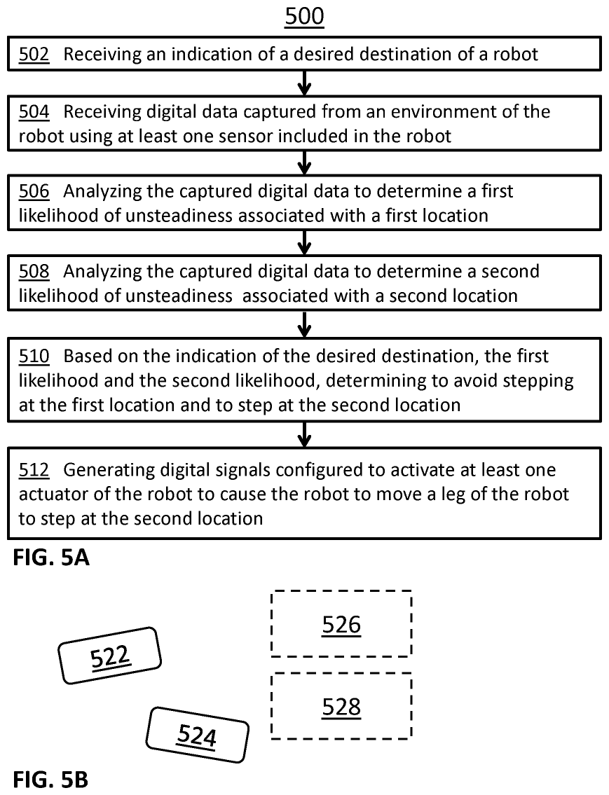

FIG. 5A is a flowchart of an exemplary process 500 for stable navigation of robots, consistent with some embodiments of the present disclosure. In this example, process 500 may comprise: receiving an indication of a desired destination of a robot (step 502); receiving digital data captured from an environment of the robot using at least one sensor included in the robot (step 504); analyzing the captured digital data to determine a first likelihood of unsteadiness associated with a first location (step 506); analyzing the captured digital data to determine a second likelihood of unsteadiness associated with a second location (step 508); based on the indication of the desired destination, the first likelihood and the second likelihood, determining to avoid stepping at the first location and to step at the second location (step 510); and generating digital signals configured to activate at least one actuator of the robot to cause the robot to move a leg of the robot to step at the second location (step 512). In other examples, process 500 may include additional steps or fewer steps. In other examples, one or more steps of process 500 may be executed in a different order and/or one or more groups of steps may be executed simultaneously. In some examples, a system for stable navigation of robots may include at least one processing unit configured to perform process 500. In one examples, the system may further comprise the robot of process 500. For example, the robot may include the at least one processing unit. In another example, the at least one processing unit may be external to the robot of process 500. A non-limiting example of such robot may be robot 100. In some examples, a method for stable navigation of robots may include performing process 500. In some examples, a non-transitory computer readable medium may store computer implementable instructions that when executed by at least one processor may cause the at least one processor to perform operations for stable navigation of robots, and the operations may include the steps of process 500.

FIG. 5B is a block diagram illustrating an environment, consistent with some embodiments of the present disclosure. In this example, the leg of the robot (of step 512) may be positioned at location 522, a different leg of the robot may be positioned at location 524, the first location (of step 506 and/or step 510) may be location 526, and the second location (of step 508 and/or step 510 and/or step 512) may be location 528.

In some examples, step 502 may comprise receiving an indication of a desired destination of a robot. For example, step 502 may read the indication from memory (for example, from a digital memory, from memory unit 162, etc.), may receive the indication from an external computing device (for example, using a digital communication device, such as communication module 166), may determine the desired destination (for example, based on a task, based on an analysis of data captured using one or more sensors, etc.), may receive the indication from an individual (for example, via a user interface, using a keyboard, using a pointing device, using a touch surface, using a microphone, using an audio sensor, via gesture, via voice command, via natural language input, etc.), may receive the indication from a navigation module (such as a software navigation module, an hardware navigation module, etc.), and so forth. In one example, the indication may include coordinates of the desired destination (for example, a GPS coordinates, coordinates specific to an environment including the robot and the desired destination, coordinates relative to the robot, etc.), a name indicative of the desired destination, a natural language input indicative of the desired destination (for example,), and so forth. In some examples, step 502 may comprise receiving a verbal input in a natural language (for example, from an individual, from a different robot, via a microphone, via an audio sensor, etc.); and analyzing the verbal input to determine a need to navigate to the desired destination. For example, the verbal input may include ‘bring the coffee mag’, and a need to navigate to a location where the coffee mag was left or last seen may be determined. In one example, step 502 may use an NLP algorithm to analyze the verbal input to determine the need to navigate to the desired destination. In another example, step 502 may use an artificial neural network to analyze the verbal input to determine the need to navigate to the desired destination. In yet another example, step 502 may use a machine learning model to analyze the verbal input to determine the need to navigate to the desired destination. The machine learning model may be a machine learning model trained using training example to determine need to navigate to desired destinations based on natural language inputs. An example of such training example may include sample natural language input, together with a label indicative of a need to navigate to a sample destination corresponding to the sample natural language input. In an additional example, step 502 may transcribe the verbal input to obtain textual input (for example, using speech recognition algorithm), and may analyze the textual input to determine the need to navigate to the desired destination. In some examples, step 502 may comprise receiving a digital indication of a task; and analyzing the digital indication to determine a need to navigate to the desired destination. For example, the task may comprise interacting with a specific item, and the desired destination may be a last known position of the item. In one example, step 502 may use an artificial neural network to analyze the digital indication to determine the need to navigate to the desired destination. In another example, step 502 may use a machine learning model to analyze the digital indication to determine the need to navigate to the desired destination. The machine learning model may be a machine learning model trained using training example to determine need to navigate to desired destinations based on tasks. An example of such training example may include sample task, together with a label indicative of a need to navigate to a sample destination corresponding to the sample task.

In some examples, step 504 may comprise receiving digital data captured from an environment of a robot (such as the robot of step 502, a different robot, etc.) using at least one sensor (such as at least one sensor included in the robot, at least one sensor included in a different robot, at least one sensor not included in any robot, and so forth). For example, the digital data may be read from memory (for example, from a digital memory, from memory unit 162, etc.), may be received from an external computing device (for example, using a digital communication device, such as communication module 166), may be captured using the at least one sensor, and so forth. In one example, the captured digital data received by step 504 may be captured image data depicting the first location and the second location. In another example, the captured digital data received by step 504 may be captured depth data inactive of surface shape and/or surface texture associated with the first location and the second location. In one example, step 504 may use step 410 and/or step 202 and/or step 602 to obtain the digital data. In one example, the captured digital data may be or include at least part of inputs 300.

In some examples, digital data (such as the captured digital data received by step 504, different digital data, etc.) may be analyzed to determine a likelihood of unsteadiness associated with a selected location. For example, step 506 may comprise analyzing the digital data to determine a first likelihood of unsteadiness associated with a first location, and/or step 508 may comprise analyzing the digital data to determine a second likelihood of unsteadiness associated with a second location. For example, the likelihood may be based on the location being uneven. In another example, the likelihood may be based on the location being slippery. In yet another example, the likelihood may be based on the location being loose. In an additional example, the likelihood may be based on the location being rocky. In another example, the likelihood may be based on the location being icy. In yet another example, the likelihood may be based on the location being muddy. In one example, an artificial neural network may be used to analyze the captured digital data to determine the likelihood. In another example, a multimodal foundation model with a specific prompt (such as, ‘does this looks like a steady location to step on?’) may be used to analyze the captured digital data to determine the likelihood. In an additional example, a machine learning model may be used to analyze the captured digital data to determine the likelihood. The machine learning model may be a machine learning model trained using training examples to determine likelihoods of unsteadiness associated with different locations based on digital data associated with the locations. An example of such training example may include sample digital data associated with a sample location, together with a label indicative of a likelihood of unsteadiness associated with the sample location.

In some examples, step 510 may comprise, for example based on an indication of a desired destination and/or likelihoods of unsteadiness associated with different locations, determining to avoid stepping at one location and/or to step at another location. For example, step 510 may comprise, based on the indication of the desired destination received by step 502, the first likelihood determined by step 506, the second likelihood determined by step 508, and/or additional information, determining to avoid stepping at the first location (of step 506) and to step at the second location (of step 508). For example, step 510 may use a rule for selecting a location of a plurality of locations to determine to avoid stepping at the first location and to step at the second location based on the desired destination, the first likelihood, the second likelihood, and/or additional information. In another example, step 510 may use an artificial neural network to determine to avoid stepping at the first location and to step at the second location based on the desired destination, the first likelihood, the second likelihood, and/or additional information. In yet another example, step 510 may use a machine learning model to determine to avoid stepping at the first location and to step at the second location based on the desired destination, the first likelihood, the second likelihood, and/or additional information. The machine learning model may be a machine learning model trained using training examples to select a location of a plurality of locations for stepping based on destinations and/or likelihoods of unsteadiness associated with the locations and/or additional information. An example of such training examples may include a sample destination, sample likelihoods of unsteadiness associated with different sample locations, and/or sample additional information, together with a label indicative of a sample selection of a specific location of the sample locations for stepping.

In one example, the first likelihood determined by step 506 may be higher than the second likelihood determined by step 508, and, based on the desired destination of step 502, navigating via the first location of step 506 may be more efficient than navigating via the second location of step 508. Further, step 510 may determine to avoid stepping at the first location and to step at the second location although it is less efficient due to the first likelihood being higher than the second likelihood. In another example, the first likelihood determined by step 506 may be lower than the second likelihood, and, based on the desired destination of step 502, navigating via the second location of step 508 may be more efficient than navigating via the first location of step 506. Further, step 510 may determine to avoid stepping at the first location and to step at the second location although the first likelihood is lower than the second likelihood

In some examples, step 506 and/or step 508 may be omitted from process 500, and step 510 may comprise, for example based on the indication of the desired destination received by step 502 and/or an analysis of the captured digital data received by step 504, determining to avoid stepping at a first location and/or to step at a second location. For example, step 510 may use an artificial neural network to analyze the captured digital data to determine to avoid stepping at the first location and to step at the second location based on the desired destination and/or additional information. In another example, step 510 may use a machine learning model to analyze the captured digital data to determine to determine to avoid stepping at the first location and to step at the second location based on the desired destination and/or additional information. The machine learning model may be a machine learning model trained using training examples to select a location of a plurality of locations for stepping based on destinations and/or digital data captured from an environment and/or additional information. An example of such training examples may include a sample destination, sample digital data, and/or sample additional information, together with a label indicative of a sample selection of a specific location of the sample locations for stepping.

In some examples, step 510 may further base the determination to avoid stepping at the first location and/or to step at the second location on a position of the robot (or a part of the robot, such as location 522 of a first foot of the robot, location 524 of a second foot of the robot, the leg of step 512, a different leg of the robot, etc.) when the digital data received by step 504is captured. For example, step 510 may further base the determination to avoid stepping at the first location and/or to step at the second location on a location of the leg of step 512 (or part of the leg, such as a foot) of the robot when the digital data is captured. In another example, step 510 may further base the determination to avoid stepping at the first location and/or to step at the second location on a location of another leg of the robot different from the leg of step 512 (or part of the other leg, such as a foot) when the digital data is captured. For example, step 510 may use the location as the additional information in the techniques described above in relation to step 510. In some examples, step 510 may further base the determination to avoid stepping at the first location and/or to step at the second location on a relative position of the first location with respect to at least part of the robot when the digital data is captured and/or on a relative position of the second location with respect to the at least part of the robot when the digital data is captured. For example, the at least part of the robot may be the leg of the robot of step 512, may be a different leg of the robot, may be a foot of the leg of the robot of step 512, may be a foot of a different leg of the robot, and so forth. For example, step 510 may use the relative position(s) as the additional information in the techniques described above in relation to step 510.

In some examples, step 512 may comprise generating digital signals configured to activate at least one actuator of a robot (such as the robot of step 502 and/or step 504, a different robot, and so forth) to cause the robot to move a leg of the robot to step at a selected location (such as the second location of step 508 and/or step 510, a different selected location, and so forth). In one example, step 512 may generate the digital signals as described in relation to step 208 and/or using step 208.

In some examples, process 500 may further comprise: receiving second digital data captured from the environment of the robot, for example after step 512 generates the digital signals, while step 512 generates the digital signals, while moving the leg caused by step 512, before completion of the motion of the leg caused by step 512, and so forth; analyzing the captured second digital data to determine a third likelihood of unsteadiness associated with the second location, the third likelihood is higher than the second likelihood; and in response to the third likelihood, generating second digital signals configured to modify the movement of the leg to step at the first location. For example, the third likelihood may be higher than the second likelihood due to changes to the second location (for example, due to object or substance moving to the second location, due to object or substance moving from the second location, due to changes to the ground at the second location, and so forth). In another example, the third likelihood may be higher than the second likelihood due to changes to the location of the at least one sensor of step 504 enabling better capturing of information associated with the second location, due to movement of a part of the robot that previously occluded at least part of the second location or its surroundings from the at least one sensor of step 504, and so forth. In one example, the second digital data may be received after the leg made physical contact with the second location and may be captured via direct contact with a surface associated with the second location. In one example, the second digital data may be received before the leg made physical contact with the second location, and the second digital signals may be configured to prevent the leg from stepping at the second location.

In some examples, a point in a position of the robot when the digital data received by step 504 is captured, a point in the first location of step 506 and a point in the second location of step 508 may create a straight line. In one example, the second location may be farther away of the robot compared to the first location. In another example, the first location may be farther away of the robot compared to the second location. In one example, the point in the first location may be between the point in the second location and the point in the position of the robot. In another example, the point in the second location may be between the point in the first location and the point in the position of the robot. In some examples, a straight line connection a point in a position of the robot when the digital data received by step 504 is captured with a point in the first location of step 506 may be orthogonal to a straight line connecting the point in the first location with a point in the second location of step 508.

FIG. 6 is a flowchart of an exemplary process 600 for narrating robotic activities, consistent with some embodiments of the present disclosure. In this example, process 600 may comprise: receiving data captured using at least one sensor (step 602); analyzing the captured data to determine a desired action for a robot (step 604); based on the desired action, determining a series of desired movements for a body of the robot for performing the desired action (step 606); based on the desired action, determining information in a natural language indicative of the desired action (step 608); generating digital signals configured to activate at least one actuator of the robot to cause the body to undergo the determined desired movements (step 610); and generating an audible output of the determined information in the natural language (step 612). In other examples, process 600 may include additional steps or fewer steps. In other examples, one or more steps of process 600 may be executed in a different order and/or one or more groups of steps may be executed simultaneously. In some examples, a system for narrating robotic activities may include at least one processing unit configured to perform process 600. In one examples, the system may further comprise the robot of process 600. For example, the robot may include the at least one processing unit. In another example, the at least one processing unit may be external to the robot of process 600. A non-limiting example of such robot may be robot 100. In some examples, a method for narrating robotic activities may include performing process 600. In some examples, a non-transitory computer readable medium may store computer implementable instructions that when executed by at least one processor may cause the at least one processor to perform operations for narrating robotic activities, and the operations may include the steps of process 600.

In some examples, step 602 may comprise receiving data captured using at least one sensor. For example, step 602 may read the captured data from memory (for example, from a digital memory, from memory unit 162, etc.), may receive the captured data from an external computing device (for example, using a digital communication device, such as communication module 166), may capture the data using the at least one sensor, and so forth. In one example, the captured data may be captured digital data. In one example, the captured data may be data captured using at least one sensor from an environment of a robot (such as the robot of step 604, a different robot, and so forth). In one example, the at least one sensor may be at least one sensor included in a robot (such as the robot of step 604, a different robot, and so forth). In another example, the at least one sensor may be at least one sensor not included in any robot. In one example, step 602 may use step 202 and/or step 410 and/or step 504 to obtain the captured data. In one example, the captured data may be captured image data captured using at least one image sensor. In another example, the captured data may be captured audio data captured using at least one audio sensor. In one example, the captured data may be or include at least part of inputs 300.

In some examples, step 604 may comprise analyzing captured data (such as the captured data received by step 602, different captured data, etc.) to determine a desired action for a robot, for example as described above in relation to step 204 and/or using step 204. In one example, step 604 may use an artificial neural network to analyze the captured data to determine the desired action. In another example, step 604 may use a foundation model with a specific prompt (such as, ‘what should be done now given this situation and the past context?’) to analyze the captured data to determine the desired action. In yet another example, step 604 may use a machine learning model to analyze the captured data to determine the desired action. The machine learning model may be a machine learning model trained using training examples to determine desired actions based on data. An example of such training example may include sample data, together with a label indicative of a sample desired action aligned with the sample data. In one example, the captured data may be or include audio data including speech in a natural language (such as the natural language of step 608 and/or step 612, a different natural language, etc.), and step 604 may determine the desired action based on the speech included in the audio data. For example, the audio data may include an instruction (such as, ‘bring the folder’), and the desired action may be based on the instruction (for example, moving to the last known position of the folder). In another example, the audio data may include a complaint (such as, ‘this is dirty’), and the desired action may be based on the complaint (for example, cleaning or washing a particular item). In one example, the captured data may be or include image data, and step 604 may determine the desired action based on a depiction included in the image data. For example, the image data may depict an object not in its place, and the desired action may include moving the object to its place.

In some examples, step 606 may comprise, based on a desired action (such as the desired action determined by step 604, a different desired action, etc.), determining a series of desired movements for a body of a robot (such as the robot of step 604, a different robot, etc.) for performing the desired action. For example, step 606 may use step 206 to determine the series of desired movements for the body of the robot based on the desired action.

In some examples, step 608 may comprise, based on a desired action (such as the desired action determined by step 604, a different desired action, etc.), determining information in a natural language indicative of the desired action. For example, step 608 may use an artificial neural network to determine the information in the natural language indicative of the desired action based on the desired action. In another example, step 608 may use a foundation model and/or a generative model, for example with a specific prompt (such as ‘what should I say before performing {the desired action}?’), to determine the information in the natural language indicative of the desired action based on the desired action. In yet another example, step 608 may use a machine learning model to determine the information in the natural language indicative of the desired action based on the desired action. The machine learning model may be a machine learning model trained using training examples to determine information in a natural language indicative of different actions based on the actions. An example of such training example may include an indication of a sample action, together with a natural language content indicating the sample action. In one example, the information in the natural language indicative of the desired action (determined by step 608) may describe the desired action, may explain a reason for performing the desired action, may provide a safety warning associated with the desired action, and so forth.

In some examples, step 610 may comprise generating digital signals configured to activate at least one actuator of a robot (such as the robot of step 604 and/or step 606, a different robot, etc.) to cause a body of the robot (such as the body of step 606, a different body, etc.) to undergo desired movements (such as the desired movements determined by step 606, different desired movements, and so forth). For example, step 610 generate the digital signals as described above in relation to step 208 and/or using step 208.

In some examples, step 612 may comprise generating an audible output of information in a natural language (such as the information in the natural language determined by step 608, different information in the natural language of step 608, information in a different natural language, and so forth). For example, step 612 may use a text-to-speech algorithm to generate the audible output from the information in the natural language. In one example, the audible output may include a first person pronoun, such as ‘I’, ‘me’, ‘my’, ‘myself’, ‘we’, ‘us’, ‘our’, ‘ours’, ourselves, and so forth. For example, the generated audible output may include ‘we are going to cross the street together’, or ‘I moved the glasses using my left arm’.

In some examples, the body of the robot (of step 606 and/or step 610) may undergo the desired movements determined by step 606 (for example, in response to the digital signals generated by step 610) after the audible output generated by step 612 is completed. In one example, the audible output may include a sentence in a future tense informing about a prospective performance of the desired action (such as, ‘I'm about to {description of the action}’). In another example, the audible output may include a safety warning associated with the desired action (such as ‘stay away of the gate, as I'm about to close it’). In one example, the desired action (of step 604 and/or step 606 and/or step 608) may include coordinated action with at least one individual, and the audible output generated by step 612 may be configured to cause the at least one individual to participate in the coordinated action (for example, ‘please remove the map while I hold the centerpiece up’). In one example, the desired action (of step 604 and/or step 606 and/or step 608) may include usage of a physical object, and the audible output generated by step 612 may include a request for a permission to use the physical object (such as, ‘may I put the trash in your trash can?’). In one example, the desired action (of step 604 and/or step 606 and/or step 608) may include a physical contact between the body of the robot (of step 604 and/or step 606 and/or step 610) and a body of an individual, and the audible output generated by step 612 may include a request for a permission to touch the individual (such as, ‘there is something on your chin, may I remove it?’). In one example, the desired action (of step 604 and/or step 606 and/or step 608) may include entrance to a specific location, and the audible output generated by step 612 may include a request for a permission to enter the specific location.

In some examples, the body of the robot (of step 606 and/or step 610) may undergo the desired movements determined by step 606 (for example, in response to the digital signals generated by step 610) before the audible output is generated by step 612. In one example, the audible output generated by step 612 may include a sentence in a past tense describing the completed desired action (of step 604 and/or step 606 and/or step 608), such as ‘I threw the empty package away’. In another example, the audible output generated by step 612 may include a sentence in a past tense explaining a reason for performing at least part the completed desired action (of step 604 and/or step 606 and/or step 608), such as ‘I moved the chair to enable the cleaning robot to clean under the table’.

In some examples, the body of the robot (of step 606 and/or step 610) may undergo the desired movements determined by step 606 (for example, in response to the digital signals generated by step 610) simultaneously with the audible output (generated by step 612). In one example, the audible output generated by step 612 may include a sentence in a present tense describing the desired action, such as ‘I'm opening the shirt buttons’. In one example, the desired action (of step 604 and/or step 606 and/or step 608) may include a first sub-action and a second sub-action, the audible output generated by step 612 may include a first portion associated with the first sub-action and a second portion associated with the second sub-action, the first portion of the audible output may be outputted (by step 612) simultaneously with a performance of the first sub-action (for example, in response to at least a first part of the digital signals generated by step 610), and the second portion of the audible output may be outputted (by step 612) simultaneously with a performance of the second sub-action (for example, in response to at least a second part of the digital signals generated by step 610). For example, the desired action may include a first sub-action of folding a shirt and a second sub-action of putting the folded shirt in a pile of shirts, and the audible output may include a first portion of ‘I fold the shirt’ and a second portion of ‘and put it on the top of the pile’.

In one example, the desired action (of step 604 and/or step 606 and/or step 608) may include a physical contact between the body of the robot (of step 606 and/or step 610) and a body of an individual, and the audible output generated by step 612 may be directed at the individual. For example, the desired action may include lifting the individual, and the audible output may include ‘I'm going to pull you’. In one example, the desired action (of step 604 and/or step 606 and/or step 608) may include an action that changes a state of an individual, and the audible output generated by step 612 may be directed at the individual. For example, the desired action may include applying ointment to a person's skin, and the audible output may include ‘this will reduce the itching’. In one example, the desired action (of step 604 and/or step 606 and/or step 608) may include an action performed in a vicinity of an individual, and the audible output generated by step 612 may be directed at the individual. For example, the desired action may include washing the floor near a person sitting on a chair, and the audible output may include ‘the floor is wet, be careful not to step here in the next few minutes’. In some examples, the audible output generated by step 612 may be directed at an individual in an environment of the robot (of step 606 and/or step 610), and at least one of a level of details or terminology of the information in the natural language determined by step 608 may be based on the individual. For example, process 600 may use a face recognition algorithm to analyze image data captured using at least one image sensor included in the robot to identify the individual. In another example, process 600 may use a speaker recognition algorithm to analyze audio data captured using at least one audio sensor included in the robot to identify the individual. In one example, step 608 may access, based on the individual, a data structure associating individuals with desired level of details and/or desired terminologies, to obtain a desired level of detail and/or desired terminology. Further, step 608 may generate the information in the natural language based on the obtained desired level of detail and/or desired terminology. In another example, step 608 may determine the desired level of detail and/or desired terminology based on a characteristic of the individual, such as an age, mental abilities, training, and so forth. For example, step 608 may provide less details and/or using simpler terminology when interacting with a child or a mentally impaired individual, may provide more details and/or using professional terminology when interacting with an expert, and so forth. Further, step 608 may generate the information in the natural language based on the determined desired level of detail and/or desired terminology.

In some examples, step 602 may capture audio input including speech in the natural language produced by an individual and referring to the desired action (of step 604 and/or step 606 and/or step 608). In one example, step 604 may determine the desired action based on the speech in the natural language. Further, the audible output generated by step 612 may be a response to the captured speech produced by the individual. For example, the speech in the natural language may include ‘prepare the table’, the desired action may include removing used cutlery from the table to the sink, and the audible output may include ‘your table will be ready soon, I'm just removing the used tableware and putting new ones instead’. In another example, the desired action may include moving to the living room as part of a larger task of replacing batteries in a TV remote control (the remote control last seen position may be in the living room), the speech in the natural language may include ‘why are you going to the living room?’, and the audible output may include ‘I'm going to replace the batteries in the TV remote control’.

In some examples, the desired action (of step 604 and/or step 606 and/or step 608) may include interaction with a physical object, and the audible output generated by step 612 may include an indication of the physical object. For example, the desired action may include throwing a used container to a garbage can, and the audible output may include ‘I'm throwing this’. In some examples, the desired action (of step 604 and/or step 606 and/or step 608) may include movement to a specific location, and the audible output generated by step 612 may include an indication of the specific location. For example, the desired action may include moving to the living room, and the audible output may include ‘I'm headed to the living room’. In some examples, the desired action (of step 604 and/or step 606 and/or step 608) may include a first sub-action and a second sub-action, the first sub-action may precede the second sub-action, and the audible output generated by step 612 may include an explanation of how the first sub-action prepares a physical item for the second sub-action. For example, the first sub-action may include taking a first item out of a container, the second sub-action may include putting a second item in the container, and the audible output may explain that the first item is taken out of the container to make room for the second item in the container, such as ‘I removed the ball out of the bag to make room for the water bottle. In some examples, the audible output generated by step 612 may include an indication of a specific action not performed by the robot. For example, the audible output generated by step 612 may include an explanation why the specific action is avoided. In another example, the audible output generated by step 612 may include a warning not to perform the specific action.

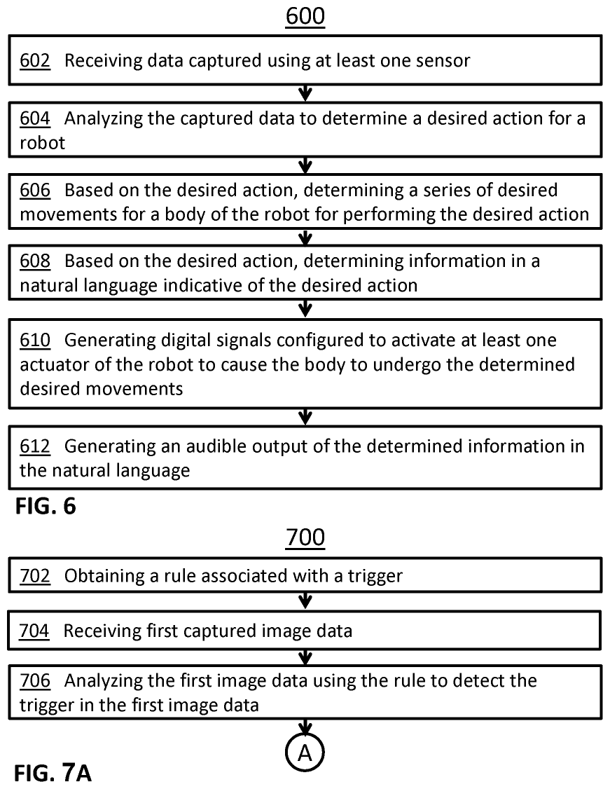

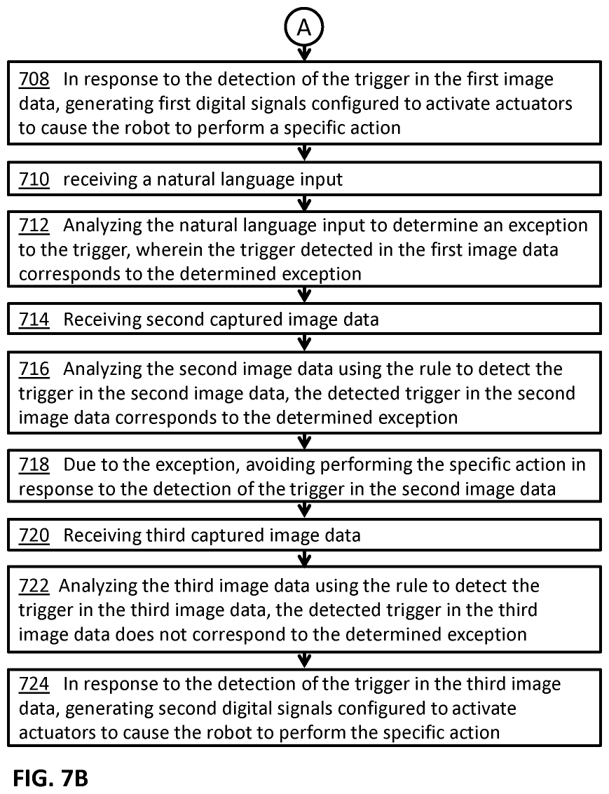

FIGS. 7A and 7B are a flowchart of an exemplary process 700 for robotic trigger configuration, consistent with some embodiments of the present disclosure. In this examples, process 700 may comprise: obtaining at least one rule associated with at least one trigger (step 702); receiving first image data captured using at least one image sensor included in a robot (step 704); analyzing the first image data using the at least one rule to detect the at least one trigger in the first image data (step 706); in response to the detection of the at least one trigger in the first image data, generating first digital signals configured to activate a first group of actuators to cause the robot to perform a specific action (step 708); after the generation of the first digital signals, receiving a natural language input (step 710); analyzing the natural language input to determine an exception to the at least one trigger, wherein the at least one trigger detected in the first image data corresponds to the determined exception (step 712); after determining the exception, receiving second image data captured using the at least one image sensor (step 714); analyzing the second image data using the at least one rule to detect the at least one trigger in the second image data, the detected at least one trigger in the second image data corresponds to the determined exception (step 716); due to the determined exception, avoiding performing the specific action in response to the detection of the at least one trigger in the second image data (step 718); after determining the exception, receiving third image data captured using the at least one image sensor (step 720); analyzing the third image data using the at least one rule to detect the at least one trigger in the third image data, the detected at least one trigger in the third image data does not correspond to the determined exception (step 722); and in response to the detection of the at least one trigger in the third image data, generating second digital signals configured to activate a second group of actuators to cause the robot to perform the specific action (step 724). In other examples, process 700 may include additional steps or fewer steps. In other examples, one or more steps of process 700 may be executed in a different order and/or one or more groups of steps may be executed simultaneously. In some examples, a system for robotic trigger configuration may include at least one processing unit configured to perform process 700. In one examples, the system may further comprise the robot of process 700. For example, the robot may include the at least one processing unit. In another example, the at least one processing unit may be external to the robot of process 700. A non-limiting example of such robot may be robot 100. In some examples, a method for robotic trigger configuration may include performing process 700. In some examples, a non-transitory computer readable medium may store computer implementable instructions that when executed by at least one processor may cause the at least one processor to perform operations for robotic trigger configuration, and the operations may include the steps of process 700.

In some examples, step 702 may comprise obtaining at least one rule associated with at least one trigger. For example, step 702 may read the at least one rule from memory (for example, from a digital memory, from memory unit 162, etc.), may receive the at least one rule from an external computing device (for example, using a digital communication device, such as communication module 166), may receive the at least one rule from an individual (for example, via a user interface, in a natural language, in a formal language, via text, via speech, via gestures, etc.), may determine the at least one rule (for example, from examples, using a machine learning model, etc.), and so forth. In one example, the at least one rule may be defined in a natural language, may be defined in a formal language (such as a programming language, a configuration file, etc.), may be defined by a series of weights (for example, of a classification model), may be defined by a machine learning model trained using training examples to detect the at least one trigger, may be defined by an artificial neural network configured to detect the at least one trigger, and so forth. In one example, step 702 may comprise: receiving particular image data, such as particular image data captured using the at least one image sensor before the capturing of the first image data received by step 704; and analyzing (for example, using a computer vision algorithm, a visual object detection algorithm, a face recognition algorithm, a visual event detection algorithm, a visual classification algorithm, a foundation model, etc.) the particular image data to determine the at least one rule associated with the at least one trigger. For example, the particular image data may depict a particular object, particular individual or a particular event; and the at least one rule may be based on a category of objects associated with the particular object and/or a category of individuals associated with the particular individual and/or a category of events associated with the particular event. In one example, step 702 may comprise: before the capturing of the first image data, receiving a second natural language input; and analyzing (for example, using a speech recognition algorithm, using an NLP algorithm, using a foundation model, etc.) the second natural language input to determine the at least one rule associated with the at least one trigger. For example, the second natural language input may include “always knock before opening the door”, the at least one rule may include “a task necessitating or including opening a door”. In one example, step 702 may comprise: receiving particular image data, such as particular image data captured using the at least one image sensor before the capturing of the first image data; before the capturing of the first image data, receiving a second natural language input; and analyzing the particular image data and the second natural language input (for example, using a multimodal foundation model) to determine the at least one rule associated with the at least one trigger. For example, the second natural language input may include “always knock before opening this door”, the particular image data may include a gesture indicating a specific door, and the at least one rule may include “a task necessitating or including opening the specific door”.

In some examples, image data captured using at least one image sensor (such as at least one image sensor included in a robot, at least one image sensor not included in a robot, etc.) may be received. For example, step 704 may comprise receiving first image data captured using at least one image sensor, such as at least one image sensor included in a robot. In another example, step 714 may comprise, after determining the exception by step 712, receiving second image data captured using at least one image sensor (such as the at least one image sensor of step 704, different at least one image sensor included in the robot of step 704, at least one image sensor included in a different robot, at least one image sensor not included in any robot, and so forth). In yet another example, step 720 may comprise after determining the exception by step 712, receiving third image data captured using at least one image sensor (such as the at least one image sensor of step 704 and/or step 714, different at least one image sensor included in the robot of step 704 and/or step 708 and/or step 724, at least one image sensor included in a different robot, at least one image sensor not included in any robot, and so forth). For example, the image data may be read from memory (for example, from a digital memory, from memory unit 162, etc.), may be received from an external computing device (for example, using a digital communication device, such as communication module 166), may be captured using the at least one sensor, and so forth.

In some examples, image data may be analyzed using at least one rule (such as the at least one rule obtained by step 702, different at least one rule, etc.) to detect at least one trigger (such as the at least one trigger of step 702, a different at least one trigger, etc.) in the image data. For example, step 706 may comprise analyzing the first image data received by step 704 using the at least one rule to detect the at least one trigger in the first image data. In another example, step 716 may comprise analyzing the second image data received by step 714 using the at least one rule to detect the at least one trigger in the second image data. The at least one trigger in the second image data detected by step 714 may correspond to the exception determined by step 712. In yet another example, step 722 may comprise analyzing the third image data received by step 720 using the at least one rule to detect the at least one trigger in the third image data. The at least one trigger in the third image data detected by step 722 may not correspond to the determined exception. In some examples, an artificial neural network may be used to analyze the image data to detect the at least one trigger in the image data. In one example, the at least one rule may be defined by the artificial neural network. In another example, the at least one rule may be an input to the artificial neural network. In one example, steps 706, 716 and 722 may use the same artificial neural network. In another example, steps 706, 716 and 722 may use different artificial neural networks. In some examples, a machine learning model may be used to analyze the image data to detect the at least one trigger in the image data. In one example, the at least one rule may be defined by the machine learning model. In another example, the at least one rule may be an input to the machine learning model. In one example, steps 706, 716 and 722 may use the same machine learning model. In another example, steps 706, 716 and 722 may use different machine learning models. The machine learning model may be a machine learning model trained using training examples to detect triggers in visual data. One example of such training example may include sample image data, together with a label indicative of whether the sample image data includes a sample trigger. Another example of such training example may include sample image data and sample rule associated with a sample trigger, together with a label indicative of whether the sample image data includes the sample trigger. In some examples, a foundation model with a prompt may be used to analyze the image data to detect the at least one trigger in the image data. In one example, the at least one rule may be defined, at least partly, by the prompt. In one example, steps 706, 716 and 722 may use the same foundation model. In another example, steps 706, 716 and 722 may use different foundation models. In one example, steps 706, 716 and 722 may use the same prompt. In another example, steps 706, 716 and 722 may use different prompts. For example, steps 706, 716 and 722 may use the same prompt, and the prompt may include a definition of the at least one rule in a natural language (such as the natural language of step 710, a different natural language, and so forth). In another example, steps 706 may use a first prompt, steps 716 and 722 may use a second prompt different from the first prompt, the first prompt may include a definition of the at least one rule in a natural language (such as the natural language of step 710, a different natural language, and so forth), and/or the second prompt may include a definition of the at least one rule and/or a definition of the determined exception in the natural language. In some examples, the at least one rule may be defined by a code in a programming language configured to detect triggers in visual data, and the code may be executed to analyze the image data to detect at least one trigger in the image data.

In some examples, digital signals configured may be generated to activate a group of actuators of a robot (such as the robot of step 704, a different robot, etc.) to cause the robot to perform a specific action, for example in response to a detection of a trigger (such as the at least one trigger of step 702, a different at least one trigger, etc.), for example in captured image data, in other captured data, in received image data, in other received data, and so forth. For example, the digital signals may be generated as described above in relation to step 208 and/or using step 208. In one example, step 708 may comprise, in response to the detection by step 706 of the at least one trigger (of step 702) in the first image data received by step 704, generating first digital signals configured to activate a first group of actuators to cause the robot to perform a specific action. In another example, step 724 may comprise, in response to the detection by step 722 of the at least one trigger (of step 702) in the third image data, generating second digital signals configured to activate a second group of actuators to cause a robot (such as the robot of step 704 and/or step 708, a different robot, and so forth) to perform a specific action (such as the specific action of step 708 and/or step 718, a different specific action, and so forth). For example, the first group of actuators and the second group of actuators may be the same group of actuators, may be different groups of actuators, may include at least some but not all actuators in common, may include no actuator in common, and so forth. In some examples, step 718 may comprise, for example due to the exception determined by step 712 and/or due to the trigger detected by step 716 in the second image data corresponding to the exception determined by step 712, avoiding performing a specific action (such as the specific action of step 708 and/or step 724, a different specific action, etc.) in response to the detection of the at least one trigger detected by step 716 in the second image data received by step 714. For example, step 718 may avoid performing the specific action by avoiding generating digital signals configured to activate one or more actuators or the robot to cause the robot to perform the specific action. In one example, the specific action (of step 708 and/or step 718 and/or step 724) may include moving the robot to a selected position. In another example, the specific action (of step 708 and/or step 718 and/or step 724) may include a physical interaction of the robot with a selected physical object (for example, touching the selected physical object, manipulating the selected physical object, moving the selected physical object, and so forth). In some examples, the natural language input received by step 710 may be indicative of an alternative action different from the specific action of step 708 and/or step 724. Further, step 718 may, for example in response to the detection of the at least one trigger in the second image data by step 716, generate third digital signals configured to activate a third group of actuators of the robot to cause the robot to perform the alternative action. For example, the group of actuators may be the first group of group of actuators, may be the second group of actuators, may be a different group of actuators, and so forth. For example, the at least one trigger may include dairy product left unattended outside the refrigerator, the specific action may include putting the dairy product in the refrigerator, the natural language input may include ‘when the product is expired or empty, throw it to the garbage’, the exception may be empty or expired dairy product, and the alternative action may include throwing the dairy product to the garbage.

In some examples, step 710 may comprise, for example after the generation of the first digital signals by step 708, receiving a natural language input. For example, the natural language input may be or include a textual input in a natural language, an audio data including speech in a natural language, and so forth. In one example, step 710 may receive the natural language from a natural person. In another example, may receive the natural language from a robot different from the robot of step 704 and/or step 708. For example, step 710 may read the natural language input from memory (for example, from a digital memory, from memory unit 162, etc.), may receive the natural language input from an external computing device (for example, using a digital communication device, such as communication module 166), may capture audio data including the natural language input using the at least one audio sensor, may receive textual content including the natural language input from an individual (for example, via a keyboard, via speech recognition, etc.), and so forth.

In some examples, step 712 may comprise analyzing a natural language input (such as the natural language input received by step 710, a different natural language input, etc.) to determine an exception to at least one trigger (such as the at least one trigger of step 702, a different at least one trigger, and so forth). In one example, the at least one trigger detected by step 706 in the first image data received by step 704 may correspond to the determined exception. In another example, the at least one trigger detected by step 706 in the first image data received by step 704 may not correspond to the determined exception. In one example, step 712 may use an artificial neural network to analyze the natural language input and/or additional information to determine the exception to the at least one trigger. In another example, step 712 may use a foundation model (for example, with a suitable prompt, such as ‘define the exception to this {the at least one rule} described in this input: {the natural language input}’) to analyze the natural language input and/or additional information to determine the exception to the at least one trigger. In yet another example, step 712 may use a machine learning model to analyze the natural language input and/or additional information to determine the exception to the at least one trigger. The machine learning model may be a machine learning model trained using training examples to determine exceptions to rules from natural language inputs and/or additional information. An example of such training example may include sample rule, sample natural language input and/or sample additional information, together with a label indicative of an exception to the sample rule indicated by the sample natural language input and/or sample additional information.

In some examples, step 710 may further comprise receiving particular image data, such as particular image data captured using at least one image sensor (such as the at least one image sensor of step 704 and/or step 714 and/or step 720, different at least one image sensor included in the robot of step 704 and/or step 708 and/or step 724, at least one image sensor included in a different robot, at least one image sensor not included in any robot, etc.), for example as described above in relation to step 704 and/or step 714 and/or step 720. Further, step 712 may comprise analyzing the particular image data received by step 710 and the natural language input received by step 710 to determine the exception to the at least one trigger. For example, step 712 may use the particular image data as the additional information when using the artificial neural network and/or the machine learning model and/or the foundation model as described above. In one example, the particular image data may depict a plurality of physical objects and a gesture indicative of a particular physical object of the plurality of physical objects, the particular physical object may have a plurality of characteristics, the natural language input may be indicative of a particular characteristic of the plurality of characteristics, and the determined exception may be based on the particular characteristic of the particular physical object. In another example, the particular image data may depict a particular physical object, the particular physical object may have a plurality of characteristics, the natural language input may be indicative of a particular characteristic of the plurality of characteristics, and the determined exception may be based on the particular characteristic of the particular physical object. In yet another example, the particular image data may depict a particular event, the particular event may have a plurality of characteristics, the natural language input may be indicative of a particular characteristic of the plurality of characteristics, and the determined exception may be based on the particular characteristic of the particular event.

In some examples, the natural language input received by step 710 may be indicative of a timeframe, and the exception determined by step 712 may be based on the timeframe. For example, the specific action may be associated with loud noise, the natural language input may include ‘don’t make loud noises during night time, and the determined exception may include avoiding performing the specific action between 10 PM and 7 AM. In one example, the timeframe may be based on time elapsed from at least one of a last detection of the at least one trigger or a last performance of the specific action. For example, the specific action may include turning lights off or dimming the lights, the natural language input may include ‘don't change the lights so often’, and the determined exception may include avoiding performing the specific action in the two minutes after the pervious performance of the specific action. In another example, the at least one trigger may include meeting a person, the specific action may include greeting the person, and the natural language input may include ‘don't greet the same person again and again’, and the determined exception may include avoiding responding to triggers in the two hours after a previous trigger was identified (even if the specific action was not performed in response to the previous trigger). In some examples, the natural language input received by step 710 may be indicative of a region, and the exception determined by step 712 may be based on the region. For example, the specific action may include cleaning, the natural language input may include ‘never clean in here’, and the determined exception may include avoiding cleaning specific region, thereby ignoring triggers in the specific region. In another example, the at least one trigger may include a present of a person, the specific action may include opening the lights when a person is observed, the natural language input may include ‘never turn on the lights in the dark room’, the region may be ‘the dark room’, and the determined exception may include ignoring people observed in the dark room. In some examples, the natural language input received by step 710 may be indicative of a timeframe and a region, and the exception determined by step 712 may be based on the timeframe and the region. For example, the at least one trigger may include a present of a person, the specific action may include opening the lights when a person is observed, the natural language input may include ‘never turn on the lights in the baby's room during nap time’, the region may be ‘the baby's room’, the timeframe may be nap time, and the determined exception may include ignoring people observed in the baby's room during nap time.

In some examples, the natural language input received by step 710 may be indicative of at least one individual, and the exception determined by step 712 may be based on the at least one individual. For example, the specific action may include assisting people in a selected action, the natural language input may be received from a specific person and may include ‘I like to manage on my own’, the at least one individual may be the specific person, and the determined exception may include avoiding assisting the specific person in the selected action. In some examples, the natural language input received by step 710 may be indicative of at least one category of objects, and the exception determined by step 712 may be based on the at least one category of objects. For example, the at least one trigger may include dairy product left unattended outside the refrigerator, the specific action may include putting the dairy product in the refrigerator, the natural language input may include ‘don't put the expired or empty products in the refrigerator’, the at least one category of objects may include expired products and empty products, and the determined exception may be empty or expired products. In some examples, the natural language input received by step 710 may be indicative of a potential outcome, and the exception determined by step 712 may be based on the potential outcome. For example, the specific action may include pouring liquids into a sink, the natural language input may include ‘don't pour liquids into the sink if the sink may get clogged’, and the determined exception may include avoiding triggers to pour liquids into the sink when the liquid may clogged the sink (for example, when the liquid is thick or when there are debris or waste in the sink).

In some examples, the specific action of step 708 and/or step 718 and/or step 724 may be a prerequisite action required to be performed by the robot before performing a subsequent action, and the exception determined by step 712 may include at least one case that does not require the prerequisite action. For example, the subsequent action may include entering a room, the prerequisite action may include knocking on a door of the room, the at least one trigger may be the door being closed, and the determined exception may include at least one case where entering the room does not require the knocking on the door (such as, when the room is a shared space room, when the room is a room of a young child, an emergency, and so forth). For example, the natural language input received by step 710 may include ‘you don't need to knock when you enter this specific room’, or ‘don't knock and just enter the room if you suspect a person fell down in the room’.

In some examples, the specific action of step 708 and/or step 718 and/or step 724 may be or include manipulating an object, and the determined exception may be based on a condition of the object. For example, the specific action may include cleaning a tableware item, the natural language input may include ‘you don't have to clean broken tableware items, just throw them to the garbage’, and the determined exception may include avoiding cleaning a broken tableware item.

In some examples, process 700 may further comprise, for example after the generating second digital signals by step 724 and/or after the avoiding performing the specific action in response to the detection of the at least one trigger in the second image data (by step 718): receiving a second natural language input, for example as described above in relation to step 710; and analyzing the second natural language input to determine to forget the at least one trigger of step 702, for example using an NLP algorithm, using an artificial neural network, using a foundation model, and so forth. For example, the at least one trigger may be associated with handling a specific crisis, and the second natural language input may indicate that the specific crisis is over. In another example, the at least one trigger may be associated with handling a specific guest, and the second natural language input may indicate that the specific guest left and is not expected to return. For example, the specific guest may suffer from anxiety disorder, and the at least one trigger may be associated with a specific triggers of the specific guest (for example, to avoid such specific triggers, to react to such specific triggers, and so forth).

In some examples, process 700 may further comprise, for example after the generating second digital signals by step 724 and/or after the avoiding performing the specific action in response to the detection of the at least one trigger in the second image data (by step 718): receiving a second natural language input, for example as described above in relation to step 710; and analyzing the second natural language input to determine to forget the exception determined by step 712, for example using an NLP algorithm, using an artificial neural network, using a foundation model, and so forth. For example, the exception may be associated with handling a specific crisis or situation, and the second natural language input may indicate that the specific crisis or situation is over. In another example, the exception may be associated with handling a specific guest, and the second natural language input may indicate that the specific guest left and is not expected to return.

In some examples, the natural language input received by step 710 may include a noun and an adjective adjacent to the noun. The noun may be indicative with a category of objects associated with the at least one trigger of step 702, the adjective may be indicative with a characteristic of an object, and the exception to the at least one trigger determined by step 712 may be based on the characteristic. For example, the natural language input may include ‘when a plate's color turns yellow, don't put it in the pantry, and just throw it to the garbage’, the category of objects is plates, the characteristic is a color, and the exception is based on the color of the plate turning yellow. In some examples, the natural language input received by step 710 may include a verb and an adverb adjacent to the verb. The verb may be indicative with a category of events associated with the at least one trigger of step 702, the adverb may be indicative with a characteristic of an event, and the exception to the at least one trigger is based on the characteristic. For example, the at least one trigger may include refusing to eat, the natural language input may include ‘it's okay if she briefly postpones a meal’, the category of events is postponing meals, the characteristic is a temporal extent of the postponing, and the exception is based on the postponing being brief.

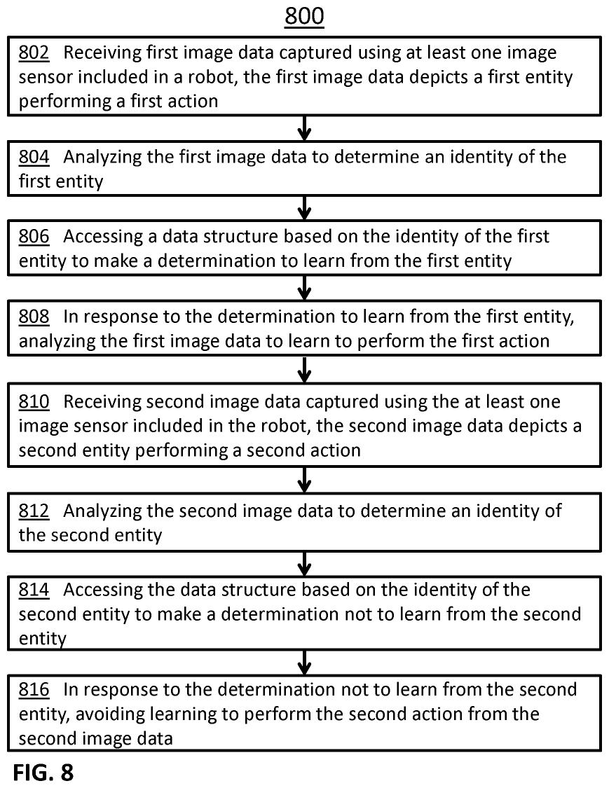

FIG. 8 is a flowchart of an exemplary process 800 for selective learning in visual robotic configuration, consistent with some embodiments of the present disclosure. In this example, process 800 may comprise: receiving first image data captured using at least one image sensor included in a robot (step 802), the first image data depicts a first entity performing a first action; analyzing the first image data to determine an identity of the first entity (step 804); accessing a data structure based on the identity of the first entity to make a determination to learn from the first entity (step 806); in response to the determination to learn from the first entity, analyzing the first image data to learn to perform the first action (step 808); receiving second image data captured using the at least one image sensor included in the robot (step 810), the second image data depicts a second entity performing a second action; analyzing the second image data to determine an identity of the second entity (step 812); accessing the data structure based on the identity of the second entity to make a determination not to learn from the second entity (step 814); and in response to the determination not to learn from the second entity, avoiding learning to perform the second action from the second image data (step 816). In other examples, process 800 may include additional steps or fewer steps. In other examples, one or more steps of process 800 may be executed in a different order and/or one or more groups of steps may be executed simultaneously. In some examples, a system for selective learning in visual robotic configuration may include at least one processing unit configured to perform process 800. In one examples, the system may further comprise the robot of process 800. For example, the robot may include the at least one processing unit. In another example, the at least one processing unit may be external to the robot of process 800. A non-limiting example of such robot may be robot 100. In some examples, a method for selective learning in visual robotic configuration may include performing process 800. In some examples, a non-transitory computer readable medium may store computer implementable instructions that when executed by at least one processor may cause the at least one processor to perform operations for selective learning in visual robotic configuration, and the operations may include the steps of process 800.

In some examples, image data may be received. For example, image data captured using at least one image sensor (such as at least one image sensor included in the robot, at least one image sensor not included in any robot, etc.) may be received. In one example, the image data may depict an entity performing an action. In another example, the image data may depict an individual. For example, step 802 may comprise receiving first image data. The first image data received by step 802 may be image data captured using at least one image sensor, such as at least one image sensor included in a robot. The first image data may depict a first entity performing a first action. In another example, step 810 may comprise receiving second image data. The second image data received by step 810 may be image data captured using at least one image sensor (such as the at least one image sensor of step 802, a different at least one image sensor included in the robot of step 802, at least one image sensor included in a different robot, at least one image sensor not included in any robot, etc.), the second image data may depict a second entity performing a second action. In yet another example, step 902 may comprise receiving image data. The image data received by step 902 may be image data captured using at least one image sensor (such as at least one image sensor included in a robot, at least one image sensor not included in any robot, etc.), the image data depicts an individual. In one example, the first entity and the second entity may be the same entity, may be different entities, and so forth. In one example, the first entity may be a natural person and the second entity may be a different robot. In another example, the first entity may be a different robot and the second entity may be a natural person. In yet another example, the first entity may be a first natural person and the second entity may be a second natural person. In an additional example, the first entity may be a first robot and the second entity may be a second robot. In one example, the first action and the second action may be the same action. In another example, the first action and the second action may be different actions. In one example, the image data may be read from memory (for example, from a digital memory, from memory unit 162, etc.), may be received from an external computing device (for example, using a digital communication device, such as communication module 166), may be captured using the at least one sensor, and so forth.

In some examples, image data may be analyzed to determine an identity of an entity depicted in the image data. For example, step 804 may comprise analyzing the first image data received by step 802 to determine an identity of the first entity of step 802. In another example, step 812 may comprise analyzing the second image data received by step 810 to determine an identity of the second entity of step 810. In one example, the image data may be analyzed using a face recognition algorithm to identify the entity. In another example, the image data may be analyzed using an artificial neural network to identify the entity. In yet another example, the image data may be analyzed using a machine learning model to identify the entity. The machine learning model may be a machine learning model trained using training examples to identify entities depicted in visual data. An example of such training example may include a sample image data depicting a sample entity, together with a label indicative of the identity of the sample entity. In an additional example, a visual identifier indicative of the identity of the entity may be visible on the entity (such as a name tag, a barcode, a QR code, etc.), and the image data may be analyzed to detect and decode the visual identifier to thereby determine the identity of the entity. In one example, the entity may be a natural person, and the determined identity may include at least one of a name, unique identifier (such as a social security number, an internal unique identifier, etc.), and so forth. In another example, the entity may be a robot, and the identity may be or include an indication of a model of the robot. In yet another example, the entity may be a robot, and the identity may be or include an indication of a specific instance of a model of robots.

In some examples, a data structure may be accessed based on an identity of an entity to make a determination of whether to learn from the entity. For example, step 806 may comprise accessing a data structure based on the identity of the first entity determined by step 804 to make a determination to learn from the first entity. In yet another example, step 814 may comprise accessing a data structure (such as the data structure of step 806, a different data structure, etc.) based on the identity of the second entity determined by step 812 to make a determination not to learn from the second entity. In some examples, the second entity may be in the data structure, step 806 may base the determination to learn from the first entity on the first entity not being in the data structure, and/or step 814 may base the determination to not learn from the second entity on the second entity being in the data structure. For example, the data structure may be or include a block-list of entities. Other non-limiting examples are described below. In some examples, the first entity may be in the data structure, step 814 may base the determination to not learn from the second entity on the second entity not being in the data structure, and/or step 806 may base the determination to learn from the first entity on the first entity being in the data structure. For example, the data structure may be or include an allow-list of entities. Other non-limiting examples are described below.

In some examples, the data structure of step 806 and/or step 814 may associate entities with permissions to teach the robot. For example, a permission associated with an entity in the data structure may a general permission to teach the robot, a permission to teach the robot specific category of actions, a permission to teach the robot all actions except a specific category of actions, a permission to teach the robot in specific contextual conditions, a permission to teach the robot in all contextual conditions except specific contextual conditions, and so forth. In one example, step 806 may base the determination to learn from the first entity on a permission associated in the data structure with the first entity. In another example, step 814 may the determination to not learn from the second entity on a permission associated in the data structure with the second entity. In yet another example, step 806 may base the determination to learn from the first entity on a lack of association for the first entity in the data structure (for example, when the default permission is to permit to teach the robot, when the default permission is to permit to teach the robot specific actions that includes the first action, when the default permission is to permit to teach the robot all actions except specific actions that do not include the first action, when the default permission is to permit to teach the robot in specific contextual conditions that match the current conditions, when the default permission is to permit to teach the robot in all contextual conditions except specific contextual conditions that do not match the current conditions, and so forth). In an additional example, step 814 may base the determination to not learn from the second entity on a lack of association for the second entity in the data structure (for example, when the default permission is not to permit to teach the robot, when the default permission is not to permit to teach the robot specific actions that includes the second action, when the default permission is not to permit to teach the robot all actions except specific actions that do not include the second action, when the default permission is not to permit to teach the robot in specific contextual conditions that match the current conditions, when the default permission is not to permit to teach the robot in all contextual conditions except specific contextual conditions that do not match the current conditions, and so forth).

In some examples, the data structure associates entities with levels of confidence. For example, a level of confidence associated with an entity in the data structure may a general level of confidence, a level of confidence associated with a specific category of actions, a level of confidence associated with specific contextual conditions, a level of confidence associated with specific subject matter, and so forth. In one example, step 806 may base the determination to learn from the first entity on a level of confidence associated in the data structure with the first entity (for example, when the level of confidence associated in the data structure with the first entity is above a selected threshold). In another example, step 814 may base the determination to not learn from the second entity on a level of confidence associated in the data structure with the second entity (for example, when the level of confidence associated in the data structure with the second entity is below a selected threshold). Such selected threshold may be a general threshold, a threshold selected based on the respective action, a threshold selected based on current contextual conditions, a threshold selected based on respective subject matter, and so forth. In yet another example, step 806 may base the determination to learn from the first entity on a lack of association for the first entity in the data structure (for example, when the default level of confidence is high enough). In an additional example, step 814 may base the determination to not learn from the second entity on a lack of association for the second entity in the data structure (for example, when the default level of confidence is too low).

In some examples, the data structure may associate entities with subject matters. For example, the subject matters associated with an entity in the data structure may be subject matters in which the robot may learn from the entity, may be subject matters in which the robot may not learn from the entity, and so forth. In one example, the first action may be associated with a specific subject matter, and step 806 may base the determination to learn from the first entity on the specific subject matter and on one or more subject matters associated in the data structure with the first entity. In another example, the section action may be associated with a specific subject matter, and step 814 may base the determination to not learn from the second entity on the specific subject matter and on one or more subject matters associated in the data structure with the second entity.

In some examples, the data structure may associate entities with actions. For example, the actions associated with an entity in the data structure may include a fixed list of actions (for example, where each action may be associated with different scores for different entities), actions successfully learnt or performed by the entity, actions associated with a failure of the entity, and so forth. In one example, step 806 may base the determination to learn from the first entity on a similarity between the first action and actions associated in the data structure with the first entity. In another example, step 814 may base the determination to not learn from the second entity on a similarity between the second action and actions associated in the data structure with the second entity.

In some examples, image data may be analyzed to identify a characteristic of an action (for example, using a visual classification algorithm, using a visual regression algorithm, and so forth). Further, a data structure (such as the data structure of step 806 and/or step 814, a different data structure, etc.) may be accessed based on an identity of an entity (such as an entity depicted performing the action in the image data, a different entity, and so forth) and the characteristic of the action to make a determination of whether to learn to perform the action from the entity. For example, the data structure may associate a combination of an entity and an action with a selected characteristic with a permission, with a level of confidence, and so forth. In one example, step 804 may further analyze the first image data to identify a characteristic of the first action, and step 806 may access the data structure based on the identity of the first entity and the characteristic of the first action to make the determination to learn from the first entity. In another example, step 812 may further analyze the second image data to identify a characteristic of the second action, and step 814 may access the data structure based on the identity of the second entity and the characteristic of the second action to make the determination not to learn from the second entity.

In some examples, the first entity of step 802 and/or the second entity of step 810 may not be in the data structure of step 806 and/or step 814. In one example, step 806 may base the determination to learn from the first entity on a similarity between the first entity and a first group of one or more entities from the data structure. In another example, step 814 may base the determination not to learn from the second entity on a similarity between the second entity and a second group of one or more entities from the data structure. For example, when the minimal similarity between a specific entity and entities in the data structure is above a selected threshold, it may be determined to learn from the entity, and/or when the minimal similarity between a specific entity and entities in the data structure is below a selected threshold, it may be determined not to learn from the entity. In another example, a value may be calculated as a function of the similarities between a specific entity to different entities in the data structure and of values associated in the data structure with the different entities (such as, a weighted sum, a polynomial function, a linear function, a non-linear function, etc.), and it may be determined whether to learn from the specific entity based on the calculated value.

In some examples, it may be determined whether to learn from a specific entity to perform a specific action based on contextual attributes (such as contextual attributes associated with the specific entity and the specific action, contextual attributes associated with image data depicting the specific entity performing the specific action, and so forth). Some non-limiting examples of such contextual attributes may include camera distance from the entity, viewpoint, environmental conditions, layout of an environment, occlusions, and so forth. In one example, step 806 may further base the determination to learn from the first entity on contextual attributes associated with the first image data. In another example, step 814 may further base the determination not to learn from the second entity on contextual attributes associated with the second image data. For example, some contextual attributes (such as occlusions, far distance from a camera, challenging layout, etc.) may be associated with challenging learning or poor results of learning, and therefore it may be determined to avoid learning. In another example, some contextual attributes (such as drunk entity, late time at night, etc.) may be associated with poorer performance by the entity, and therefore it may be determined to avoid learning.

In some examples, it may be determined whether to learn from a specific image data to perform a specific action based on performance rating associated with the specific action and the specific image data. For example, step 806 may further base the determination to learn from the first entity on a performance rating associated with the first action and the first image data. In another example, step 814 may further base the determination not to learn from the second entity on a performance rating associated with the second action and the second image data. For example, the specific image data may depict a failure of the specific action, therefore it may be determined to avoid learning from the specific image data. In another example, the specific image data may depict a below average result of the specific action, therefore it may be determined to avoid learning from the specific image data.

In some examples, step 808 may comprise analyzing image data (such as the first image data received by step 802, different image data, etc.) and/or a natural language input (such as a natural language input received from the first entity, a natural language input received from a different entity, a natural language input received step 710, etc.) to learn to perform an action (such as the first action of step 802, an action depicted in the image data, a different action, etc.), for example in response to the determination to learn from the first entity made by step 806. In one example, step 808 may use an artificial neural network to analyze the image data and/or natural language inputs to learn to perform the action. In another example, step 808 may use a foundation model to analyze the image data and/or natural language inputs to learn to perform the action. In yet another example, step 808 may use a machine learning model to analyze the image data and/or natural language inputs to learn to perform the action. The machine learning model may be a machine learning model trained using training examples to learn to perform actions from visual data and/or natural language inputs. An example of such training example may include sample image data depicting a sample action and/or sample and/or natural language input, together with a label indicative of an action model and/or data (such as parameters, coefficients, weights, representations, etc.) for configuring an action model corresponding to the sample action. In one example, the natural language input may clarify at least one of a reason for performing a sub-action of the action, an exception that requires different performance of the action, or a generalization of the action to other situations. In one example, the natural language input may be included in an audio data captured before, after, or simultaneously with the capturing of the image data.

In some examples, step 808 may analyze the image data to determine one or more characteristics of configurations, poses and/or movements of an entity depicted in the image data (such as the first entity) to thereby learn to perform an action depicted in the image data (such as the first action). For example, step 808 may analyze the first image data to identify a configuration of at least one autopodium of the first entity during the performance of the first action, for example using a visual pose estimation algorithm. In another example, step 808 may analyze the first image data to identify a motion pattern of at least one autopodium of the first entity (for example, the same at least one autopodium, different at least one autopodium, etc.) during the performance of the first action, for example using visual motion detection algorithm. In one example, process 800 may further comprise generating digital signals configured to activate a group of actuators of a robot (such as the robot of step 802 and/or step 810, a different robot, etc.) to cause the robot to imitate the configuration and/or the motion pattern (for example to perform the first action), for example as described above in relation to step 208 and/or using step 208.

In some examples, the learning to perform the first action by step 808 may include compensating for a difference in a physical attribute between the first entity and the robot. Some non-limiting examples of such physical attribute may include height, weight, limb length, number of limbs, hand size, motion capability (such as capabilities of specific joints, number of joints, locations of joints, etc.), strength, center-of-mass, and so forth. In one example, step 808 may analyze the first image data to determine the difference in the physical attribute between the first entity and the robot, for example using an artificial neural network, using a foundation model, using a trained machine learning model, and so forth. In some examples, the compensating may include adjusting motion speed based on a motion capability associated with the first entity. For example, the robot may be slower than the first entity, and the motion speed may be slowed to enable the robot to perform the movements. In another example, the robot may be faster than the first entity, and the motion speed may be increased to utilize the robot abilities. In some examples, the compensating may include adjusting timing of sub-actions of the first action based on a reaction speed associated with the first entity. For example, the robot may be slower than the first entity, and the timing of the sub-actions may be slowed to enable the robot to perform the sub-actions. In another example, the robot may be faster than the first entity, and the timing of the sub-actions may be accelerated to utilize the robot abilities. In some examples, the compensating may include adjusting a grasping configuration based on difference between a hand of the first entity and a hand of the robot. For example, the difference between the hands may include difference in a number of digits, in lengths of digits, in relative positions of digits, in motion's degrees of freedom of different digits, in strength, in dexterity, and so forth. In some examples, the compensating may include adjusting joint angles while performing the action. For example, the adjustment to adjusting joint angles may be due to the first entity and the robot having different number of joints, different positions of joints, different lengths of links, different motion abilities of joints, and so forth. In some examples, the compensating may include adjusting observed movements of the first entity in the first image data based on a length associated with the first entity. Some non-limiting examples of such length may include height, limb length, and so forth. For example, the adjustment to the observed movements may include scaling. In another example, the adjustment to the observed movements may include adjustment to a spatial trajectory.

In some examples, the learning to perform the first action by step 808 may include compensating for contextual attributes associated with the first image data received by step 802. Some non-limiting examples of such contextual attribute associated with the first image data may include camera distance from the first entity, viewpoint, environmental conditions, layout, and so forth. For example, the contextual attributes may include a layout that affects the performance of the first action by constraining motion, and the compensating may include determining how the first action may be performed when the layout does not constrain the motion. In another example, the contextual attributes may include a need to avoid noises, and the compensating may include determining how the first action may be performed when there is no or less need to avoid noises.

In some examples, the learning to perform the first action by step 808 may include selecting a level of generalization for the learning based on the first entity. For example, the level of generalization may determine whether to learn to perform similar actions to the first action from the first image data. For example, when the first entity is associated with a high level of confidence (for example in the data structure of step 806), the level of generalization may be high as well, and vice versa. In one example, the first action may include operating a specific device (such as a specific drill), and the level of generalization may determine whether to learn to operate similar devices (such as other drills) based on the first image data. In another example, the first action may include operating a specific category of devices (such as playing pianos), and the level of generalization may determine whether to learn to operate similar categories of devices (such as playing organs or synthesizers) based on the first image data. In some examples, the learning to perform the first action by step 808 may include adjustments to the first action based on one or more safety rules. Some non-limiting examples of such safety rules may include limiting movement speed, limiting lifted weight, limiting applied force, and so forth.

In some examples, step 816 may comprise avoiding learning to perform the second action from the second image data received by step 810, for example in response to the determination not to learn from the second entity made by step 814. For example, step 816 may avoid learning to perform the second action from the second image data by avoiding selected analysis of the second image data, and/or by avoiding storing information derived from a selected analysis of the second image data in a selected memory portion and/or by avoiding updating stored values in response to information derived from a selected analysis of the second image data.

In some examples, process 800 may further comprise, for example after learning to perform the first action by analyzing the first image data by step 808: obtaining a success indicator associated with the learned first action; and updating the data structure of step 806 and/or step 814 based on the success indicator. For example, the success indicator may indicate a complete success, a partial success, a failure, and so forth. In one example, the robot may attempt to perform the first action based on the learning of step 808, and the success indicator may be based on whether the attempt is successful. In another example, the robot may perform the first action based on the learning of step 808 obtaining partial success, and the success indicator may be based on a rating associated with the partial success. For example, the data structure may associate entities with subject matters, and the update to the data structure may include removing (or decreasing confidence of) an association of the first entity and a subject matter associated with the first action in response to a poor success indicator. In another example, the data structure may associate entities with levels of confidence, and the update to the data structure may include updating a level of confidence associated with the first entity based on the success indicator.

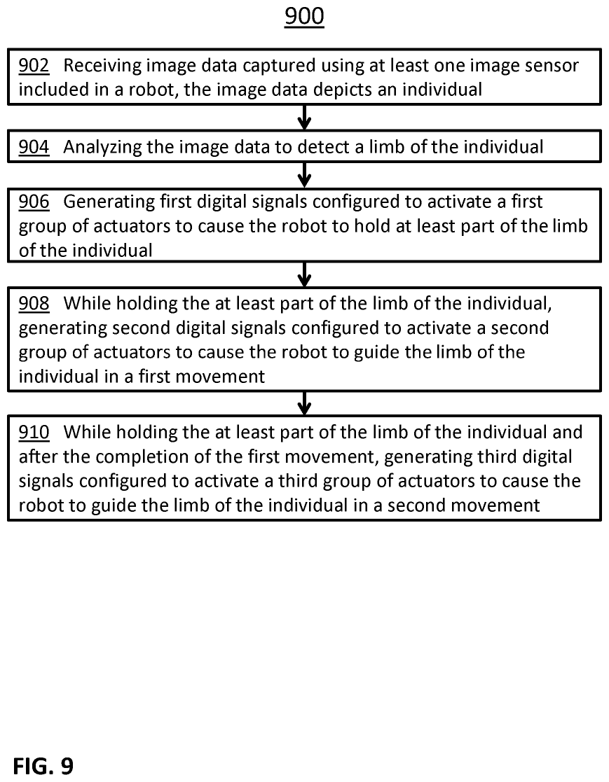

FIG. 9 is a flowchart of an exemplary process 900 for robotic guidance, consistent with some embodiments of the present disclosure. In this example, process 900 may comprise receiving image data captured using at least one image sensor included in a robot (step 902), the image data depicts an individual; analyzing the image data to detect a limb of the individual (step 904); generating first digital signals configured to activate a first group of actuators to cause the robot to hold at least part of the limb of the individual (step 906); while holding the at least part of the limb of the individual, generating second digital signals configured to activate a second group of actuators to cause the robot to guide the limb of the individual in a first movement (step 908); and while holding the at least part of the limb of the individual and after the completion of the first movement, generating third digital signals configured to activate a third group of actuators to cause the robot to guide the limb of the individual in a second movement (step 910). In other examples, process 900 may include additional steps or fewer steps. In other examples, one or more steps of process 900 may be executed in a different order and/or one or more groups of steps may be executed simultaneously. In some examples, a system for robotic guidance may include at least one processing unit configured to perform process 900. In one examples, the system may further comprise the robot of process 900. For example, the robot may include the at least one processing unit. In another example, the at least one processing unit may be external to the robot of process 900. A non-limiting example of such robot may be robot 100. In some examples, a method for robotic guidance may include performing process 900. In some examples, a non-transitory computer readable medium may store computer implementable instructions that when executed by at least one processor may cause the at least one processor to perform operations for robotic guidance, and the operations may include the steps of process 900. In one example, the second movement may differ from the first movement at least in a direction of motion. In another example, the second movement may differ from the first movement at least in a shape of a trajectory of motion. In one example, the limb of process 900 may be an arm. In another example, the limb of process 900 may be a leg. As used herein, the term “arm” is intended to broadly include any portion of an upper limb, including but not limited to the upper arm, forearm, wrist, and hand. Accordingly, references to an “arm” may encompass the hand unless explicitly stated otherwise. As used herein, the term “leg” is intended to broadly include any portion of a lower limb, including but not limited to the thigh, knee, lower leg, ankle, and foot. Accordingly, references to a “leg” may encompass the foot unless explicitly stated otherwise.

In some examples, step 904 may comprise analyzing image data (such as the image data received by step 902, different image data, etc.) to detect a limb (or specifically an arm, or specifically a leg) of an individual depicted in the image data (such as the individual of step 902, a different individual, and so forth). For example, step 904 may analyze the image data using a visual object detection algorithm and/or semantic segmentation algorithm and/or visual pose estimation algorithm to detect the limb of the individual. In one example, the image data may depict two or more limbs of the individual, and step 904 may select a specific limb of the two or more limbs. In another example, the image data may depict limbs of two or more individuals, and step 904 may select a specific individual of the two or more individual and/or may select a specific limb of a specific individual. For example, such selections may be based on a preference (such as, selecting an arm, selecting a leg, selecting the dominant arm, selecting an individual for guidance, selecting individual based on distance, selecting individual based on pose, and so forth).

In some examples, step 906 may comprise generating first digital signals configured to activate a first group of actuators to cause a robot (such as the robot of step 902, a different robot, etc.) to hold at least part of a limb of an individual (for example, the limb of the individual of step 904, a different limb of the individual of step 902 and/or step 904, a limb of a different individual, and so forth), for example as described above in relation step 208 and/or using step 208. For example, step 906 may cause the robot to hold the at least part of the limb using a hand of the robot (for example, in a humanoid robot), using an end effector, using a gripper, using a jaw gripper, using a three fingers gripper, using a soft gripper, using a jamming gripper, using fingers of a gripper, using jaws of a gripper, using a single arm of the robot, using two or more arms of the robot, and so forth.

In some examples, step 908 may comprise, for example while a robot (such as the robot of step 902 and/or step 906, a different robot, etc.) holds (for example, as a result of step 906, as a result of different measures, etc.) at least part of a limb of an individual (such as, the at least part of the limb of the individual of step 906, a different part of the limb of the individual of step 906, a limb of a different individual, etc.), generating second digital signals configured to activate a second group of actuators to cause the robot to guide the limb of the individual in a first movement, for example as described above in relation step 208 and/or using step 208. For example, the first group of actuators of step 906 and the second group of actuators of step 908 may be the same group of actuators, may be different groups of actuators, may have no actuator in common, may have at least one but not all actuators in common, and so forth.

In some examples, step 910 may comprise, for example while a robot (such as the robot of step 902 and/or step 906, a different robot, etc.) holds (for example, as a result of step 906, as a result of different measures, etc.) at least part of a limb of an individual (such as, the at least part of the limb of the individual of step 906, a different part of the limb of the individual of step 906, at least part of a limb of a different individual, etc.) and/or after the completion of the first movement caused by step 908, generating third digital signals configured to activate a third group of actuators to cause the robot to guide the limb of the individual in a second movement, for example as described above in relation step 208 and/or using step 208. For example, the first group of actuators of step 906 and the third group of actuators of step 910 may be the same group of actuators, may be different groups of actuators, may have no actuator in common, may have at least one but not all actuators in common, and so forth. In another example, the second group of actuators of step 908 and the third group of actuators of step 910 may be the same group of actuators, may be different groups of actuators, may have no actuator in common, may have at least one but not all actuators in common, and so forth.

In some examples, step 910 may further comprise: receiving an input from the individual before a completion of the second movement (for example, input may be audible input, verbal input, natural language input, non-verbal audible input, gesture, facial expression, visual input, etc.); analyzing the input received from the individual to determine a desire to modify the second movement; and modifying the second movement in response to the input received from the individual. For example, the input may be received before the second movement is initiated, after the second movement is initiated but before it is completed, and so forth. In one example, the input may be indicative of pain or discomfort. Some non-limiting examples of such input indicative of pain or discomfort may include facial expressions (such as grimacing, wincing, or jaw clenching), increased heart rate, rapid breathing, non-verbal vocalizations (such as sighing, groaning, moaning, or screaming), verbal (such as ‘stop!’ or ‘that's irritating’), and so forth. In one example, the input may be indicative of a desire to avoid guidance or assistance, such as ‘I can do it on my own’ or ‘I'm familiar with this technique’. In one example, the input may be indicative of a desire to stop or change the second movement (such as, ‘let's try reaching out further this time’ or ‘stop!’). In one example, the input may be indicative of a motion limitation of the individual, such as a verbal indication of the motion limitation, a physical response of the body of the individual indicative of the motion limitation, and so forth. In some examples, step 910 may use at least one of an NLP algorithm, a foundation model, an artificial neural network, a trained machine learning algorithm, a visual gesture recognition algorithm, or a speech recognition algorithm to analyze the input to determine the desire to modify the second movement. In one example, the modification may include an unplanned mid-movement stopping of the second movement. In another example, the modification may include an unplanned mid-movement change to a speed of motion associated with the second movement. In yet another example, the modification may include an unplanned mid-movement change to a trajectory of the second movement, such as change in at least one of a direction of motion, an extent of motion, or a shape of the trajectory. In one example, the input may be indicative of a motion limitation of the individual, and the modification may include an unplanned mid-movement change to a trajectory of the second movement.

In some examples, process 900 may further comprise determining a motion limitation of the individual (for example, determining the existence of the motion limitation, determining the type of the motion limitation, determining parameters of the motion limitation, and so forth). In one example, process 900 may analyze the image data received by step 902 to determine the motion limitation, for example using a visual classification algorithm configured to identify motion limitations of individuals, using an artificial neural network, using a foundation model (for example, with a suitable prompt, such as ‘are there any signs of motion limitation of the individual in this video?’), using a machine learning model trained to identify motion limitations of individuals, and so forth. In another example, process 900 may analyze natural language input (such as ‘I've shoulder impingement syndrome’ or ‘I can't straighten my elbow’) to determine the motion limitation, for example using an NLP algorithm, using speech recognition algorithm, using a foundation model, and so forth. In yet another example, process 900 may analyze a record associated with the individual (such as a medical record, an intake questionnaire, a treatment record, etc.) to determine the motion limitation, for example using an NLP algorithm, using an artificial neural network, using a foundation model, and so forth. In one example, step 908 may base the generation of the second digital signals on the determined motion limitation, and/or step 910 may base the generation of the third digital signals on the determined motion limitation. For example, step 908 may generate the second digital signals to guide the limb of the individual in a first movement aligned with the motion limitation, and/or the step 910 may generate the third digital signals to guide the limb of the individual in a second movement aligned with the motion limitation. For example, the motion limitation may include a difficulty raising the arm overhead (for example, due to shoulder impingement syndrome), and in response, the first and second movements may avoid raising the arm overhead. In another example, the motion limitation may include a reduced ability to fully straighten the knee, and in response, the first and second movements may avoid straightening of the knee.

In some examples, process 900 may further comprise determining a desired action for the individual. In one example, the desired action may be determined based on information such as a goal, a task, an instruction, a guideline, a request received from the individual, captured information (such as the captured information received using step 202, the image data received using step 902, audio data captured using at least one audio sensor, etc.), and so forth. For example, such information may be analyzed to determine a desired action where the individual requires assistance and/or guidance (for example, based on a request received from the individual or from a different individual, based on an instruction received from a different individual, due to an observed difficulty of the individual in performing the desired action, and so forth). In one example, a machine learning model to analyze may be used to analyze such information and determine the desired action. The machine learning model may be a machine learning model trained using training examples to determine desired actions based on information. An example of such training example may include sample information (for example, sample captured information), together with an indication of a sample desired action corresponding to the sample information. In another example, a foundation model may be used to analyze such information (for example, with a suitable prompt, such as ‘is there an action that the individual requires guidance for in this captured image/audio/data’) to determine the desired action. In one example, step 908 may, before generating the second digital signals, determine, based on the desired action for the individual, at least one desired characteristic of the first movement. In another example, step 908 may, before generating the third digital signals, determine, based on the desired action, at least one desired characteristic of the second movement. For example, the desired action may be throwing a ball, the first movement may include drawing an arm back, the second movement may include swinging the arm forward and releasing, the desired characteristics of the first movement may include that the hand is higher than the shoulder, and the desired characteristics of the second movement may include speed and/or direction. In another example, the desired action may be applying toothpaste to a toothbrush, the first movement may include positioning a toothpaste tube over the toothbrush, the second movement may include squeezing the tube, the desired characteristics of the first movement may include an orientation of the tube relative to the toothbrush, and the desired characteristics of the second movement may include a magnitude of the squeeze. In one example, step 908 may base the generation of the second digital signals on the determined at least one desired characteristic of the first movement, and/or step 910 may base the third digital signals on the at least one desired characteristic of the second movement. In another example, step 908 may select the second group of actuators based on the determined at least one desired characteristic of the first movement, and/or step 910 may select the third group of actuators based on the at least one desired characteristic of the second movement. In one example, the desired action may be associated with at least one of bathing, shaving, cleaning, eating, drinking, or drying. In another example, the desired action may be associated with a sporting activity. In yet another example, the desired action may be associated with at least one of self-grooming or maintaining personal hygiene. In one example, the desired action may be determined based on a time of day. For example, when the individual stands next to a bathroom basin at waking time, the desired action may be brushing the individual's teeth, and when the individual stands next to a bathroom basin when dinner is served, the desired action may be washing the individual's hands. In one example, the desired action may be determined based on a location. For example, in a golf course, the distance from a hole may determine a desired type of shot. In some examples, image data (such as the image data received by step 902, different image data, etc.) may be analyzed to determine the desired action. For example, the image data may be analyzed using a visual object detection algorithm to detect physical objects, may be analyzed using a visual event detection algorithm to detect events in a physical environment, may be analyzed using a visual classification algorithm to determine one or more attributes, and so forth. Further, the desired action may be determined based on the detected objects and/or the detected events and/or the determined attributes. In some examples, a natural language input may be received (for example, as described above in relation to step 710 and/or using step 710). Further, the natural language input may be analyzed to determine the desired action, for example using an NLP algorithm, using an artificial neural network, using a foundation model, and so forth. For example, the natural language input may be indicative of a need for assistance and/or guidance associated with the desired action. In another example, the natural language input may be received from the individual, from an entity different from the individual, from a different individual, from a different robot, and so forth.

In some examples, the limb of process 900 may be an arm, and process 900 may further comprise, for example before generating the second digital signals by step 908 and/or before generating the third digital signals by step 910: generating fourth digital signals configured to activate a fourth group of actuators to cause the robot the pick a particular object, for example as described above in relation step 206 and/or step 208, and/or using step 206 and/or step 208; and generating fifth digital signals configured to activate a fifth group of actuators to cause the robot to place the particular object in a hand of the individual included in the arm of the individual, for example as described above in relation step 206 and/or step 208, and/or using step 206 and/or step 208. Some non-limiting examples of such particular object may include a soap bar, liquid soap bottle, sponge, comb, shaving accessory, cutlery item, or a sporting equipment. For example, the first and second movements may be associated with a shower (such as lathering, scrubbing, exfoliating, washing, cleansing, etc.), and the particular object may be at least one of a soap bar, liquid soap bottle, or sponge. In another example, the first and second movements may be associated with drying, and the particular object may be a towel. In yet another example, the first and second movements may be associated with dining, and the particular object may be cutlery item. In one example, process 900 may further comprise, for example after generating the second digital signals by step 908 and/or after generating the third digital signals by step 910, generating sixth digital signals configured to activate a sixth group of actuators to cause the robot to take the particular object from the hand of the individual, for example as described above in relation step 206 and/or step 208, and/or using step 206 and/or step 208.

In some examples, process 900 may further comprise: selecting a holding-position on the limb of the individual based on a plan associated with the first movement of step 908 and/or on a plan associated with the second movement of step 910. For example, the plan associated with the first movement and the plan associated with the first movement may be the same plan, may be different plans, may be a plan to perform a task, may be a plan to reach goal, and so forth. In one example, when the plan includes moving the forearm without moving the upper arm, the holding point may be on the forearm, for example away from elbow and closer to the wriest. In another example, when the plan includes moving the entire arm, the holding point may be on the upper arm, for example away from the shoulder and closer to the elbow. In one example, image data (such as the image data received by step 902, different image data, etc.) may be analyzed to select the holding point. For example, the image data may show a wound or bruised skin on the limb, and the selection of the holding-position may avoid the region of the wound or the bruised skin. In another example, the image data may show a clothing covering a part of the limb, and the selection of the holding-position may avoid the part covered by the cloth to avoid slippage. Further, step 906 may base the generation of the first digital signals on the selected holding-position, for example to cause the robot to hold the at least part of the limb of the individual at the selected holding-position.

In some examples, process 900 may further comprise, for example after generating the second digital signals by step 908 and/or after generating the third digital signals by step 910: determining a need to repeat the first movement of step 908; and generating fourth digital signals configured to activate a fourth group of actuators to cause the robot to guide the limb of the individual in the first movement again, for example as described above in relation to step 908 and/or step 208. For example, the determination of the need to repeat the first movement may be based on the an analysis of a natural language input (for example, a natural language input received from the individual, a natural language input received from a different individual, a natural language input indicative of a desire for a repeated guidance, and so forth). In another example, the determination of the need to repeat the first movement may be based on an indication that the individual failed to learn to perform a desire action associated with the first movement and/or second movement. For example, the indication may be an observation that the individual fails to perform the desired action correctly.

In some examples, process 900 may further comprise, for example before generating the first digital signals by step 906: determining that a current pose of the individual is suboptimal. For example, process 900 may analyze image data (such as the image data received by step 902, different image data depicting the individual, etc.) using a visual pose estimation algorithm to determine the current pose of the individual, or may use wearable sensors to determine the current pose of the individual; and may use a classifier algorithm to determine whether the current pose is suboptimal. In another example, process 900 may analyze inputs (such as image data, wearable sensors location, etc.) to determine whether the current pose of the individual is suboptimal, for example using a classifier algorithm, using an artificial neural network, using a foundation model (for example, with a suitable prompt, such as ‘is the pose reflected in this input is a good initial pose for a forehand groundstroke?’), and so forth. In some examples, process 900 may further comprise, for example in response to the determination that the current pose of the individual is suboptimal and/or before generating the first digital signals by step 906, providing guidance to the individual to assume a desired initial pose. Such provided guidance may include natural language output (such as instructions for assuming a desired pose, a request to assume a desired pose, a description of a desired pose, an explanation of the benefits of a desired pose, an audible natural language output, a textual natural language output, etc.), a visual demonstration a desired pose (such as an image or a video of a person at the desired pose, possibly with visual indicators explaining characteristics of the desired pose), a physical demonstration of the desired pose by the robot (for example, when the robot is a humanoid robot), a physical guidance through touch between the robot and the individual (for example, using another instance of process 900), and so forth. For example, the first and/or second movement may require an initial pose with specific characteristics, the current pose may not match the specific characteristics, and the provided guidance may include guidance for assuming a pose with the specific characteristics.

In some examples, process 900 may further comprise generating fourth digital signals configured to activate a fourth group of actuators to cause the robot to hold at least part of a second limb of the individual different from the limb of step 904 and/or step 906 and/or step 908 and/or step 910 (for example, as described above in relation step 208 and/or using step 208 and/or as described above in relation to step 906, the first digital signals, the first group of actuators and the first limb of the individual); and, while holding the at least part of the second limb of the individual, generating fifth digital signals configured to activate a fifth group of actuators to cause the robot to guide the second limb of the individual in a third movement (for example, as described above in relation step 208 and/or using step 208 and/or as described above in relation to step 908, the second digital signals, the second group of actuators, the first limb of the individual, and the first movement). For example, the third movement may be at least partly simultaneous with at least one of the first movement or the second movement, may be after the completion of the second movement, may be before the initiation of the first action, may be before the generation of the first digital signals, and so forth. In one example, step 908 may generate the second digital signals and/or step 910 may generate the third digital signals while holding the at least part of the second limb of the individual. In one example, the second movement and/or the third movement may be synchronized with at least one of the first and second movements to create a coordinated action of the two limbs. In one example, the limb of step 904 may be an arm and the second limb may be a leg. In another example, the limb of step 904 may be a first arm and the second limb may be a second arm. In yet another example, the limb of step 904 may be a leg and the second limb may be an arm. In an additional example, the limb of step 904 may be a first leg and the second limb may be a second leg.

In some examples, process 900 may further comprise: generating fourth digital signals configured to activate a fourth group of actuators to cause the robot to hold at least part of a torso of the individual (for example, as described above in relation step 208 and/or using step 208 and/or as described above in relation to step 906, the first digital signals, the first group of actuators and the first limb of the individual). Further, step 908 may generate the second digital signals and/or step 910 may generate the third digital signals while holding the at least part of the torso of the individual. For example, the robot may hold the at least part of the torso of the individual to provide support to the individual while the individual undergoes the first movement and/or the second movement. In another example, the robot may hold the at least part of the torso of the individual to maintain balance of the individual while the individual undergoes the first movement and/or the second movement. In yet another the example, robot may hold the at least part of the torso of the individual to prevent the individual from moving the torso while the individual undergoes the first movement and/or the second movement. In an additional example, the robot may hold the at least part of the torso of the individual to guide the individual to move the torso while the individual undergoes the first movement and/or the second movement.

In some examples, the first digital signals generated by step 906 may be configured to cause the robot to hold with a first robotic hand the at least part of the limb of the individual at a first holding-position on the limb. Further, process 900 may further comprise generating fourth digital signals configured to activate a fourth group of actuators to cause the robot to hold with a second robotic hand the at least part of the limb of the individual at a second holding-position on the limb (for example, as described above in relation step 208 and/or using step 208 and/or as described above in relation to step 906, the first digital signals, the first group of actuators and the first limb of the individual). In one example, step 908 may generate the second digital signals while holding the at least part of the limb of the individual at the first holding-position with the first robotic hand and at the second holding-position with the second robotic hand. In one example, step 910 may generate the third digital signals while holding the at least part of the limb of the individual at the first holding-position with the first robotic hand and at the second holding-position with the second robotic hand. For example, the robot may hold the at least part of the limb of the individual at the second holding-position to provide support to one portion of the limb while another portion of the limb undergoes the first movement and/or the second movement. In another example, the robot may hold the at least part of the limb of the individual at the second holding-position to prevent one portion of the limb from moving while another portion of the limb undergoes the first movement and/or the second movement. In an additional example, the robot may hold the at least part of the limb of the individual at the second holding-position to one portion of the limb to move while another portion of the limb undergoes the first movement and/or the second movement.

In some examples, process 900 may further comprise: obtaining information in a natural language; and generating an audible output of the determined information in the natural language (for example, as described above in relation to step 612 and/or using step 612). For example, the information in the natural language may be determined based on information (for example, as described above in relation to step 608), may be generated using a generative model, may be read from memory (for example, from a digital memory, from memory unit 162, etc.), may be received from an external computing device (for example, using a digital communication device, such as communication module 166), and so forth. In one example, the audible output may be generated before generating the first digital signals by step 906. In another example, the audible output may be generated before generating the second digital signals by step 908. In yet another example, the audible output may be at least partly simultaneous with at least one of the first movement or the second movement. In an additional example, the audible output may be generated after the third movement is completed. For example, the audible output may indicate the actions to the individual, may explain a reason for the actions to the individual, may request a permission from the individual to touch the individual, may request a permission from the individual to perform the actions, and so forth.

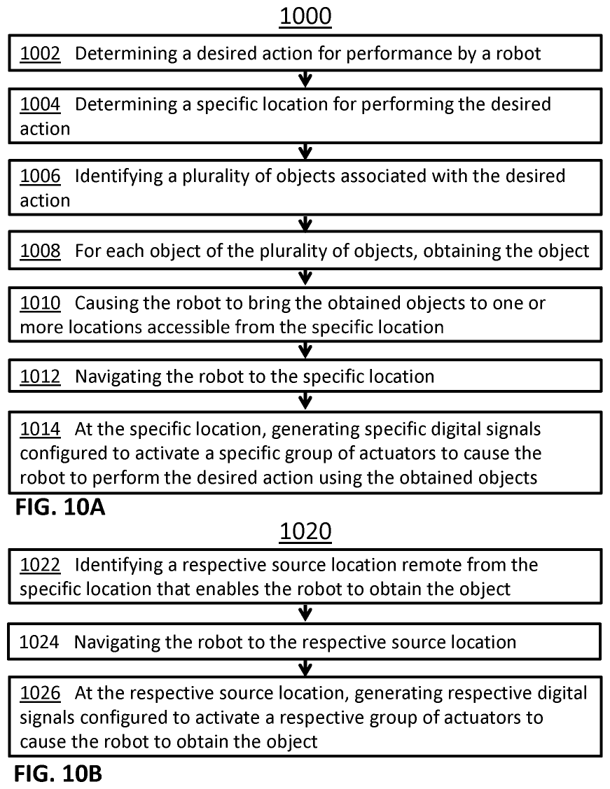

FIG. 10A is a flowchart of an exemplary process 1000 for robotic preparation for task execution, consistent with some embodiments of the present disclosure. In this example, process 1000 may comprise: determining a desired action for performance by a robot (step 1002); determining a specific location for performing the desired action (step 1004); identifying a plurality of objects associated with the desired action (step 1006); for each object of the plurality of objects, obtaining the object (step 1008), for example using process 1020; causing the robot to bring the obtained objects to one or more locations accessible from the specific location (step 1010); navigating the robot to the specific location (step 1012); and at the specific location, generating specific digital signals configured to activate a specific group of actuators to cause the robot to perform the desired action using the obtained objects (step 1014). In other examples, process 1000 may include additional steps or fewer steps. In other examples, one or more steps of process 1000 may be executed in a different order and/or one or more groups of steps may be executed simultaneously. In some examples, a system for robotic preparation for task execution may include at least one processing unit configured to perform process 1000. In one examples, the system may further comprise the robot of process 1000. For example, the robot may include the at least one processing unit. In another example, the at least one processing unit may be external to the robot of process 1000. A non-limiting example of such robot may be robot 100. In some examples, a method for robotic preparation for task execution may include performing process 1000. In some examples, a non-transitory computer readable medium may store computer implementable instructions that when executed by at least one processor may cause the at least one processor to perform operations for robotic preparation for task execution, and the operations may include the steps of process 1000.

FIG. 10B is a flowchart of an exemplary process 1020 for obtaining object using robots, consistent with some embodiments of the present disclosure. In this example, process 1020 may comprise: identifying a respective source location remote from the specific location that enables the robot to obtain the object (step 1022); navigating the robot to the respective source location (step 1024); and, at the respective source location, generating respective digital signals configured to activate a respective group of actuators to cause the robot to obtain the object (step 1026). In other examples, process 1020 may include additional steps or fewer steps. In other examples, one or more steps of process 1020 may be executed in a different order and/or one or more groups of steps may be executed simultaneously. In some examples, a system for obtaining object using robots may include at least one processing unit configured to perform process 1020. In one examples, the system may further comprise the robot of process 1020. For example, the robot may include the at least one processing unit. In another example, the at least one processing unit may be external to the robot of process 1020. A non-limiting example of such robot may be robot 100. In some examples, a method for obtaining object using robots may include performing process 1020. In some examples, a non-transitory computer readable medium may store computer implementable instructions that when executed by at least one processor may cause the at least one processor to perform operations for obtaining object using robots, and the operations may include the steps of process 1020.

In some examples, step 1002 may comprise determining a desired action for performance by a robot, for example as described above in relation to step 204 and/or using step 204. Some non-limiting examples of such desired action may include an action on a subject, injecting a solution to a subject, massaging a person, grooming a person, dressing a person, changing a diaper, shaving a person, haircutting, washing dishes, wrapping an object, dressing a wound, cleaning, and so forth. Some non-limiting examples of such subject may include a person, an animal, a domesticate animal, a pet animal, or a farm animal. In one example, the desired action may include at least one of cutting hair, shaving, brushing, or cleaning. In some examples, the desired action may comprise physically transforming at least one of the objects obtained by step 1008. For example, the at least one of the obtained objects may include a substance, and the substance may be applied to another physical object (such as a person, a pet animal, a pot, another object of the obtained objects, and so forth). In another example, the at least one of the obtained objects may include a closed object, and the physically transformation may include opening the closed object. In some examples, the desired action may comprise coordinating interaction between the obtained objects. For example, the at least one of the obtained objects may include two substances, and the coordinated interaction may include adding the two substances to a pot in a selected order and at selected times. In some examples, the desired action may comprise combining at least two of the obtained objects to produce a modified result. For example, the at least one of the obtained objects may include two substances, and the coordinated interaction may include blending the two substances together. In another example, the at least one of the obtained objects may include a key and a lock, and the coordinated interaction may include opening the lock with the key. In some examples, wherein the desire action may include using at least one of the plurality of objects to modify a physical characteristic of a subject. Some non-limiting examples of such subject may include a person, an animal, a domesticate animal, a pet animal, or a farm animal. For example, the at least one of the plurality of objects may include scissors, and the scissors may be used to cut hair of the subject.

In some examples, step 1004 may comprise determining a specific location for performing a desired action (such as the desired action of step 1002, a different desired action, and so forth). For example, the desired action may include showering a person, and the specific location may be a shower. In another example, the desired action may include washing dishes, and the specific location may be a kitchen sink. In some examples, step 1004 may determine the specific location for performing the desired action based on the desired action. In one example, step 1004 may determine required characteristics for the specific location based on the desire action, and may select the specific location based on the determined required characteristics for the specific location. For example, the desired action may include ironing clothes, and the specific location may need to enable opening and positioning an ironing board. In another example, the desired action may include injecting a solution to a person, and the specific location may need a comfortable chair for the person. In one example, the specific location determined by step 1004 may comprise an operational workspace configured for performing the desired action using the obtained objects. In one example, step 1004 may access a data structure based on the desired action to determine the specific location. For example, the data structure may associate desired actions and/or categories of desired actions with locations and/or required characteristics for locations. In one example, step 1004 may use an artificial neural network to determine the specific location for performing the desired action, for example based on the desired action and/or other information. In one example, step 1004 may use a foundation model (for example, with a suitable prompt, such as ‘where can I {the desired action} at the house?’) to determine the specific location for performing the desired action, for example based on the desired action and/or other information. In one example, step 1004 may use a machine learning model to determine the specific location for performing the desired action, for example based on the desired action and/or other information. The machine learning model may be a machine learning model trained using training examples to select locations for performing actions based on the actions and/or other information. An example of such training example may include an indication of a sample action and/or other information, together with a label indicative of a sample selection of location for performing the sample action. In some examples, step 1004 may receive an indication of a desired location and/or desired characteristics of a location, and may determine the specific location for performing the desired action based on the desired location and/or the desired characteristics of a location. For example, step 1004 may receive the indication from an individual (for example, via a user interface, using a keyboard, using a pointing device, using a touch surface, using a microphone, using an audio sensor, via gesture, via voice command, via natural language input, etc.), from a data structure, from a different process, from an external computing device (for example, using a digital communication device), from memory, and so forth. In one example, the indication may include ‘that can get messy, do that over a sink’, and step 1004 may select the bathroom sink as the specific location. In another example, the indication may include ‘rub my feet’ said by a woman sitting with her foot up, and the specific location may be where the foot is.

In some examples, step 1006 may comprise identifying a plurality of objects associated with a desired action (such as the desired action of step 1002 and/or step 1004, a different desired action, and so forth). For example, the desire action may be an action on a subject, and the plurality of objects may include at least one tool configured to physically contact the subject. Some non-limiting examples of such subject may include a person, an animal, a domesticate animal, a pet animal, or a farm animal. Some non-limiting examples of such tools may include prosthetic devices, orthotic devices, mobility aids, adaptive utensils, watches, smartwatches, bracelets, jewelries, hearing aids, glasses, blood pressure cuffs, massage tools, lotions, creams, soap, and so forth. In another example, the desire action may include injecting a solution to a subject, and the plurality of objects may include a syringe and an antiseptic swab. Some non-limiting examples of such subject may include a person, an animal, a domesticate animal, a pet animal, or a farm animal. In this example, the plurality of objects may further include at least one of the solution, sharps container, cotton ball, or tissue. In this example, the syringe may be a pre-filled syringe with the solution. In yet another example, the desire action may include changing a diaper, and the plurality of objects may include a clean diaper. In this example, the plurality of objects may further include at least one of cleaning wipes, rash cream, rash ointment, changing mat, towel, or waste bag. In an additional example, the desire action may include at least one of shaving or haircutting, and the plurality of objects may include at least one of a razor, shaver, trimmer, clippers or scissors. In this example, the plurality of objects may further include at least one of shaving cream, shaving gel, shaving foam, towel, shaving brush, or aftershave. In one example, step 1006 may access, based on the desired action and/or other information, a data structure associating actions with required objects to identify the plurality of objects. For example, the data structure may be stored in memory (such as a digital memory), may be part of a database, may be included in an artificial neural network, and so forth. In another example, step 1006 may use an artificial neural network to identify the plurality of objects based on the desired action and/or other information. In yet another example, step 1006 may use a foundation model (for example, with a suitable prompt, such as ‘what do I need in order to perform {the desired action}?’) to identify the plurality of objects based on the desired action and/or other information. In an additional example, step 1006 may use a machine learning model to identify the plurality of objects based on the desired action and/or other information. The machine learning model may be a machine learning model trained using training examples to determine required items for performing actions based on the actions and/or other information. An example of such training example may include an indication of a sample action and/or other information, together with a label indicative of a sample group of items required for performing the sample action. In one example, step 1006 may simulate the desired action to identify the plurality of objects. For example, the desired action may include wrapping an object with a wrapping paper, and the simulation may indicate a minimal size of wrapping paper required for wrapping the object. In another example, the desired action may include dressing a wound, the simulation may be based on captured image data depicting the wound and surrounding skin, and the simulation may indicate the need for an adhesive to hold the dressing in place. In one example, the desire action may be an action on a subject, and step 1006 may further base the identifying the plurality of objects on a characteristic of the subject. For example, the desired action may include dressing a person, and the plurality of objects may include clothes in a size corresponding to the person. In another example, the desired action may include massaging a person, and the plurality of objects may include a cream preferred by the person and/or may not include substances that the person is allergic to. Some non-limiting examples of such characteristic of the subject may include preferences of the subject, allergies of the subject, measurements of the subject, weight of the subject, height of the subject, disablement of the subject, condition of the subject, ability of the subject, and so forth. In one example, step 1006 may base the identifying the plurality of objects on a location for performing the desired action (such as the specific location determined by step 1004, a different location for performing the desired action, and so forth). For example, the desired action may include cleaning an item, when the specific location is outdoor or well ventilated, step 1006 may include smelly cleaning materials in the plurality of objects, and when the specific location is in a poorly ventilated space, step 1006 may avoid including smelly cleaning materials in the plurality of objects.

In one example, step 1006 may select, based on availability, a specific object from a group of two or more alternative objects matching the desired action, and may include the selected object in the plurality of objects. For example, the desired action may include brushing a person hair, the two or more alternative objects may include different hair brushes (such as vented, round, boar bristle brush, rat-tail brush, paddle brush, wide tooth brush, loop brush, etc.), and step 1006 may avoid including brushes that are unavailable in the current environment and/or may select a brush of the different hair brushes that is available in the current environment (even if a brush unavailable in the current environment is better suited for a hair type of the person and/or for a goal associated with the brushing).

In some examples, step 1008 may comprise, for each object of a plurality of objects (such as the plurality of objects identified by step 1006, a different plurality of objects, etc.), obtaining the object. In one example, step 1008 may obtain an object by requesting a person and/or a different robot to bring the object. For example, step 1008 may transmit a digital signal encoding the request to a different robot and/or a system controlling the different robot. In another example, step 1008 may generate an audible output including speech indicative of the request. In one example, step 1008 may cause the robot of step 1002 and/or step 1010 and/or step 1012 and/or step 1014 to obtain an object, for example using process 1020. In one example, step 1008 may use process 1020 to obtain an object. In some examples, step 1022 may comprise identifying a respective source location that enables a robot (such as the robot of step 1002, a different robot, etc.) to obtain an object (such as an object of the plurality of objects identified by step 1006, a different object, and so forth). In one example, the respective source location may be remote from the specific location determined by step 1004 (for example, at least a selected number of feet from the specific location, such as at least two feet, at least five feet, at least ten feet, etc.), may be close to the specific location determined by step 1004 (for example, at most a selected number of feet from the specific location, such as at most two feet, at most five feet, at most ten feet, etc.), may be the specific location determined by step 1004, and so forth. For example, a source location that enables the robot to obtain an object may be a distance that enables the robot to grab the object with a robotic arm (thereby, at a distance shorter than a length of the robotic arm from the object. In another example, a source location that enables the robot to obtain an object may be a location that the robot may safely navigate to (for example, without passing through dangerous or prohibited regions). In yet another example, a source location that enables the robot to obtain an object may be a location that enables the robot to stably stand. In one example, step 1022 may identify a respective source location that enables the robot to obtain an object based on at least one of a known location of the object, a last known location of the object, or a visual detection of the object in captured image data. In some examples, step 1024 may comprise navigating a robot (such as the robot of step 1002 and/or step 1022, a different robot, etc.) to a respective source location (such as the respective source location identified by step 1022, a different respective source location, etc.), for example using a motion planning algorithm, using a navigation algorithm, or using process 200 as described above, and so forth. In some examples, step 1026 may comprise, for example at the respective source location identified by step 1022 and/or navigated to by step 1024, generating respective digital signals configured to activate a respective group of actuators to cause a robot (such as the robot of step 1002 and/or step 1022 and/or step 1024, a different robot, etc.) to obtain an object (such as the object of step 1022, an object of the plurality of objects identified by step 1006, a different object, and so forth), for example as described above in relation to step 208 and/or using step 208. For example, the digital signals generated by step 1026 may cause the robot to grab the object using a hand of the robot (for example, in a humanoid robot), using an end effector, using a gripper, using a jaw gripper, using a three fingers gripper, using a soft gripper, using a jamming gripper, using fingers of a gripper, using jaws of a gripper, using a single arm of the robot, using two or more arms of the robot, and so forth.

In some examples, step 1010 may comprise causing a robot (such as the robot of step 1002 and/or step 1022 and/or step 1024 and/or step 1026, a different robot, etc.) to bring obtained objects (such as objects obtained by step 1008, objects obtained by process 1020, different obtained objects, and so forth) to one or more locations accessible from a specific location (such as the specific location determined by step 1004, a different specific location, and so forth). In one example, the obtained objects may be placed by the robot one after another (such that each object is placed before the next object is obtained). For example, for each object of the obtained objects, after the robot obtains the object, step 1010 may comprise: navigating the robot to a respective position while the robot holds the object; and causing the robot to place, for example from the respective position, the object at a respective location accessible from the specific location (for example, as described above in relation to step 208 and/or using step 208). In one example, two or more obtained objects may be placed by the robot at the same time. For example, after obtaining all objects of the plurality of objects, step 1010 may comprise: navigating the robot to a selected position; and causing the robot to place the plurality of objects at the one or more locations (for example, as described above in relation to step 208 and/or using step 208). In some examples, step 1012 may comprise navigating a robot (such as the robot of step 1002 and/or step 1010 and/or step 1022 and/or step 1024 and/or step 1026, a different robot, etc.) to a specific location (such as the specific location determined by step 1004, a different specific location, and so forth), for example using a motion planning algorithm, using a navigation algorithm, or using process 200 as described above, and so forth.

In some examples, step 1014 may comprise, for example at the specific location determined by step 1004, generating specific digital signals configured to activate a specific group of actuators to cause the robot to perform the desired action using the obtained objects, for example as described above in relation to step 208 and/or using step 208 and/or using process 200. In one example, the desire action determined by step 1002 may be an action on a subject, and the generating the specific digital signals by step 1014 may be based on real-time sensor data (such as real-time image data, real-time audio data, real-time pose data, etc.) obtained from the subject. Some non-limiting examples of such subject may include a person, an animal, a domesticate animal, a pet animal, or a farm animal. For example, the specific digital signals may compensate for real-time movements of the subject, may be adjusted based on a reaction of the subject during the performance of the desired action, and so forth. For example, the real-time sensor data may indicate the subject is in pain, and the specific digital signals may be adjusted to reduce pain causing activities. In some examples, the desire action determined by step 1002 may be an action on a subject (some non-limiting examples of such subject may include a person, an animal, a domesticate animal, a pet animal, or a farm animal), and step 1014 may determine a manner of using at least one of the obtained objects based on a characteristic of the subject. Some non-limiting examples of such subject may include a person, an animal, a domesticate animal, a pet animal, or a farm animal. For example, the characteristic of the subject may be determined in real-time based on analysis of real-time sensor data (such as real-time image data, real-time audio data, real-time pose data, and so forth). In another example, the characteristic of the subject pre-known (for example, may be obtained from medical records, may be determined from sensor data captured beforehand, may be obtained from a record or a profile of the subject, may be determined based on social media, may be determined based on past activities of the subject, and so forth). In one example, the desired action may include dressing a wound of the subject, the characteristic of the subject may include a condition of the wound, and step 1014 may determine a manner of using a bandage and/or an ointment based on the condition of the wound. In another example, the desired action may include treating the subject with a Transcutaneous Electrical Nerve Stimulation (TENS) device, the characteristic of the subject may include characteristic of pain that the subject suffers from, and step 1014 may adjust the manner of using the TENS device (such as location of the electrodes, type of electrical current, etc.) based on the characteristic of the pain. In some examples, step 1014 may cause the robot to use at least two of the obtained objects simultaneously. In some examples, step 1014 may cause the robot to use at least two of the obtained objects sequentially in a selected order. In one example, the selected order may be predefined, may be randomly selected, may be selected based on a characteristic of a subject associated with the desired action of step 1002, may be selected based on the specific location determined by step 1004, and so forth. In some examples, performing the desired action (by the robot) may comprise applying a substance using a first object of the obtained objects and subsequently manipulating the substance using a second object of the obtained objects. For example, the first object may be an applicator, the second object may be a comb or a brush, the applicator may be used to apply gel to a subject's hair, and the brush or the comb may be then used to distribute and/or shape the gel. In another example, the first object may be a cream dispenser or spatula, the second object may be a roller, pad or massaging device, the cream dispenser or spatula may be used to apply a cream or serum to a subject's skin, and the roller, pad or massaging device may be then used to press or spread the cream or serum onto the skin. In yet another example, the first object may be an applicator for antiseptic or ointment, the second object may be a dressing tool or bandage applicator, the applicator may apply the antiseptic or ointment (for example, to a wound, to skin, to an organ, etc.), and the dressing tool or bandage applicator may then spread or cover the applied substance. In an additional example, the first object may be a liquid dispenser (for example of liquid soap, cleanser, etc.), the second object may be a sponge, cloth, or brush, the liquid dispenser may dispense a cleaning liquid onto a subject, and the sponge, cloth, or brush may scrub or wipe the cleaning liquid. In another example, the first object may be a dispenser for a food substance, the second object may be a utensil (such as spreader, spoon, etc.), the dispenser may be used to apply the food substance (such as sauce or puree), and the utensil may be then used to distributes or shapes it.

In some examples, process 1000 may further comprise, for example after bringing the obtained objects to the one or more locations (of step 1010) and/or after navigating the robot to the specific location (of step 1012), generating an audible output including speech in a natural language informing that a preparation for the desired action is complete, for example as described above in relation to step 612 and/or using step 612. For example, the speech in the natural language may include ‘I'm ready to dress the wound’ or ‘Please come to the shower’. In some examples, the desire action may be an action on an individual, and process 1000 may further comprise generating an audible output including speech in a natural language calling the individual to a particular location accessible from the specific location, for example as described above in relation to step 612 and/or using step 612. For example, the speech in the natural language may include ‘Please sit here’ or ‘You need to lie, face down, on the bed’.

In some examples, the desire action may be an action on a subject (some non-limiting examples of such subject may include a person, an animal, a domesticate animal, a pet animal, or a farm animal), and process 1000 may further comprise: identifying a current location of the subject (such as a known location of the subject, a last known location of the subject, a visual detection of the subject in captured image data, or an audio source localization for sounds produced by the subject, etc.); navigating the robot to the current location (for example using a motion planning algorithm, using a navigation algorithm, or using process 200 as described above); and causing the robot to at least one of leading or carrying the subject from the current location to a particular location accessible from the specific location (for example as described above in relation to step 208 and/or using step 208 and/or using process 200). In one example, the robot may be caused to lead the subject from the current location to the particular location by moving ahead of the subject to the particular location, for example by leading the subject (for example, a pet animal) with a leash to the particular location, by taking the subject by the hand to the particular location, and so forth. In one example, the robot may be caused to carry the subject from the current location to the particular location by moving ahead of the subject to the particular location, for example by lifting the subject first and then carrying the subject.

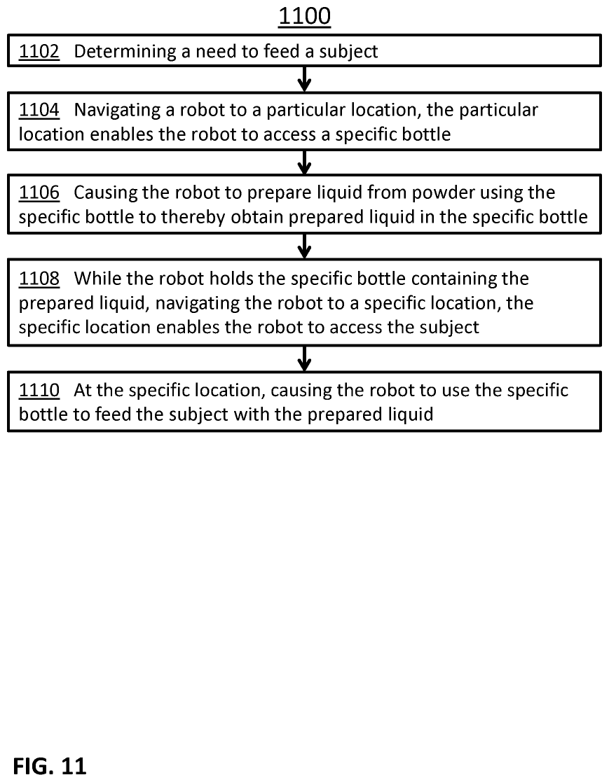

FIG. 11 is a flowchart of an exemplary process 1100 for robotic feeding of subjects, consistent with some embodiments of the present disclosure. In this example, process 1100 may comprise: determining a need to feed a subject (step 1102); navigating a robot to a particular location (step 1104), the particular location enables the robot to access a specific bottle; causing the robot to prepare liquid from powder using the specific bottle to thereby obtain a prepared liquid in the specific bottle (step 1106); while the robot holds the specific bottle containing the prepared liquid, navigating the robot to a specific location, the specific location enables the robot to access the subject (step 1108); and at the specific location, causing the robot to use the specific bottle to feed the subject with the prepared liquid (step 1110). In other examples, process 1100 may include additional steps or fewer steps. In other examples, one or more steps of process 1100 may be executed in a different order and/or one or more groups of steps may be executed simultaneously. In some examples, a system for robotic feeding of subjects may include at least one processing unit configured to perform process 1100. In one examples, the system may further comprise the robot of process 1100. For example, the robot may include the at least one processing unit. In another example, the at least one processing unit may be external to the robot of process 1100. A non-limiting example of such robot may be robot 100. In some examples, a method for robotic feeding of subjects may include performing process 1100. In some examples, a non-transitory computer readable medium may store computer implementable instructions that when executed by at least one processor may cause the at least one processor to perform operations for robotic feeding of subjects, and the operations may include the steps of process 1100. In one example, the subject may be an infant. In another example, the subject may be an animal. In yet another example, the subject may be a person requiring assistance with eating activities.

In some examples, step 1102 may comprise determining a need to feed a subject. It is to be understood that a trigger for feeding the subject is indicative of the need to feed the subject, and that a determined need to feed the subject may be a trigger for feeding the subject. For example, an indication of the need to feed the subject may be read from memory (for example, from a digital memory, from memory unit 162, etc.), may be received from an external computing device (for example, using a digital communication device, such as communication module 166), may be received from a different process, may be received from an individual (for example, from the subject, from an individual different from the subject, via a user interface, using a keyboard, using a pointing device, using a touch surface, using a microphone, using an audio sensor, via gesture, via voice command, via natural language input, etc.), via an analysis of data captured using at least one sensor, and so forth. In some examples, step 1102 may comprise: receiving information captured using at least one sensor (such as at least one sensor included in the robot, at least one sensor included in a different robot, at least one sensor not included in any robot, and so forth), for example using step 202 and/or step 410 and/or step 504 and/or 602; and analyzing the captured information to identify a behavior of the subject indicative of the need to feed the subject. For example, step 1102 may use a classification algorithm to analyze the captured information to classify it to a class corresponding to behavior indicative of a need for feeding or to a class corresponding to behavior not indicative of a need for feeding, thereby identifying the behavior of the subject indicative of the need to feed the subject. In another example, step 1102 may use an artificial neural network to analyze the captured information to identify the behavior of the subject indicative of the need to feed the subject. In yet another example, step 1102 may use a foundation model (for example, with a suitable prompt, such as ‘is this behavior indicative of a need for feeding?’) to analyze the captured information to identify the behavior of the subject indicative of the need to feed the subject. In an additional example, step 1102 may use a machine learning model to analyze the captured information to identify the behavior of the subject indicative of the need to feed the subject. The machine learning model may be a machine learning model trained using training examples to identify behaviors indicative of a need for feeding in captured data. An example of such training example may include sample captured information reflecting sample behavior, together with a label indicative of whether the sample behavior is indicative of a need for feeding. In one example, the subject may be an infant, the captured information may include captured audio information, the at least one sensor may include at least one audio sensor, and the behavior of the infant may include crying. In another example, the at least one sensor may be at least one audio sensor, and the behavior of the subject indicative of the need to feed the subject may include producing sounds indicative of the need to feed the subject (such as crying for an infant, speech indicative of hunger and/or wish for feeding, and so forth). In yet another example, the at least one sensor may be at least one image sensor, and the behavior of the subject indicative of the need to feed the subject includes making at least one of movements, gesture, or facial expression indicative of the need to feed the subject. Some non-limiting examples of such movements may include stirring, turning the head, opening the mouth, or sucking on hands or fingers. Some non-limiting examples of such gesture may include bringing hand or fist to mouth, sucking on fingers, turning the head while opening the mouth, smacking lips, licking lips, sucking lips, clenching hands, reaching for food, gestures specific to the subject, and so forth. Some non-limiting examples of such facial expression may include red face, “O” face, and so forth. In some examples, step 1102 may comprise: receiving a natural language input from an individual different from the subject (for example, via text, via a user interface, via audible speech, via a keyboard, via an audio sensor, via a speech recognition algorithm, etc.), for example as described above in relation to step 710 and/or using step 710; and analyzing the natural language input to determine the need to feed the subject. For example, the natural language input may include an instruction or request to feed the subject (such as, ‘please feed the puppy’), may include an indication of a hunger (such as, ‘I think the baby is hungry’), and so forth. In some examples, step 1102 may base the determination of the need to feed the subject on an elapsed time since the last feeding of the subject. For example, the same cues may be interpreted as hunger when the elapsed time is longer than a selected threshold, and may be interpreted differently (as non-hunger) when the elapsed time is shorter than the selected threshold. The threshold may be predefined, may be selected based on the subject, may be selected based on the cues, may be selected based on contextual information (such as location, time of day, other activities in the environment of the subject, etc.), and so forth. In some examples, step 1102 may base the determination of the need to feed the subject on based on a time of day. For example, the same cues may be interpreted as hunger during one portion of a day, and may be interpreted differently (as non-hunger) during another portion of the day. In some examples, step 1102 may base the determination of the need to feed the subject on based on an identity of the subject (for example, based on past behavior of the subject, based on records associated with the subject, based on an age of the subject, based on physical attributes of the subject, based on weight of the subject, based on height of the subject, and so forth). For example, the same cues may be interpreted as when the subject is one subject, and may be interpreted differently (as non-hunger) when the subject is a different subject.

In some examples, step 1104 may comprise navigating a robot to a particular location, for example using a motion planning algorithm, using a navigation algorithm, or using process 200 as described above, and so forth. The particular location may enable the robot to access a specific bottle. In one example, step 1104 may navigate the robot to the particular location in response to the need to feed the subject determined by step 1102. In some examples, step 1104 may further comprise selecting the particular location. In one example, step 1104 may select the particular location based on a model of the environment (such as a map, layout data, two dimensional model, three dimensional model, real-time model, offline model, static model, dynamically updated model, etc.), for example based on a task. For example, the task may include using a specific object (such as the specific bottle of step 1102), the model may indicate a position of the specific object, and step 1104 may select a particular location that enables the robot to reach the specific object. In one example, step 1104 may receive information captured using at least one sensor (such as at least one sensor included in the robot, at least one sensor included in a different robot, at least one sensor not included in any robot, etc.), for example using step 202. Further, step 1104 may analyze the captured information to select the particular location, for example using an artificial neural network, using a foundation model with a suitable prompt, using a trained machine learning model, using computer vision algorithms, and so forth. For example, the captured information may include image data depicting the specific bottle, step 1104 may analyze the captured image data using a visual object detection algorithm to determine a specific location of the specific bottle, and may select the particular location based on the specific location.

In some examples, step 1104 may further comprise: receiving information captured using at least one sensor (such as at least one sensor included in the robot, at least one sensor included in a different robot, at least one sensor not included in any robot, etc.), for example using step 202; analyzing the captured information to detect a plurality of bottles, for example using an artificial neural network, using a machine learning model trained using training examples to detect bottles in the captured information, using a foundation model with a suitable prompt, using a visual object detection algorithm, and so forth; for each bottle of the plurality of bottles, analyzing the captured information to determine at least one characteristic of the respective bottle, for example using an artificial neural network, using a machine learning model trained using training examples to determine characteristic of bottles from the captured information, using a foundation model with a suitable prompt, using a visual object classification algorithm, and so forth; and, based on the determined characteristics, selecting the specific bottle of the plurality of bottles, for example using an artificial neural network, using a machine learning model trained using training examples to select bottle of plurality of alternative bottles based on characteristic of the alternative bottles, using a foundation model with a suitable prompt, and so forth. In one example, for each bottle of the plurality of bottles, the at least one characteristic of the respective bottle may be a size of the respective bottle. In another example, for each bottle of the plurality of bottles, the at least one characteristic of the respective bottle may be an amount of a liquid contained in the respective bottle. In yet another example, for each bottle of the plurality of bottles, the at least one characteristic of the respective bottle may be a condition of the respective bottle. In an additional example, for each bottle of the plurality of bottles, the at least one characteristic of the respective bottle may be a temperature of a liquid contained in the respective bottle. In some examples, step 1104 may receive an indication of an intended use, and may select the specific bottle of a plurality of bottles based on the intended use. For example, the intended use may be feeding a specific subject, a required size and/or teat type for the bottle may be determined based on the specific subject (for example, based on an age of the specific subject, based on past behavior of the specific subject, etc.), and step 1104 may select the bottle of a plurality of bottles based on the required size and/or teat type.

In some examples, step 1106 may comprise causing a robot (such as the robot of step 1104, a different robot, etc.) to prepare liquid from powder using a specific bottle (such as the specific bottle accessible from the particular location of step 1104, a different specific bottle, etc.) to thereby obtain a prepared liquid in the specific bottle. For example, step 1106 may use process 1200 and/or step 1204 and/or step 1206 and/or step 1208 and/or step 1210 and/or step 1212 and/or step 1214 to cause the robot to prepare liquid from powder using a specific bottle to thereby obtain the prepared liquid in the specific bottle. In one example, step 1106 may cause the robot to prepare the liquid from the powder using the specific bottle after step 1104 navigates the robot to the particular location and/or in response to the need to feed the subject determined by step 1102.

In some examples, step 1108 may comprise navigating a robot (such as the robot of step 1104 and/or step 1106, the robot of step 1302, a different robot, and so forth) to a specific location, for example using a motion planning algorithm, using a navigation algorithm, or using process 200 as described above. In one example, the specific location may enable the robot to access a subject (such as the subject of step 1102, a different subject, and so forth). In another example, the specific location may enable the robot to access an infant. In one example, step 1108 may further comprise distinguishing the subject (or the infant) from at least one other subjects (such as other infants, other children, other people, etc.) in an environment of the robot (such as a residential environment, a daycare environment, a dormitory environment, etc.), for example by analyzing captured image data using face recognition algorithm, using an artificial neural network, using a foundation model with a suitable prompt, and so forth. In one example, step 1108 may navigate the robot to the specific location while the robot holds a specific bottle (such as the specific bottle accessible from the particular location of step 1104, the specific bottle used by step 1106, the specific bottle of step 1302, a different specific bottle, and so forth) containing prepared liquid (such as the liquid prepared by step 1106, a different prepared liquid, and so forth). In some examples, step 1108 may navigate the robot to the specific location after the robot obtained a specific bottle a specific bottle (such as the specific bottle accessible from the particular location of step 1104, the specific bottle used by step 1106, the specific bottle of step 1302, a specific bottle containing the liquid of step 1302, a specific bottle containing the prepared liquid of step 1106, a different specific bottle, and so forth) and/or while the robot holds the specific bottle. In some examples, the robot may obtain a specific bottle (such as the specific bottle accessible from the particular location of step 1104, the specific bottle used by step 1106, the specific bottle of step 1302, a specific bottle containing the liquid of step 1302, a specific bottle containing the prepared liquid of step 1106, a different specific bottle, and so forth) after the robot arrives at the specific location of step 1108.

In some examples, step 1110 may comprise, for example at the specific location of step 1108 and/or after step 1108 navigates the robot to the specific location, causing the robot to use a specific bottle (such as the specific bottle accessible from the particular location of step 1104, the specific bottle used by step 1106, the specific bottom held by the robot while step 1108 navigates the robot to the specific location, a different specific bottle, etc.) to feed a subject (such as the subject of step 1102 and/or step 1108, a different subject, etc.) with a prepared liquid (such as the prepared liquid of step 1106 and/or step 1108, different prepared liquid, and so forth). For example, the subject may be an infant, and step 1110 may use process 1300 and/or step 1306 and/or step 1308 and/or step 1310 and/or step 1312 and/or step 1314 and/or step 1316 to cause the robot to use the specific bottle to feed the infant with the prepared liquid. In another example, step 1110 may use process 1320 and/or step 1308 and/or step 1310 and/or step 1312 and/or step 1314 to cause the robot to use the specific bottle to feed the subject with the prepared liquid.

In some examples, the subject of process 1100 and/or process 1320 may be an infant, and process 1100 and/or process 1300 and/or process 1320 may further comprise generating particular digital signals configured to activate a particular group of actuators to cause a robot (such as the robot of process 1100 and/or process 1300 and/or robot of step 1320, a different robot, etc.) to position the infant in a selected position to burp the infant, for example as described above in relation to step 208 and/or using step 208. In some examples, the particular digital signals may be generated after completing the feeding of the infant (for example, after the completion of the feeding by the robot, after the completion of the feeding caused by step 1110, after the completion of the feeding monitored by step 1312, after the completion determined by step 1314, after a completion of a different feeding process of the infant, and so forth). In some examples, the activation of the particular group of actuators may be configured to cause the robot to position the infant over a shoulder of the robot to burp the infant. For example, with a chin of the infant resting on the shoulder, with a chest of the infant resting on the shoulder, with a belly of the infant resting on the shoulder, lying across the shoulder, and so forth. In some examples, the activation of the particular group of actuators may be configured to cause the robot to position the infant over a limb of the robot to burp the infant. For example, over a lap of the robot, over a leg of the robot, over a hand of the robot, sitting on the limb, lying across the limb, and so forth. In some examples, information captured using at least one sensor (such as at least one sensor included in the robot, at least one sensor included in a different robot, at least one sensor not included in any robot, etc.) while using the specific bottle to feed the infant may be received (for example using step 202 and/or step 410 and/or step 504 and/or 602), and the captured information may be analyzed to select a timing for the generation of the particular digital signals, for example using a classification algorithm configured to classify the captured information to a class indicating the selected timing is now or to a class indicating that the selected timing was not yet reached, using a regression model configured to determine a prospective selected timing based on the captured data, using an artificial neural network, using a machine learning model trained using training examples to determine the selected time from the captured information, using a foundation model with a suitable prompt, and so forth. In some examples, information captured using at least one sensor (such as at least one sensor included in the robot, at least one sensor included in a different robot, at least one sensor not included in any robot, etc.) while the infant in the selected position for burping the infant may be received (for example using step 202 and/or step 410 and/or step 504 and/or 602), and the captured information may be analyzed to trigger the robot to reposition the infant in a particular position to burp the infant. The particular position may differ from the specific position. For example, the triggering the robot to reposition the infant may include generating specific digital signals configured to activate a specific group of actuators to cause the robot to reposition the infant in the particular position to burp the infant, for example as described above in relation to step 208 and/or using step 208. In one example, the analysis for triggering the robot to reposition the infant may comprise using a classification algorithm configured to classify the captured information to a class corresponding to the trigger for repositioning or to a class corresponding to no such trigger, using an artificial neural network, using a machine learning model trained using training examples to determine triggers for repositioning from the captured information, using a foundation model with a suitable prompt, and so forth. In some examples, the particular digital signals may be generated and/or the infant may be positioned to burp the infant before the feeding of the infant is completed (for example, before the completion of the feeding by the robot, before the completion of the feeding caused by step 1110, before the completion of the feeding monitored by step 1312, before the completion determined by step 1314, before a completion of a different feeding process of the infant, and so forth), for example during a break from the feeding. For example, information captured using at least one sensor (such as at least one sensor included in the robot, at least one sensor included in a different robot, at least one sensor not included in any robot, etc.) while the infant in the selected position for burping the infant may be received (for example using step 202 and/or step 410 and/or step 504 and/or 602), and the captured information may be analyzed to select a timing for stopping the burping of the infant and resuming the feeding of the subject with the prepared liquid using the specific bottle, for example using a classification algorithm configured to classify the captured information to a class indicating the selected timing is now or to a class indicating that the selected timing was not yet reached, using a regression model configured to determine a prospective selected timing based on the captured data, using an artificial neural network, using a machine learning model trained using training examples to determine the selected time from the captured information, using a foundation model with a suitable prompt, and so forth.

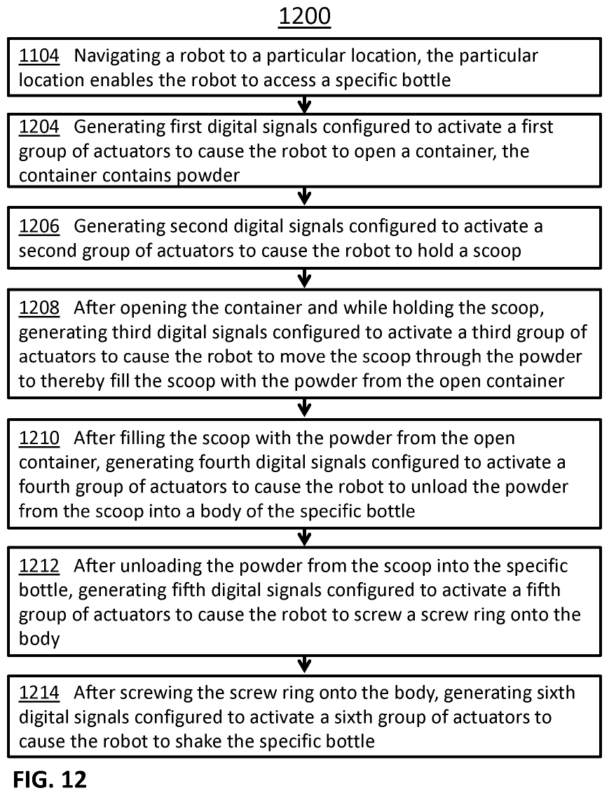

FIG. 12 is a flowchart of an exemplary process 1200 for robotic preparation of liquids, consistent with some embodiments of the present disclosure. In this example, process 1200 may comprise: navigating a robot to a particular location (step 1104), the particular location enables the robot to access a specific bottle; generating first digital signals configured to activate a first group of actuators to cause the robot to open a container, the container contains powder (step 1204); generating second digital signals configured to activate a second group of actuators to cause the robot to hold a scoop (step 1206); after the robot opens the container and while the robot holds the scoop, generating third digital signals configured to activate a third group of actuators to cause the robot to move the scoop through the powder to thereby fill the scoop with the powder from the open container (step 1208); after the robot fills the scoop with the powder from the open container, generating fourth digital signals configured to activate a fourth group of actuators to cause the robot to unload the powder from the scoop into a body of the specific bottle (step 1210); after the robot unloads the powder from the scoop into the specific bottle, generating fifth digital signals configured to activate a fifth group of actuators to cause the robot to screw a screw ring onto the body (step 1212); and after the robot screws the screw ring onto the body, generating sixth digital signals configured to activate a sixth group of actuators to cause the robot to shake the specific bottle. In other examples, process 1200 may include additional steps or fewer steps. In other examples, one or more steps of process 1200 may be executed in a different order and/or one or more groups of steps may be executed simultaneously. In some examples, a system for robotic preparation of liquids may include at least one processing unit configured to perform process 1200. In one examples, the system may further comprise the robot of process 1200. For example, the robot may include the at least one processing unit. In another example, the at least one processing unit may be external to the robot of process 1200. A non-limiting example of such robot may be robot 100. In some examples, a method for robotic preparation of liquids may include performing process 1200. In some examples, a non-transitory computer readable medium may store computer implementable instructions that when executed by at least one processor may cause the at least one processor to perform operations for robotic preparation of liquids, and the operations may include the steps of process 1200. In some examples, any two or more groups of the first, second, third, fourth, fifth and sixth groups of actuators may be the same group of actuators, may be different groups of actuators, may have no actuator in common, may have at least one but not all actuators in common, and so forth. For example, the second group of actuators, the third group of actuators and the fourth group of actuators may be the same group of actuators.

In some examples, step 1204 may comprise generating first digital signals configured to activate a first group of actuators to cause a robot (such as the robot of step 1104, a different robot, etc.) to open a container, for example as described above in relation to step 208 and/or using step 208. In one example, the container may contain powder. In another example, the container may contain no powder. For example, the powder may be an infant formula powder, a food powder, a milk powder, a cocoa powder, a medical nutrition powder, a premix powder, and so forth. In yet another example, the container may be empty. In one example, the first group of actuators may cause an arm of the robot to remove a lid from the container. In some examples, step 1206 may comprise generating second digital signals configured to activate a second group of actuators to cause a robot (such as the robot of step 1104 and/or step 1204, a different robot, etc.) to hold a scoop, for example as described above in relation to step 208 and/or using step 208. In some examples, step 1208 may comprise, for example after step 1204 generates the first digital signals and/or after step 1206 generates the second digital signals and/or after the robot opens the container and/or while the robot holds the scoop, generating third digital signals configured to activate a third group of actuators to cause a robot (such as the robot of step 1104 and/or step 1204 and/or step 1206, a different robot, etc.) to move a scoop (such as the scoop of step 1206, a different scoop, etc.) through powder (such as the powder of step 1204, powder in the open container of step 1204, powder in a different container, powder in no container, etc.) to thereby fill the scoop with the powder (for example, from the open container of step 1204, from a different container, from no container, etc.), for example as described above in relation to step 208 and/or using step 208. In some examples, step 1210 may comprise, for example after step 1208 generated the third digital signals and/or after the robot fills the scoop with the powder, generating fourth digital signals configured to activate a fourth group of actuators to cause a robot (such as the robot of step 1104 and/or step 1204 and/or step 1206 and/or step 1208, a different robot, etc.) to unload powder (such as the powder of step 1204 and/or step 1208, powder in the scoop of step 1206 and/or step 1208, powder in a different scoop, different powder, etc.) from a scoop (such as the scoop of step 1206 and/or step 1208, a different scoop, etc.) into a body of a specific bottle (such as the specific bottle of step 1104, a different specific bottle, etc.), for example as described above in relation to step 208 and/or using step 208. For example, unloading the powder may comprise positioning the scoop (or a selected portion of the scoop) above an opening of the body of the specific bottle and tilting the scoop. In some examples, step 1212 may comprise, for example after step 1210 generates the fourth digital signals and/or after the robot unloads the powder from the scoop into the specific bottle, generating fifth digital signals configured to activate a fifth group of actuators to cause a robot (such as the robot of step 1104 and/or step 1204 and/or step 1206 and/or step 1208 and/or step 1210, a different robot, etc.) to screw a screw ring onto a body of a specific bottle (such as the body of step 1210, a body of the specific bottle of step 1104 and/or step 1210, a body of a different specific bottle, etc.), for example as described above in relation to step 208 and/or using step 208. In one non-limiting example, screwing the screw ring onto the body may connect a teat to the body. In some examples, step 1214 may comprise, for example after step 1212 generates the fifth digital signals and/or after the robot screws the screw ring onto the body, generating sixth digital signals configured to activate a sixth group of actuators to cause a robot (such as the robot of step 1104 and/or step 1204 and/or step 1206 and/or step 1208 and/or step 1210 and/or step 1212, a different robot, etc.) to shake a specific bottle (such as the specific bottle of step 1104 and/or step 1210 and/or step 1212, a different specific bottle, etc.), for example as described above in relation to step 208 and/or using step 208. In one example, the sixth digital signals generated by step 1214 may cause the robot to continue shaking the specific bottle until the powder properly dissolves in water contained in the specific bottle (for example, until the powder and the water becomes a homogeneous liquid). In one example, the shaking of the specific bottle may include swirling the specific bottle, may include stirring the specific bottle, may include rolling the specific bottle, may include turning and/or inverting the specific bottle, may include vigorous back-and-forth movement of the specific bottle, and so forth.

In some examples, the second digital signals generated by step 1206 may be configured to activate the second group of actuators of step 1206 to cause an arm of a robot (such as the robot of step 1104 and/or step 1204, a different robot, etc.) to hold a scoop, the third digital signals generated by step 1208 may be configured to activate the third group of actuators of step 1208 to cause the arm to move the scoop through powder (such as the powder of step 1204, powder in the open container of step 1204, powder in a different container, powder in no container, etc.) to thereby fill the scoop with the powder (for example, from the open container of step 1204, from a different container, from no container, etc.), and the fourth digital signals generated by step 1210 may be configured to activate the fourth group of actuators of step 1210 to cause the arm to unload the powder from the scoop into a body of a specific bottle (such as the specific bottle of step 1104, a different specific bottle, and so forth).

In some examples, process 1200 may further comprise, for example after step 1208 generates the third digital signals and/or after step 1210 generates the fourth digital signals and/or after step 1212 generates the fifth digital signals and/or after step 1214 generates the sixth digital signals and/or after the robot fills the scoop with the powder and/or after the robot unloads the powder from the scoop into the specific bottle and/or after the robot screws the screw ring onto the body, generating particular digital signals configured to activate a particular group of actuators to cause a robot (such as the robot of step 1104 and/or step 1204 and/or step 1206 and/or step 1208 and/or step 1210 and/or step 1212 and/or step 1214, a different robot, etc.) to close a container (such as the container opened by step 1204, the container of step 1208, a different open container, etc.), for example as described above in relation to step 208 and/or using step 208. For example, the particular group of actuators may cause an arm of the robot to pick a lid of the container and/or to use the lid to close the container. In some examples, process 1200 may further comprise, for example after the robot unloads the powder from the scoop into the specific bottle and/or after step 1210 generates the fourth digital signals and/or before the robot closes the container and/or before the generation of the particular digital signals, generating specific digital signals configured to activate a specific group of actuators to cause the robot to place the scoop in the container (for example, over the powder, at a specialized comportment for the scoop, and so forth). In some examples, any two or more groups of the first, second, third, fourth, fifth, sixth, particular or specific groups of actuators may be the same group of actuators, may be different groups of actuators, may have no actuator in common, may have at least one but not all actuators in common, and so forth.

In some examples, process 1200 may further comprise, for example after step 1208 generates the third digital signals and/or after the robot fills the scoop with the powder from the open container and/or before step 1210 generates the fourth digital signals and/or before the robot unloads the powder from the scoop into the specific bottle, generating particular digital signals configured to activate a particular group of actuators to cause the robot to remove excess powder and level the powder in the scoop, for example as described above in relation to step 208 and/or using step 208. For example, the particular group of actuators may cause an arm of the robot to pick a flat object (such as a knife, a specialized leveler, a leveler associated with the container of step 1204 and/or step 1208, etc.) and/or to use the flat object to wipe off excess powder (for example, back into the container of step 1204 and/or step 1208, into a different container, to a garbage collection device, to a sink, etc.), for example by dragging a flat edge of the flat object across the top of the scoop. In another example, the container of step 1204 and/or step 1208 may include a built-in ledge inside, and the particular group of actuators may cause an arm of the robot to move the scoop from inside the container out, touching an edge of the built-in ledge to utilize the built-in ledge to scrape off excess powder. In some examples, process 1200 may further comprise, for example before removing the excess powder and leveling the powder and/or before generating the particular digital signals and/or after step 1208 generates the third digital signals and/or after the robot fills the scoop with the powder from the open container, generating specific digital signals configured to activate a specific group of actuators to cause the robot to tap a side of the scoop to remove air bubbles, for example as described above in relation to step 208 and/or using step 208. For example, the robot may hold the scoop of the robot with one arm while tapping the side of the scoop using another arm of the robot, may tap the side of the scoop using a different object (for example, by moving the scoop and/or by moving the different object), and so forth. In some examples, any two or more groups of the first, second, third, fourth, fifth, sixth, particular or specific groups of actuators may be the same group of actuators, may be different groups of actuators, may have no actuator in common, may have at least one but not all actuators in common, and so forth.

In some examples, for example after step 1104 navigates the robot and/or before step 1210 generates the fourth digital signals and/or before the robot unloads the powder from the scoop into the body of the specific bottle: generating seventh digital signals configured to activate a seventh group of actuators to cause a first arm of the robot to hold the body of the specific bottle, for example as described above in relation to step 208 and/or using step 208; generating eighth digital signals configured to activate an eighth group of actuators to cause a second arm of the robot to hold the screw ring of the specific bottle, for example as described above in relation to step 208 and/or using step 208; and, while the first arm holds the body and the second arm holds the screw ring, generating ninth digital signals configured to activate a ninth group of actuators to cause the robot to unscrew and detach the screw ring from the body, for example as described above in relation to step 208 and/or using step 208. In one example, the specific bottle may contain liquid prior to the unscrewing and detaching of the screw ring from the body. For example, the liquid may be water. In another example, the liquid may be juice, may be liquid prepared from water, and so forth. In some examples, any two or more groups of the first, second, third, fourth, fifth, sixth, seventh, eighth or ninth groups of actuators may be the same group of actuators, may be different groups of actuators, may have no actuator in common, may have at least one but not all actuators in common, and so forth. For example, the second group of actuators, the third group of actuators and the fourth group of actuators may be the same group of actuators. For example, the ninth group of actuators may include at least one actuator of the seventh group of actuators and/or at least one actuator of the eighth group of actuators.

In some examples, process 1200 may further comprise generating particular digital signals configured to activate a particular group of actuators to cause a particular arm of the robot to hold a second container that contains liquid, for example as described above in relation to step 208 and/or using step 208. In one example, process 1200 may further comprise, for example while the particular arm holds the second container and/or before the robot screws the screw ring onto the body and/or before step 1212 generates the fifth digital signals, generating specific digital signals configured to activate a specific group of actuators to cause the particular arm to pour liquid from the second container to a specific bottle (such as the specific bottle of step 1104 and/or step 1210 and/or step 1212 and/or step 1214, a different specific bottle, etc.), for example as described above in relation to step 208 and/or using step 208. In one example, the liquid may be water. In another example, the liquid may be juice, may be liquid prepared from water, and so forth. In some examples, any two or more groups of the first, second, third, fourth, fifth, sixth, particular or specific groups of actuators may be the same group of actuators, may be different groups of actuators, may have no actuator in common, may have at least one but not all actuators in common, and so forth. For example, the particular group of actuators and the specific group of actuators may be the same. In some examples, the activation of the specific group of actuators may be configured to cause the particular arm to pour a selected amount of the liquid from the container to the specific bottle. For example, the amount of the liquid may be selected based on an intended use, based on a subject associated with the intended use, based on a type of powder, using a rule, and so forth.

In some examples, process 1200 may further comprise causing the robot to repeat filling and unloading until a target quantity of powder is unloaded into the body of the specific bottle, for example by repeating step 1208 and/or step 1210. In one example, the target quantity may be determined based on an intended use, based on a subject associated with the intended use, based on a type of powder, based on a recipe, using a rule, and so forth. In some examples, process 1200 may further comprise causing the robot to heat a content of the specific bottle (such as the unloaded powder, water, other liquids, etc.) to a target temperature. For example, the robot may operate a device configured to heat the content of the specific bottle. In one example, the target temperature may be determined based on an intended use, based on a subject associated with the intended use, based on a type of powder, based on a recipe, using a rule, and so forth.

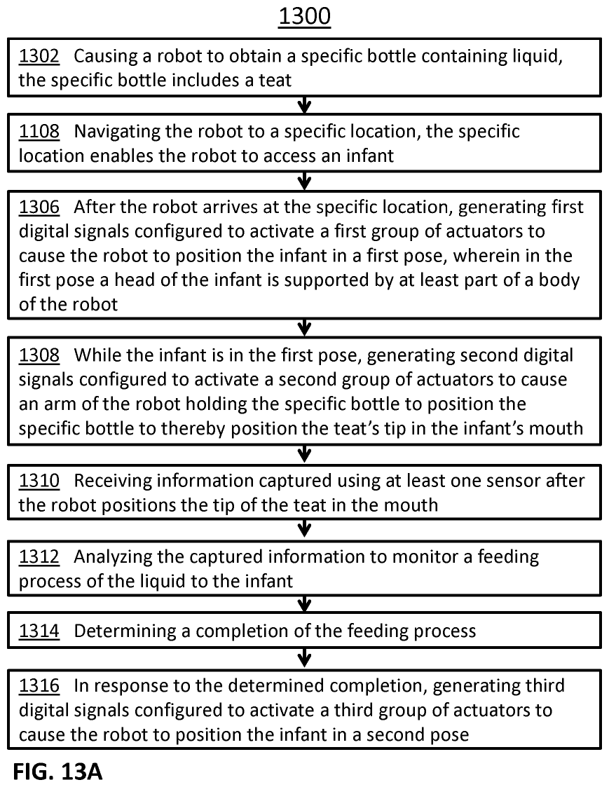

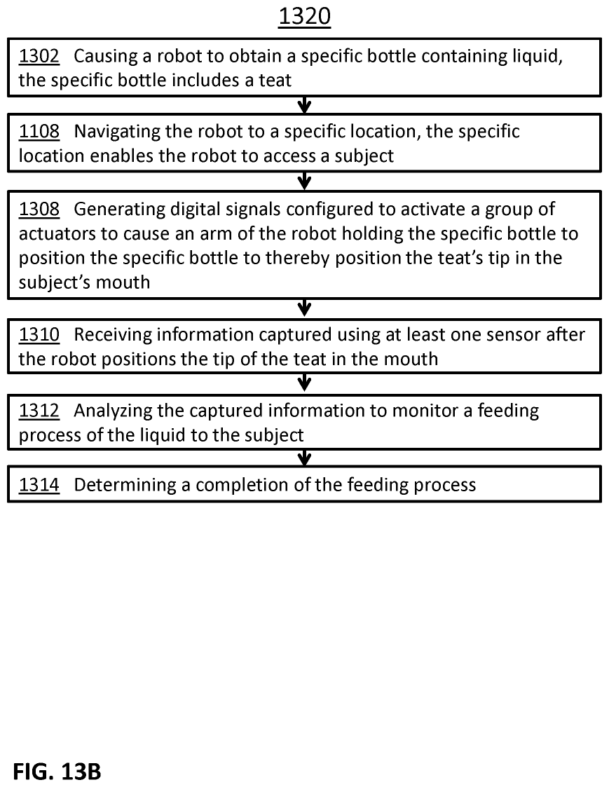

FIG. 13A is a flowchart of an exemplary process 1300 for robotic feeding of infants, consistent with some embodiments of the present disclosure. In this example, process 1300 may comprise: causing a robot to obtain a specific bottle containing liquid (step 1302), the specific bottle includes a teat; navigating the robot to a specific location, the specific location enables the robot to access an infant (step 1108); after the robot arrives at the specific location, generating first digital signals configured to activate a first group of actuators to cause the robot to position the infant in a first pose, wherein in the first pose a head of the infant is supported by at least part of a body of the robot (step 1306); while the infant is in the first pose, generating second digital signals configured to activate a second group of actuators to cause an arm of the robot holding the specific bottle to position the specific bottle to thereby position a tip of the teat in a mouth of the infant (step 1308); receiving information captured using at least one sensor after the robot positions the tip of the teat in the mouth (step 1310); analyzing the captured information to monitor a feeding process of the liquid to the infant (step 1312); determining a completion of the feeding process (step 1314); and, in response to the determined completion, generating third digital signals configured to activate a third group of actuators to cause the robot to position the infant in a second pose (step 1316). In other examples, process 1300 may include additional steps or fewer steps. In other examples, one or more steps of process 1300 may be executed in a different order and/or one or more groups of steps may be executed simultaneously. In some examples, a system for robotic feeding of infants may include at least one processing unit configured to perform process 1300. In one examples, the system may further comprise the robot of process 1300. For example, the robot may include the at least one processing unit. In another example, the at least one processing unit may be external to the robot of process 1300. A non-limiting example of such robot may be robot 100. In some examples, a method for robotic feeding of infants may include performing process 1300. In some examples, a non-transitory computer readable medium may store computer implementable instructions that when executed by at least one processor may cause the at least one processor to perform operations for robotic feeding of infants, and the operations may include the steps of process 1300. In some examples, any two or more groups of the first, second and third groups of actuators may be the same group of actuators, may be different groups of actuators, may have no actuator in common, may have at least one but not all actuators in common, and so forth.

FIG. 13B is a flowchart of an exemplary process 1320 for robotic feeding of subjects, consistent with some embodiments of the present disclosure. In this example, process 1300 may comprise: causing a robot to obtain a specific bottle containing liquid (step 1302), the specific bottle includes a teat; navigating the robot to a specific location, the specific location enables the robot to access a subject (step 1108); generating digital signals configured to activate a group of actuators to cause an arm of the robot holding the specific bottle to position the specific bottle to thereby position a tip of the teat in a mouth of the subject (step 1308); receiving information captured using at least one sensor after the robot positions the tip of the teat in the mouth (step 1310); analyzing the captured information to monitor a feeding process of the liquid to the subject (step 1312); and determining a completion of the feeding process (step 1314). In other examples, process 1320 may include additional steps or fewer steps. In other examples, one or more steps of process 1320 may be executed in a different order and/or one or more groups of steps may be executed simultaneously. In some examples, a system for robotic feeding of subjects may include at least one processing unit configured to perform process 1320. In one examples, the system may further comprise the robot of process 1320. For example, the robot may include the at least one processing unit. In another example, the at least one processing unit may be external to the robot of process 1320. A non-limiting example of such robot may be robot 100. In some examples, a method for robotic feeding of subjects may include performing process 1320. In some examples, a non-transitory computer readable medium may store computer implementable instructions that when executed by at least one processor may cause the at least one processor to perform operations for robotic feeding of subjects, and the operations may include the steps of process 1320.

In some examples, step 1302 may comprise causing a robot to obtain a specific bottle containing liquid. The specific bottle may include a teat. For example, step 1302 may generate specific digital signals configured to activate a specific group of actuators to cause an arm of the robot to hold the specific bottle, for example as described above in relation to step 208 and/or using step 208. In another example, step 1302 may use step 1104 and/or step 1106 to obtain the specific bottle. In yet another example, step 1302 may use process 1200 and/or one or more steps of the steps of process 1200 to obtain the specific bottle. In one example, the specific bottle of step 1302 may be the specific bottle of process 1100 and/or process 1200, and the liquid of step 1302 may be the prepared liquid of process 1100 and/or process 1200.

In some examples, step 1306 may comprise, for example after a robot (such as the robot of step 1302 and/or step 1108, a different robot, etc.) arrives at a specific location (such as the specific location of step 1108, a different specific location, etc.), generating first digital signals configured to activate a first group of actuators to cause the robot to position an infant (such as the infant of step 1108, a different infant, etc.) in a first pose, for example as described above in relation to step 208 and/or using step 208. In one example, in the first pose a head of the infant may be supported by at least part of a body of the robot. In one example, the first pose may be a semi-upright pose. In another example, in the first pose the head of the infant may be supported by the at least part of the body of the robot through a direct contact between the at least part of the body of the robot and the head of the infant. In yet another example, in the first pose the head of the infant may be supported by the at least part of the body of the robot through an indirect contact. For example, the at least part of the body of the robot may support an object, and the object may support the head of the infant through a direct contact between the object and the head of the infant. In another example, the at least part of the body of the robot may support an object of a pile of objects, and the pile of objects may support the head of the infant through a direct contact between another object of the pile of objects and the head of the infant, and so forth.

In some examples, step 1308 may comprise generating second digital signals configured to activate a second group of actuators to cause an arm of the robot holding a specific bottle (such as the specific bottle of step 1302, the specific bottle of process 1100 and/or process 1200, a different specific bottle, etc.) to position the specific bottle to thereby position a tip of the teat in a mouth of a subject (such as the subject of step 1108, the infant of step 1108 and/or step 1306, a different infant, a different subject, etc.), for example as described above in relation to step 208 and/or using step 208. For example, the subject may be an infant (such as the infant of step 1108 and/or step 1306, a different infant, etc.), and step 1308 may generate the second digital signals while the infant of is in a first pose (such as the first pose of step 1306, a different selected pose, and so forth). In some examples, step 1310 may comprise, for example after step 1308 generates the second digital signals and/or after the robot positions the tip of the teat in the mouth, receiving information captured using at least one sensor (such as at least one sensor included in the robot, at least one sensor included in a different robot, at least one sensor not included in any robot, etc.), for example using step 202 and/or step 410 and/or step 504 and/or 602.

In some examples, step 1312 may comprise analyzing captured information (such as the captured information received by step 1310, different captured information, etc.) to monitor a feeding process of a liquid (such as the liquid of step 1302, the prepare liquid of process 1100 and/or process 1200, a different prepared liquid, a liquid contained in the specific bottle of step 1302, a liquid contained in a different bottle, a different liquid, etc.) to a subject (such as the subject of step 1108 and/or step 1308, the infant of step 1108 and/or step 1306 and/or step 1308, a different infant, a different subject, etc.), for example using an artificial neural network, using a trained machine learning model, using a foundation model with a suitable prompt, using computer vision algorithms, using one or more rules, and so forth. In some examples, the monitoring the feeding process of the liquid to the subject by step 1312 may comprise analyzing the captured information to adjust at least an angle of the specific bottle during the feeding process. For example, the angle of the specific bottle may be adjusted as the amount of liquid in the specific bottle reduces to ensure that a select portion of the specific bottle (such as the teat, the tip of the teat, etc.) is covered by liquid. In another example, the angle of the specific bottle may be adjusted as the subject changes a position of the subject's mouth. For example, the captured information may include captured image data, and the image data may be analyzed to determine an adjustment to the angle of the specific bottle to satisfy a requirement (such as a requirement that a select portion of the specific bottle is covered by liquid, a requirement on a relative orientation between the specific bottle and the subject's face, etc.), for example using a regression model configured to determine a desired angle for the specific bottle based on the captured image data, using an artificial neural network, using a machine learning model trained using training examples to determine a desired angle for the specific bottle based on visual data, using a foundation model with a suitable prompt, and so forth. In some examples, the monitoring the feeding process of the liquid to the subject by step 1312 may comprise analyzing the captured information to determine a need for a burp intermission. For example, step 1312 may analyze the captured information to identify a behavior of the subject indicative of the need for a burp intermission. Some non-limiting examples of such behavior may include squirming, wriggling, pulling away from the specific bottle while still acting hungry, clenching fists, arching the back, pulling the subject's legs up toward the subject's tummy, frustrated crying, making strained facial expressions, slowing sucking, gulping, coughing, and so forth. In one example, the captured information may include captured image data, and step 1312 may analyze the captured image data to identify the behavior of the subject indicative of the need for a burp intermission, for example using a visual action recognition algorithm, using an artificial neural network, using a machine learning model trained using training examples to identify behavior from visual data, using a foundation model with a suitable prompt, and so forth. In another example, the captured information may include captured audio data, and step 1312 may analyze the captured image data to identify the sounds produced by the subject indicative of the need for a burp intermission (such as crying sounds, sounds specific to the subject, etc.), for example using an artificial neural network, using a machine learning model trained using training examples to identify specific sounds from audio data, using a foundation model with a suitable prompt, and so forth.

In some examples, step 1312 may further comprise, for example during the feeding process and/or after step 1308 generates the second digital signals and/or after the robot positions the tip of the teat in the mouth and/or before step 1314 determines the completion of the feeding process, causing a robot (such as the robot of step 1302 and/or step 1108 and/or step 1306, a different robot, etc.) to initiate a burp intermission. For example, the robot may reposition the subject to a burping pose (for example, upright over the shoulder of the robot, sitting over a lap of the robot while the robot supports the chin of the subject, lying across a lap of the robot, and so forth), for example as described above in relation to step 208 and/or using step 208. Further, when the burp intermission is over, the robot may reposition the subject using step 1306 and/or as described above in relation to step 1306. In one example, the subject may be monitored during the burp intermission and/or while in the burping pose to determine when to end the burp intermission (for example, when the subject burps, when the subject falls asleep, and so forth). In another example, the duration of the burp intermission or a maximal duration for the burp intermission may be predetermined (for example, based on instructions, based on the subject, based on the amount of liquid consumed, based on a type of liquid, and so forth).

In some examples, for example additionally or alternatively to step 1312, process 1300 and/or process 1320 may further comprise: analyzing captured information (such as the captured information received by step 1310, different captured information, etc.) to detect at least one additional entity in an environment of the robot (for example, using a visual detection algorithm, using a beacon triangulation algorithm to determine a position of a beacon attached or associated with the at least one additional entity, etc.); and initiating an action of the robot for preventing interference to the feeding process by the at least one additional entity. For example, the at least one additional entity may be at least one of a grown-up person, a child, a pet animal, or a different robot. In one example, the action for preventing the interference may include producing an audible speech directed at the at least one additional entity (such as an instruction, a request, an indication of the subject, an indication of the feeding process, etc.) to change a behavior of the at least one additional entity. Some non-limiting examples of such audible speech directed at the at least one additional entity may include ‘please keep quiet’, ‘go to your room’, ‘sit’ (for example, to a pet animal), ‘shhh, he is eating’, and so forth. In another example, the at least one additional entity may be a different robot, and the action for preventing the interference may include transmitting a digital signal to change a behavior of the different robot (for example, a digital signal informing the other robot of the feeding process, informing the other robot of the need to avoid interference, instructing the other robot to change the behavior, and so forth). In yet another example, the action for preventing the interference may include changing a position of at least one of the subject or the specific bottle (for example, to avoid collision with the at least one additional entity, to keep the at least one additional entity out of a line of sight of the subject, and so forth). In an additional example, the action for preventing the interference includes positioning at least part of the robot (such as an arm, a leg, etc.) between the at least one additional entity and the subject. In one example, process 1300 and/or process 1320 may further comprise: analyzing the captured information to determine a trajectory of the at least one additional entity (for example, with a visual tracking algorithm, using a Kalman filter, etc.); and basing the action for preventing the interference on the determined trajectory. In one example, an extrapolation of the trajectory may indicate a prospective location of the at least one additional entity, a prospective interference to the feeding process may be determined based on the prospective location (for example, when the prospective location is in a current line of sight of the subject, when the prospective location is too close to the subject, etc.), the initiating the action of the robot for preventing interference to the feeding process by the at least one additional entity may be triggered in response to prospective interference. In another example, an extrapolation of the trajectory may indicate a prospective location of the at least one additional entity, and the action may be based on the prospective location (for example, a change to a location or an orientation of the subject may be based on the prospective location, and/or a part of robot may be positioned between the subject and the prospective location).

In some examples, step 1314 may comprise determining a completion of a feeding process (such as the feeding process of process 1312, a feeding process of liquid to a subject, a different feeding process, and so forth). In one example, step 1314 may obtain an indication of the completion of the feeding process. For example, step 1314 may read the indication from memory (for example, from a digital memory, from memory unit 162, etc.), may receive the indication from an external computing device (for example, using a digital communication device, such as communication module 166), may receive the indication from an individual (for example, via a user interface, using a keyboard, using a pointing device, using a touch surface, using a microphone, using an audio sensor, via gesture, via voice command, via natural language input, etc.), and so forth. In some examples, step 1314 may analyze captured information (such as the captured information received by step 1310, the captured information analyzed by step 1312, different captured information, etc.) to the completion of the feeding process, for example using a classification algorithm configured to classify the captured information to a class indicating a completion of a feeding process or to a class indicating that the feeding process was not yet completed, using a regression model configured to determine a prospective completion timing based on the captured data, using an artificial neural network, using a machine learning model trained using training examples to determine completion of the feeding process from the captured information, using a foundation model with a suitable prompt, and so forth. In some examples, step 1314 may base the determination of the completion of the feeding process on an amount of liquid left in the specific bottle. For example, based on a requirement that the subject of the feeding process will consume at least a selected amount of liquid during the feeding process (for example, requirement specific to the subject, requirement based on an age of the subject, requirement based on a weight of the subject, requirement based on a height of the subject, requirement based on past behavior of the subject, etc.), and based on an initial amount of liquid in the specific bottle before the feeding process begins, an upper limit for the amount of liquid left in the specific bottle may be selected as a condition for the completion of the feeding process. In another example, step 1314 may track the amount of liquid left in the specific bottle over time, and when the left amount does not change for a selected time duration (or when the change in the left amount during a selected time duration is bellow a selected threshold), step 1314 may determine the completion of the feeding process. In one example, the captured information may include captured image data, and step 1314 may analyze the captured image data to determine the amount of liquid left in the specific bottle, for example using a visual regression model configured to determine an amount of liquid based on visual data, using an artificial neural network, using a machine learning model trained using training examples to determine an amount of liquid from the visual data, using a foundation model with a suitable prompt, and so forth. In another example, the captured information may include weight data captured using a weight sensor, and step 1314 may determine the amount of liquid left in the specific bottle based on the weight data. In some examples, step 1314 may base the determination of the completion of the feeding process on a behavior of the subject (for example, the infant). For example, the subject may be an infant, and a behavior indicative of a completion of the feeding process may include at least one of unlatching from the teat, falling asleep, being drowsy, turning the face of the infant away, slowing or stopping suction, pushing the specific bottle away, relaxation of the body of the infant, opening of a hand of the infant (in contrast to a fisted hand common during feeding), being silence or quiet, or producing vocalization specific to the infant that indicates a completion of the feeding process. In one example, the captured information may include captured image data, and step 1314 may analyze the captured image data to identify the behavior of the subject indicative of a completion of the feeding process, for example using a visual action recognition algorithm, using an artificial neural network, using a machine learning model trained using training examples to identify behavior from visual data, using a foundation model with a suitable prompt, and so forth. In another example, the captured information may include captured audio data, and step 1314 may analyze the captured image data to identify the sounds produced by the subject indicative of a completion of the feeding process, for example using an artificial neural network, using a machine learning model trained using training examples to identify specific sounds from audio data, using a foundation model with a suitable prompt, and so forth. In some examples, step 1314 may base the determination of the completion of the feeding process on an elapsed time. For example, the elapsed time may be an elapsed time since the feeding process began, may be an elapsed time since the last liquid intake of the subject (or the last intake of an amount of liquid that is above a selected threshold), and so forth.

In some examples, step 1316 may comprise, for example in response to a determined completion of a feeding process (such as the completion of the feeding process determined by step 1314, a different completion of a different feeding process, etc.), generating third digital signals configured to activate a third group of actuators to cause a robot (such as the robot of step 1302 and/or step 1108 and/or step 1306, a different robot, etc.) to position an infant (such as the infant of step 1108 and/or step 1306 and/or step 1308, a different infant, etc.) in a second pose and/or to cause the robot to remove the tip of the teat (of step 1308) from the mouth (of step 1308), for example as described above in relation to step 208 and/or using step 208. In one example, the second pose may be a burping pose (such as upright over the shoulder of the robot, sitting over a lap of the robot while the robot supports the chin of the infant, lying across a lap of the robot, and so forth). In another example, the second pose may be an upright pose.

In some examples, when the robot obtains a specific bottle (such as the specific bottle of step 1302 and/or step 1308, the specific bottle of process 1100 and/or process 1200, a different specific bottle, etc.), the teat of the specific bottle may be covered with a cap. In one example, process 1300 and/or process 1320 may further comprise, for example before step 1308 generates the second digital signals and/or before the arm of the robot positions the tip of the teat in the mouth and/or after the robot obtains the specific bottle, generating particular digital signals configured to activate a particular group of actuators to cause the robot to remove the cap from at least part of the specific bottle and/or to expose at least part of the teat. For example, the robot may hold the specific bottle with one arm, and may apply force on the cap with another arm (for example, by pushing the cap away from the specific bottle, by grabbing the cap and polling it away from the specific bottle, etc.) to remove the cap.

Systems, robots, methods, and non-transitory computer readable media for visual robotic configuration are provided. In some examples, image data may be received. For example, the image data may be read from a digital memory, may be received from an external computing device (for example, using a digital communication device), may be captured using at least one image sensor, may be generated using a generative model, and so forth. The image data may depict an entity performing a first action using at least one autopodium of the entity and/or performing a second action using the at least one autopodium of the entity. Further, the image data may be analyzed to identify that the second action occurs after the completion of the first action, for example using a visual event detection algorithm, using a classification algorithm, and so forth. Further, the image data may be analyzed to identify a first configuration of the at least one autopodium during the performance of the first action, for example using a visual pose detection algorithm. Further, the image data may be analyzed to identify a first motion pattern of the at least one autopodium during the performance of the first action, for example using a visual object tracking algorithm. Further, the image data may be analyzed to identify a second configuration of the at least one autopodium during the performance of the second action, for example using a visual pose detection algorithm. Further, the image data may be analyzed to identify a second motion pattern of the at least one autopodium during the performance of the second action, for example using a visual object tracking algorithm. Further, first digital signals configured to activate a first group of actuators to cause a robot to imitate the first configuration and the first motion pattern may be generated. Further, after imitating the first configuration and the first motion pattern, second digital signals configured to activate a second group of actuators to cause the robot to imitate the second configuration and the second motion pattern may be generated.

In some examples, the entity may be an individual. In some examples, the entity may be a different robot.

In some examples, a need to learn a new action may be identified. Further, the image data may be image data obtained based on the new action in response to the identified need.

In some examples, the image data may be image data captured using at least one image sensor included in the robot. In one example, an indication of a desire of the entity to teach the robot may be received. In another example, the indication may be received before the performance of the first action. In yet another example, the indication may be received during the performance of the first action. In an additional example, the indication may be received between the performance of the first action and the performance of the second action. In another example, the indication may be received during the performance of the second action. In yet another example, the indication may be received after the performance of the second action. In one example, the image data may be analyzed to identify the indication. In another example, audio data captured using at least one audio sensor included in the robot may be received, and the audio data may be analyzed to identify the indication. In one example, the indication may be a gesture performed by the entity. In another example, the indication may be a speech in a natural language received from the entity and indicative of a desire of the entity to teach the robot.

In some examples, the at least one autopodium may be or include at least one hand. In some examples, the at least one autopodium may be or include at least one hand and at least one foot.

In some examples, the first group of actuators and the second group of actuators may be the same group of actuators. In some examples, the first group of actuators and the second group of actuators may include at least one but not all actuators in common. In some examples, the first group of actuators and the second group of actuators may include no actuator in common.

In some examples, the image data may further depict the entity performing a third action using the at least one autopodium of the entity. Further, the image data may be analyzed to identify that the third action occurs after the completion of the second action. Further, the image data may be analyzed to identify a third configuration of the at least one autopodium during the performance of the third action. Further, the image data may be analyzed to identify a third motion pattern of the at least one autopodium during the performance of the third action. Further, after imitating the second configuration and the second motion pattern, third digital signals configured to activate a third group of actuators to cause the robot to imitate the third configuration and the third motion pattern may be generated.

In some examples, the image data may further depict the entity performing a third action using a second at least one autopodium of the entity. Further, the image data may be analyzed to identify that the third action occurs at least partly simultaneously with the second action. Further, the image data may be analyzed to identify a third configuration of the second at least one autopodium during the performance of the third action. Further, the image data may be analyzed to identify a third motion pattern of the second at least one autopodium during the performance of the third action. Further, while imitating the second configuration and the second motion pattern, third digital signals configured to activate a third group of actuators to cause the robot to imitate the third configuration and the third motion pattern may be generated.

In some examples, the image data may be analyzed to determine a time duration between the first action and the second action. Further, the generation of the second digital signals may be timed based on a timing of the generation of the first digital signals and on the determined time duration.

In some examples, a natural language input may be received (for example, from the entity, from an individual different than the entity, and so forth). Further, the natural language input may be analyzed to determine a time duration. Further, the generation of the second digital signals may be timed based on a timing of the generation of the first digital signals and on the determined time duration.

In some examples, a natural language input may be received (for example, from the entity, from an individual different than the entity, and so forth). Further, the natural language input may be analyzed to determine a limitation on at least one of the second configuration or the first motion pattern. Further, the first digital signals may be based on the determined limitation to cause the imitation of the at least one of the first configuration or the first motion pattern to adhere to the determined limitation.

In some examples, a natural language input may be received (for example, from the entity, from an individual different than the entity, and so forth). Further, the natural language input may be analyzed to determine a limitation on at least one of the second configuration or the second motion pattern. Further, the second digital signals may be based on the determined limitation to cause the imitation of the at least one of the second configuration or the second motion pattern to adhere to the determined limitation.

In some examples, after imitating the first configuration and the first motion pattern, a natural language input indicative of a correction to at least one of the first configuration or the first motion pattern may be received. Further, the natural language input may be analyzed to determine the correction to the at least one of the first configuration or the first motion pattern. Further, third digital signals configured to activate a third group of actuators to cause the robot to imitate, in a way consistent with the determined correction, the first configuration and the first motion pattern may be generated. Further, after imitating the first configuration and the first motion pattern in the way consistent with the determined correction, fourth digital signals configured to activate a fourth group of actuators to cause the robot to imitate the second configuration and the second motion pattern may be generated.

In some examples, at least one rule associated with at least one trigger may be determined. Further, second image data captured using at least one image sensor included in the robot may be received. Further, the second image data may be analyzed using the at least one rule to detect the at least one trigger. Further, in response to the detection of the at least one trigger, the generation of the first digital signals may be initiated. In one example, a natural language input may be received (for example, from the entity, from an individual different than the entity, and so forth), and the natural language input may be analyzed to determine the at least one rule associated with at least one trigger. In another example, second image data captured using at least one image sensor included in the robot may be received, and the second image data may be analyzed to determine the at least one rule associated with at least one trigger. In one example, after initiating the generation of the first digital signals, a natural language input may be received. Further, the natural language input may be analyzed to determine an exception to the at least one trigger, wherein the at least one trigger detected in the second image data corresponds to the determined exception. Further, after determining the exception, third image data captured using the at least one image sensor may be received. Further, the third image data may be analyzed using the at least one rule to detect the at least one trigger in the third image data. The detected at least one trigger in the third image data corresponds to the determined exception. Further, imitating the first configuration and the first motion pattern in response to the detection of the at least one trigger in the third image data may be avoided. Further, after determining the exception, fourth image data captured using the at least one image sensor may be received. Further, the forth image data may be analyzed using the at least one rule to detect the at least one trigger in the fourth image data. The at least one trigger in the fourth image data does not correspond to the determined exception. Further, in response to the detection of the at least one trigger in the fourth image data, third digital signals configured to activate the first group of actuators to cause the robot to imitate the first configuration and the first motion pattern may be generated.

In some examples, the first motion pattern may include at least one of (at least two of, at least three of, at least four of, at least five of, all of) a direction of movement, a speed of movement, a relative movement of one body part relative to another body part, a movement of one body part while another body part stays still, a sequence of movements (the movements may differ from one another at least in direction), or a sequence of configurations of the at least one autopodium.

In some examples, an approximated first configuration may be determined based on the first configuration and an anatomical difference between the entity and the robot. Further, an approximated second configuration may be determined based on the second configuration and the anatomical difference between the entity and the robot. Further, the first digital signals may be based on the approximated first configuration. Further, the second digital signals may be based on the approximated second configuration.

In some examples, an approximated first motion pattern may be determined based on the first motion pattern and at least one of a range of motion or a pace of motion limitation the robot. Further, an approximated second motion pattern may be determined based on the second motion pattern at least one of a range of motion or a pace of motion limitation of the robot. Further, the first digital signals may be based on the approximated first motion pattern. Further, the second digital signals may be based on the approximated second motion pattern.

What is claimed is:

1. A non-transitory computer readable medium storing computer implementable instructions that when executed by at least one processor cause the at least one processor to perform operations for navigating robots based on associations, the operations comprising:
in a first timeframe, receiving a first verbal input in a natural language;
analyzing the first verbal input to determine a first need, the first need is a need to move to a stored location associated, at the first timeframe, with a particular entity;
accessing, based on the particular entity, a data structure associating entities with stored locations to identify a first location associated with the particular entity at the first timeframe, wherein the stored locations in the data structure are independent of real-time detected positions of the entities;
generating first digital signals configured to activate at least one actuator of a robot to cause the robot to move to the first location;
after causing the robot to move to the first location, receiving digital data captured using at least one sensor included in the robot;
analyzing the captured digital data to update an association of the particular entity in the data structure, wherein the update is independent of a real-time detected position of the particular entity;
in a second timeframe, after updating the data structure, receiving a second verbal input in the natural language;
analyzing the second verbal input to determine a second need, the second need is a need to move to a stored location associated, at the second timeframe, with the particular entity;
accessing, based on the particular entity, the updated data structure to identify a second location associated with the particular entity at the second timeframe, the second location differs from the first location due to the update; and
generating second digital signals configured to activate the at least one actuator of the robot to cause the robot to move to the second location.

2. The non-transitory computer readable medium of claim 1, wherein the captured digital data is captured image data depicting an item associated with the particular entity in a place associated with the second location.

3. The non-transitory computer readable medium of claim 2, wherein the item associated with the particular entity is at least one of a nameplate or a label including a textual indication of the particular entity.

4. The non-transitory computer readable medium of claim 2, wherein the item associated with the particular entity is an item moved from a place associated with the first location to the place associated with the second location.

5. The non-transitory computer readable medium of claim 2, wherein the place associated with the second location is external to the second location.

6. The non-transitory computer readable medium of claim 1, wherein the captured digital data is captured audio data including a verbal indication of an association of the particular entity with the second location.

7. The non-transitory computer readable medium of claim 1, wherein the first location is a first room associated with the particular entity, the captured digital data indicates that the particular entity is now associated with a second room and is no longer associated with the first room, the update includes associating the particular entity with the second room in the data structure, and the second location is the second room.

8. The non-transitory computer readable medium of claim 1, wherein the first location is a first desk associated with the particular entity, the captured digital data indicates that the particular entity is now associated with a second desk and is no longer associated with the first desk, the update includes associating the particular entity with the second desk in the data structure, and the second location is the second desk.

9. The non-transitory computer readable medium of claim 1, wherein the first location is a first bed associated with the particular entity, the captured digital data indicates that the particular entity is now associated with a second bed and is no longer associated with the first bed, the update includes associating the particular entity with the second bed in the data structure, and the second location is the second bed.

10. The non-transitory computer readable medium of claim 1, wherein the first location is a first storage unit associated with the particular entity, the captured digital data indicates that belongings of the particular entity moved from the first storage unit to a second storage unit, the update includes associating the particular entity with the second storage unit in the data structure, and the second location is the second storage unit.

11. The non-transitory computer readable medium of claim 1, wherein the data structure is included in a memory of an artificial neural network.

12. The non-transitory computer readable medium of claim 1, wherein the operations further comprise, during a third timeframe preceding the first timeframe:
receiving a third verbal input in the natural language;
analyzing the third verbal input to determine a third need, the third need is a need to move to a stored location associated, at the third timeframe, with the particular entity;
accessing, based on the particular entity, a preliminary version of the data structure to identify a lack of information associated with the particular entity in the preliminary version of the data structure;
requesting an indication of the first location associated with the particular entity;
receiving the indication of the first location; and
analyzing the received indication of the first location to associate the particular entity with the first location in the data structure.

13. The non-transitory computer readable medium of claim 1, wherein the operations further comprise, during a third timeframe preceding the first timeframe:
receiving second digital data captured using the at least one sensor included in the robot; and
analyzing the second digital data to associate the particular entity with the first location in the data structure.

14. The non-transitory computer readable medium of claim 1, wherein the operations further comprise:
in a third timeframe after causing the robot to move to the first location and before receiving the digital data captured using the at least one sensor included in the robot, receiving a third verbal input in the natural language;
analyzing the third verbal input to determine a third need, the third need is a need to move to a stored location associated, at the third timeframe, with the particular entity;
in response to the third verbal input, generating third digital signals configured to activate the at least one actuator of the robot to cause the robot to start moving again towards the first location;
capturing the digital data using the at least one sensor included in the robot while moving again towards the first location; and
in response to the analysis of the captured digital data and before the robot reaches the first location again: stopping the motion of the robot towards the first location, and generating fourth digital signals configured to activate the at least one actuator of the robot to cause the robot to move to the second location.

15. The non-transitory computer readable medium of claim 1, wherein the operations further comprise:
after the robot moves to the first location and before receiving the digital data captured using the at least one sensor included in the robot, capturing second digital data using the at least one sensor included in the robot;
analyzing the captured second digital data to determine a third need, the third need is a need to update the association of the particular entity in the data structure; and
in response to the determined third need, causing capturing of the digital data using the at least one sensor included in the robot.

16. The non-transitory computer readable medium of claim 15, wherein the captured second digital data is captured image data depicting an absent of an item associated with the particular entity from a place associated with the first location.

17. The non-transitory computer readable medium of claim 15, wherein the captured second digital data is captured at the first location.

18. The non-transitory computer readable medium of claim 1, wherein the first verbal input includes an indication of a task and no direct indication of the particular entity, and the operations further comprise determining the first need to move to the stored location associated, at the first timeframe, with the particular entity based on the task.

19. A system for navigating robots based on associations, the system comprising:
at least one processing unit configured to perform operations, the operations comprise:
in a first timeframe, receiving a first verbal input in a natural language;
analyzing the first verbal input to determine a first need, the first need is a need to move to a stored location associated, at the first timeframe, with a particular entity;
accessing, based on the particular entity, a data structure associating entities with stored locations to identify a first location associated with the particular entity at the first timeframe, wherein the stored locations in the data structure are independent of real-time detected positions of the entities;
generating first digital signals configured to activate at least one actuator of a robot to cause the robot to move to the first location;
after causing the robot to move to the first location, receiving digital data captured using at least one sensor included in the robot;
analyzing the captured digital data to update an association of the particular entity in the data structure, wherein the update is independent of a real-time detected position of the particular entity;
in a second timeframe, after updating the data structure, receiving a second verbal input in the natural language;
analyzing the second verbal input to determine a second need, the second need is a need to move to a stored location associated, at the second timeframe, with the particular entity;
accessing, based on the particular entity, the updated data structure to identify a second location associated with the particular entity at the second timeframe, the second location differs from the first location due to the update; and
generating second digital signals configured to activate the at least one actuator of the robot to cause the robot to move to the second location.

20. A method for navigating robots based on associations, the method comprising:
in a first timeframe, receiving a first verbal input in a natural language;
analyzing the first verbal input to determine a first need, the first need is a need to move to a stored location associated, at the first timeframe, with a particular entity;
accessing, based on the particular entity, a data structure associating entities with stored locations to identify a first location associated with the particular entity at the first timeframe, wherein the stored locations in the data structure are independent of real-time detected positions of the entities;
generating first digital signals configured to activate at least one actuator of a robot to cause the robot to move to the first location;
after causing the robot to move to the first location, receiving digital data captured using at least one sensor included in the robot;
analyzing the captured digital data to update an association of the particular entity in the data structure, wherein the update is independent of a real-time detected position of the particular entity;
in a second timeframe, after updating the data structure, receiving a second verbal input in the natural language;
analyzing the second verbal input to determine a second need, the second need is a need to move to a stored location associated, at the second timeframe, with the particular entity;
accessing, based on the particular entity, the updated data structure to identify a second location associated with the particular entity at the second timeframe, the second location differs from the first location due to the update; and
generating second digital signals configured to activate the at least one actuator of the robot to cause the robot to move to the second location.
